(19) United States
(12) Patent Application Publication
(10) Pub. No.: US 2020/0057991 A1
(43) Pub. Date: Feb. 20, 2020

(54) Electronic Logistics Control Platform For Parcel Transportation

(71) Applicant: Orestis Afordakos, Athens (GR)

(72) Inventor: Orestis Afordakos, Athens (GR)

(21) Appl. No.: 16/212,506

(22) Filed: Dec. 6, 2018

Related U.S. Application Data
(63) Continuation of application No. 15/999,035, filed on Aug. 20, 2018, now abandoned.

(51) Int. Cl. G06Q 10/08; G06Q 10/04; G06Q 50/30

(52) U.S. Cl. CPC G06Q 10/0833; G06Q 10/047; G06Q 50/30; G06Q 10/0838; G06Q 10/08355

(57) ABSTRACT

Provided is an electronic platform using database driven digital computer technology and Internet connectivity. The platform provides logistics control of a crowdsourced transportation system and processes for courier pickups from senders or hubs, transport along calculated routes—with stops at intermediate hubs as necessary, and secure delivery of packages. The technology can include use of augmented reality data input and processing by server loading capacity optimization modules, to determine optimal configuration for loading/carrying parcels; and where hub technology can include means for directing landing, maintenance and takeoff of delivery drones.

### CROSS-REFERENCE TO RELATED APPLICATIONS

This application is a continuation of U.S. application Ser. No. 15/999,035, filed Aug. 20, 2018, which claims the benefit of U.S. Provisional Application No. 62/547,722, filed Aug. 18, 2017, which is incorporated herein by reference in its entirety. This application also claims the benefit of U.S. Provisional Application No. 62/566,316, filed Sep. 29, 2017, which is incorporated herein by reference in its entirety.

### FIELD OF THE INVENTION

### Technical Field

The present invention relates generally to a system and processes for controlling crowdsourced transportation of parcels from and to a plurality of points along geographic routes. More particularly, the present invention relates to an electronic logistics control platform used to match up senders, receivers and other platform users, to coordinate and facilitate parcel flow along calculated routes.

### Background of the Invention

Over the years, a diversity of means and carriers have been used to transport items from senders to receivers along geographic routes. E.g., historically, these have ranged from camel caravans along the Asian Silk roads, to marathon runners in ancient Greece, to Pony Express riders and bike-riding Western Union messengers, in the USA. Then, in the 20th century, we saw the development of huge major “Carriers” (FedEx, Airborne Express, UPS, DHL, etc.). Such Carriers continue to use means such as box-trucks, acres-wide hubs, sleek B-747s and vast networks of logistics computers, to transport parcels (from major corporations, small businesses and individuals), to recipients around the globe.

In the 21st century, technological advances have led to rapid growth in electronic merchandising and online marketplaces. Moreover, as populations have increased, so has the inherent demand for goods. The ongoing explosion in e-commerce, and the boom in Internet purchasing, is but one example of the increasing demand for transit of goods.

As more individuals and enterprises have recognized the efficiencies of e-commerce, both e-tailors and their customers, have begun to rely more heavily on direct delivery of goods. Concomitant increasing shipment volumes have already reached well into the “billions” of parcels per year levels. Even so, though billions of parcels are now being successfully transported each year, reliance on parcel shipment and delivery primarily by the major Carriers and other large couriers, still presents some problems.

For example, one art (e.g., see U.S. Pat. No. 8,762,290, by Williams et al) recognized disadvantage of the conventional Carrier system is that different Carriers may have their own unique rating schedule; delivery/pickup rules and schedules/cutoff times; and certification requirements. Such traditional shipping systems often lack flexibility due to strict requirements on how items must be packaged/wrapped, as well as limitations on the types of items that a given carrier will accept. (E.g., see U.S. Pat. Application No. 2015/0161563A1, by Mehrabi.)

Other art recognized problems with traditional package delivery systems have been noted (for example) by: (a) Chasen (U.S. Pat. Application No. 2007/0192111A1)—[i.e., if packages exceed certain strict cutoffs for size and weight (even by as little as an inch or a pound), then shipping costs for some items can increase by as much as 400%]; by Gorlin (U.S. Pat. Applic. No. 2007/0192111A1)—[i.e., the typical rigidity of schedules regarding when the large couriers/Carriers will deliver to certain destinations and areas]; by Trew et al (U.S. Pat. Applic. No. 2015/0206093A1—[i.e., delivery times are typically 3-5 business days (or more), unless the recipient is willing to pay a premium for speedier delivery]; by Baykhurazov (U.S. Pat. Applic. No. 2014/0236856A1)—[i.e., inadequacy at providing last minute urgent deliveries, and same day or next day deliveries are often problematic]

Moreover, it has also been long known in the art that conventional commercial delivery systems have various “last mile” issues. (E.g., see U.S. Pat. Applic. No. 2002/0156645A1, by Hansen). Among the various solutions that have been suggested in the art, to overcome or lessen the impact of the above type problems, are crowd-sourced or peer-to-peer (“P2P”) shipping/delivery systems.

### RELATED ART SOLUTIONS

Some examples of attempts to solve some of the above noted problems, by using P2P delivery systems, are discussed in the above cited patent documents by: Baykhurazov'856, Chasen'111, Gorlin'496, Hansen'645, Mehrabi'563, & Trew'093.

Another potential P2P solution has been suggested by Levy (U.S. Pat. Applic. 2016/0225115A1). The Levy'115 system uses a network of independent crowdsourced “warehouses” and “drivers”, operationally coupled through a mobile application and Cloud based servers, to transport packages.

While the cited P2P or crowdsourced systems may address some of the above noted problems with traditional parcel transporting systems, these P2P systems all have their own deficiencies. For example, Levy's system involves use of an offering/bidding auction system (for selecting users). +Moreover, Levy does not disclose enabling troubleshooting/error correction means.

Consequently, our system disclosed herein provides improved solutions (over the prior art P2P parcel transportation systems) to these and other problems.

### SUMMARY OF EMBODIMENTS

Our peer-to-peer/crowdsourced shipping and delivery system is called a “Platform”, hereinafter. It is an electronic logistics control system by which everyday individuals, that are non-professional couriers, can electronically register their daily travel routes onto a website/mobile application (“mob.App”). Our Platform includes a “Controller”, or computerized data processing system, with electronically coupled servers, storage and communications components. The Platform Controller electronically matches couriers with items that need to be transported along their registered routes.

Underutilized carrying space (be it in a rucksack, car, motorcycle bag, etc.), of qualified persons going from one geographic point to another, can then be better utilized for carrying additional items, up to the limits of the space's carrying capacity. Upon delivery of the item, a fee is electronically paid (through the Platform) to the transporters of the parcel, by the senders. Remuneration to successful parcel handlers (i.e., couriers and/or intermediate parcel holders) may also include other consideration (e.g., “Ecopoints”) awarded by the Platform controller.

Unlike other known P2P parcel delivery systems, however, our system adds several previously missing innovative key features that have not been found in the known P2P shipping (a.k.a. “crowdshipping”, “shared economy shipping”, etc.) systems. (Note that the terms “parcel” and “package” are used interchangeably, herein.)

One such feature for some embodiments involves the way we use a mixture of Augmented Reality (“AR”, hereinafter) technology and advanced image processing (e.g., computer vision) to facilitate parcel flow. The main AR and vision technology devices we use are: displays (e.g., Google Glass), input devices (e.g., smart phones), tracking means (e.g., GPS, accelerometers, gyroscopes, WiFi, magnetic sensors, Bluetooth, RFID, digital cameras), and digital computers (with sufficient CPU power and memory to process camera images and multi-stream data inputs).

The way our AR system works is that it enhances the user's perception of and interaction with the real world. For example, our AR system can augment the sense of reality by superposing virtual objects and cues upon the real world scenario in real time. Virtual objects (e.g., rulers/yardsticks/spatial grids) added to the real environment (e.g., images of carrying/storage areas), can show information that the user cannot directly detect with his senses (e.g., numerical dimensions of available spaces). Thereby, information passed on by the virtual objects can be used to improve Platform performance by: helping users with work tasks—such as better handling/positioning of parcels; determining the available space of a given location; and identification of the best persons and locations for given pick-ups and drop-offs.

Thus, for example, we use AR for assessing the space availability within a carrying container (e.g., the back of a car) or other storage space; for identifying particular packages; and for computing the optimal arrangement of groups of parcels.

Since our Platform includes technology for updating our AR displays, this provides a solution to the problem of knowing live (or in real time) the available space of a given carrying space or other storage area; thus allowing more accurate directing of parcel delivery orders. It also provides a solution to the problem of having a truckload/heap of small parcels with a person trying to manually (i.e., visually) identify the correct parcel.

Another key feature involves the issuance and novel use (within the Platform) of a plurality of security codes. These security codes are used: for validating the I.D. (identification) of each user; for creating an I.D. for the item transported; for activating the route; for monitoring each step/leg of the route; and for confirming safe delivery to the end recipient. This takes place via the computer generation and use of three distinct types of security codes within the Platform, namely: a Route Activation Code (“RAC”), a Delivery Confirmation Code (“DCC”) and a Unique Transition Code (“UTC”). These codes are then transmitted to different types of users at different stages along the route. The RAC, DCC and UTC can be transmitted and relayed either manually (e.g. verbally) or via a number of electronic technologies, or by a combination of manual and electronic.

While some competitors do offer a DCC, one of the innovative elements in our embodiments, however, lies in the way we configure our DCCs, RACs, and UTCs for confirming receipt of the parcel; thereby allowing the Platform to know when the parcel was received. This in turn enables our electronic Platform to more accurately calculate the estimated time of delivery, as well as help ensure a more secure transaction through a minimization of issues relating to whether the carrier actually went to the senders' premises for the pickup. (Note that the terms “courier” and “carrier” will be used interchangeably hereinafter.)

In addition, our Platform's security codes are configured to help manage parcel flow along routes which may have one or more in-between stages (essentially relay points), as well as a beginning point and an endpoint. This includes use of different UTC codes for each exchange of parcels between Platform members (e.g., between a hubspot and a courier or CMT member).

Moreover, another distinctive feature of our Platform is that the particular manner in which we configure our security codes (for tracking and progress monitoring) this also helps our administrative controller (“AC”) software calculate the amount (if any) of Ecopoints earned by a Platform user during execution of a given route.

Our Platform further includes a plurality of computer software driven “troubleshooting”/error correction routines. These subprograms facilitate aid to and/or replacement of couriers/hubs which encounter difficulties during execution of a route or do not perform as required. Our troubleshooting routines can also generate alternative security codes and transmit emergency calls for assistance from selected Crisis Management Team members. Depending on the situation, need to call certain troubleshooting routines may of course also impact the award of Ecopoints by the Platform's AC.

Still another key novel feature of some embodiments involves the way we use available and underutilized storage space of individuals and businesses as both mobile and static crowdsourced depots or hubs (a/k/a “hubspots”, hereinafter) for drop-offs and pickups. Our Platform also uses AR and computer vision technology to measure the available capacities of some of these hub spots. AR image registration uses methods of computer vision related to video tracking and can (for example) include two stages: tracking, and reconstruction/recognizing. Thus, we can use computer vision for “parcel-picking” (i.e., selecting a desired parcel from a [sometimes large] group or heap of packages) at/in a hubspot.

Examples of such underutilized hubspot storage spaces include but are not limited to: kiosks, cafes, garages, backyards, basements, parked vehicles, etc. Such hubs can be used: when the parcel recipient elects not to meet directly with the courier, in case a hand-to-hand pickup/delivery cannot take place (e.g., due timing differences), or for other reasons. These hubs generally are not (but may be) professional hubs directly associated with the Platform; but these hubs are active users of the Platform.

The defining innovative element is that, in this way, a scalable worldwide two-layer network for the sharing economy is presented (i.e., one layer being the carriers/couriers, and the second layer being the hubs/spots [for interim intra-route storage]). Moreover, there is the possibility of extending it to an N-layer network (N>2); where other layers of the multi-layer network can be involved in the packaging, displaying, or warehousing of goods, or elsewhere in the whole supply chain network.

Yet another key innovative feature of some embodiments is the use of specialized hubs/spots for drone-performed deliveries. These particular hubs qualify for this special purpose by: complying with all necessary laws and regulations, offering the required landing/takeoff equipment, having storage/anchoring facilities, and by being able to serve as recharging/servicing/maintenance facilities for unmanned parcel carrying aircraft. Some embodiments involve specialized drone-hubs facilitating parcel delivery onto drop zones. Other embodiments involve hubs with drone landing facilities.

Another innovative feature of some of our embodiments is the way we compute and incorporate distance radius information, and use polyline technology, in our user matching and route generation processes. For the radius calculations, users input position/location data on their displays for analysis by our radius controller. Our Platform software uses Polyline points (in our spatial database) for defining and computationally identifying a certain route on a geographical map, and for generating displays accordingly.

### BRIEF DESCRIPTION OF THE DRAWINGS

The accompanying drawings, which are incorporated herein and form part of the specification, illustrate the present invention; and, together with the description, further serve to explain the principles of embodiments of the invention; and serve to enable a person skilled in the relevant art(s) to make and use the invention.

FIG. 1 is a block diagram illustration of telecommunications links among the Platform devices, Internet, and different types of users' devices.

FIG. 2 is a block diagram illustration of major structural components of the Platform.

FIG. 3 is a block diagram illustration of the major database server components and data set modules.

FIG. 4A is a block diagram illustration showing the major controller/database servers components and logic modules.

FIG. 4B is a block diagram illustrating Database Server Modules & Data Sets—Registration/Authorization Area-Links.

FIG. 4C is a block diagram illustrating Database Server Modules & Data Sets—Points & Routes-Links (C).

FIG. 4D is a block diagram illustrating Database Server Modules & Data Sets—Points & Routes-Links (D).

FIG. 4E is a block diagram illustrating Database Server Modules & Data Sets—Points & Routes-Links (E).

FIG. 4F is a block diagram illustrating Database Server Modules & Data Sets—Business Area-Links (F).

FIG. 4G is a block diagram illustrating Database Server Modules & Data Sets—Business Area-Detail (G).

FIG. 5A is illustrates a hubspot with available storage/carrying capacity—in a shop or store.

FIG. 5B is a Illustrates a hubspot with available storage/carrying capacity—in a cafeteria or restaurant.

FIG. 5C & Illustrates a hubspot with available storage/carrying capacity—in the back of a tractor-trailer truck.

FIGS. 5D & 5E Illustrate two views of a hubspot with available storage/carrying capacity—in the front & back of a passenger automobile.

FIGS. 5F & 5G Illustrate a hubspot with available storage/carrying capacity—in different areas of a house/residence

FIG. 6 is an illustration of a type of Augmented Reality (AR) glasses used to help identify available space at hubspots with AR facilities.

FIGS. 7A & 7B illustrate a drone (in flight) approaching a hubspot, with drone-handling facilities, to pick-up a parcel

FIG. 7C is an illustration of a Drone flying away from a drone handling hubspot with a parcel it picked up at the hub.

FIG. 8A is an overview diagram of the User Registration Process.

FIG. 8B is an overview diagram of the Order Placement Process.

FIG. 9 is an overview diagram of the Pickup Process.

FIG. 10 is an overview diagram of the Delivery Process.

FIGS. 11A & 11B are logical overviews of Problem Resolution procedures during parcel Pickup and Delivery Processes.

FIG. 12A is a logic flowchart for the Order Placement Process. FIGS. 12B & FIG. 12C are continuations of FIG. 12A.

FIGS. 13A, 13B and 13C are logic flowcharts Pickups directly from a sender.

FIGS. 14A, 14B & 14C is are logic flowcharts for the Pickup Process—Pickup from Hubspot (“Hs)”.

FIGS. 15A & 15B are logic flowcharts for the Pickup Process—Dropoff to Hs.

FIGS. 16A & 16b are logic flowcharts for the Pickup Process Troubleshooting: Dropoff to Hs—Hs Closed.

FIG. 17 is a logic flowchart for Pickup Process Troubleshooting: Hs-RACs don't match.

FIGS. 18A & 18B are logic flowchart for the Pickup Process Troubleshooting: Cr-RAC Confirmation by Sender.

FIGS. 19A, 19B & 19C are logic flowcharts for the Pickup Process: Troubleshooting: Courier trouble—Orange alert.

FIGS. 20A & 20B are logic flowcharts for the Pickup Process Troubleshooting: Hubspots closed.

FIG. 21 is a logic flowchart for the Pickup Process Troubleshooting: RACs don't match.

FIGS. 22A, 22B & 22C are logic flowcharts for the Pickup Process—RAC confirmation by Hubspot.

FIGS. 23A, 23B, 23C & 23D are logic flowcharts for the Pickup Process Troubleshooting: Courier trouble on the way to Sender.

FIGS. 24A & 24B are logic flowcharts for the Pickup Process: Troubleshooting—Sender is not here.

FIG. 25 is a logic flowchart for the Pickup Process Troubleshooting: RACs don't match.

FIGS. 26A & 26B are logic flowcharts for the Pickup Process: Sender RAC Confirmation.

FIGS. 27A, 27B & 27C are logic flowcharts for the Delivery Process.

FIG. 28A, 28B, 28C & 28D are logic flowcharts for the Delivery Process: Troubleshooting: Courier Trouble on the way to Rc

FIGS. 29A & 29B are logic flowcharts for the Delivery Process: Courier/CMT delivers the parcel to Hubspot.

FIG. 30 is a logic flowchart for the Delivery Process Troubleshooting: Hubspot is closed.

FIG. 31 is a logic flowchart for the Delivery Process Troubleshooting: Recipient (“Rc”) is not here.

FIGS. 32A, 32B & 32C are logic flowcharts for the Delivery Process: Recipient collects the parcel from a Hubspot”.

FIGS. 33A & 33B are logic flowcharts for the Delivery Process Troubleshooting: Recipient arrives to collects the parcel from a Hs which is closed.

FIG. 34 is a logic flowchart for the Delivery Process Troubleshooting: DCCs don't match.

FIGS. 35A & 35B are overview flowcharts for CMT member selection and CMT route acceptance for meetups with a Hs, Rc or Cr). FIGS. 35C is an overview flowchart for replacement of a Cr, during either the parcel Pickup process or the parcel Delivery process.

FIGS. 36A, 36B, 36C are overview flowcharts for CMT member parcel pickups from Sender (“Sd”).

FIGS. 37 are overview flowcharts for a CMT member parcel pickups from Hubspots.

FIGS. 38A, 38B & 38C are overview flowcharts for CMT member deliveries directly to Recipients.

FIG. 39A & 39B are overview flowcharts for CMT member deliveries where a designated Hubspots (Hs) is closed.

FIGS. 40A & 40B are logic flowcharts for the Loading Capacity Optimization Process (AR)”.

FIGS. 41 to 46 are illustrations of procedures relating to radius calculations.

FIGS. 47 to 51 are illustrations of views and procedures relating to use of augmented reality (AR) mechanisms for determining space availability.

Those skilled in the art will recognize and understand that the illustrated systems and processes may be comprised of a plurality of physically distinct elements/routines as is suggested by the illustrations. It is also known in the art, however, to view these illustrations as comprising a logical view; in which case one or more of these elements/routines can be enabled and realized via shared or distributed networks of electronic communication and computing resources.

### GLOSSARY OF TERMS, ABBREVIATIONS & DEFINITIONS.

The following abbreviations/acronyms are used herein:
Sd=Sender=individual, business or enterprise sending a parcel.
Rc=Recipient=party receiving package.
Cr 32 Courier/carrier transporting a package from point A to point B.
Hs=hubspot/depot/way station temporarily holding/storing parcels.
RAC=Route Activation Code=a startup security code.
RAC1=Route Activation Code partial=a verification security code.
DCC=Delivery Confirmation Code=a route completion security code.
UTC=Unique Transition Code=a specialized security code used distinguish between parcel delivery to final recipient (DCC) and parcel transition from one member of the Platform team to another member inside the Platform.
CMT=Crisis Management Team member
mobApp=mobile application=a set of computer program code transmittable to an ECD.
ECD=an Electronic Control Device, configured with necessary communication and computing capabilities, to which our mobApp can be downloaded. For Cr and CMT users of our Platform, their ECD can be a mobile cellular phone, a laptop or tablet computer, or other portable device (configured with equivalent communication and computing capabilities), which can be carried by hand/on the person or in the vehicle of the Cr/CMT. For Sd and/or Rc users of our Platform, their ECDs can be any of the above ECD devices, or their ECD can also be a home/office/desktop PC or other computer.
GPS=Global Positioning System.
GSM=Global System for Mobile communications
SMS=Short Message Service=series of standards/protocols allowing users to send/receive short messages (e.g., up to 160 alpha-numerics) to/from GSM mobiles.
SfM=Structure from Motion=computer vision methodology used in AR for tracking and reconstructing/recognizing images/scenes.
API=Application Program Interface.

The following terms/phrases used herein are defined below:
Ecopoints=reward/benefit/remuration/consideration parameters earned on the basis (for example) of the mileage/kilometers a user has engaged in for package(s) delivery. These reward points can be earned by, (and digitally credited by the AC to), the accounts of both senders and couriers.
Escalates issue—by this we mean a problem/issue is referred to a person of higher authority/decision making power/managerial staff level with the intent to provide a solution/resolution to the issue at hand.
LCO (Loading Capacity Optimization) algorithms—these are constraint-driven distance-space geometric spatial query algorithms, and ours include a number of optimization and Satisfiability Solver solutions for combinatorial problems (e.g., such as the Travelling Salesman Problem).
Machine learning algorithms—ours use historical and current geospatial, time, platform usage and personal preference data to aid in computing/generating routes.
Polyline points—this a spatial database term referring to geospatial points which are used for defining and computationally identifying a certain route on a geographical map/grid.

### DETAILED DESCRIPTION

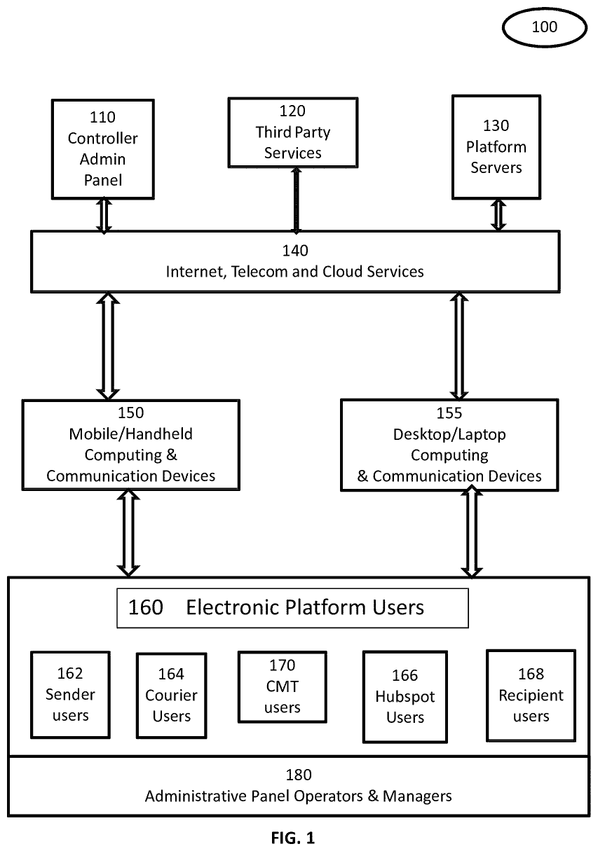

FIG. 1 is a generalized overview of an embodiment of our inventive shipping service provider Platform for transporting packages or parcels. This block diagram illustrates telecommunications links among our Platform's devices (110, 120, 130); communications interfaces or Internet/telecom/Cloud services providers (140); Platform user devices (150, 155), and the users of our electronic logistics control Platform (hereafter “Platform” or ePlatform”).

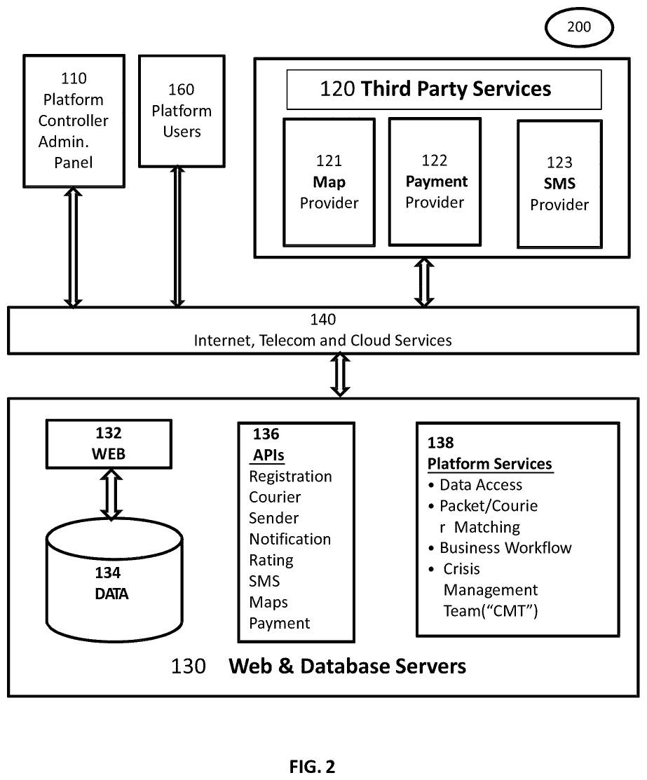

Our Platform's computer processing resources include both centralized and decentralized elements. For example, some of the processing is done by servers in the Cloud (140); and some of the processing utilizes the computing capacity of ECDs such as a mobile/handheld type device (150) or desktop/laptop type device (155). Computer technologies required for our Platform, include (but are not limited to): I/O peripherals, CPU/processors and RAM/memory; which have sufficient sensor capability, computing power and storage capacity, to process camera images and data coming from the various other input technologies—e.g., from GPS/tracking sensors & systems, or from other third parties. (See element 120 on FIG. 1 and FIG. 2.)

FIG. 1 also shows different types of users of our Platform (“Users”) These include: parcel senders (162), parcel transporters or couriers (164), owners/managers/employees/agents of depots/storage facilities/hubspots (166), parcel receivers/recipients (168), CMT users (170), and Administrative Panel operators and managers (180).

FIG. 2 is a functional block diagram of an embodiment showing more details of certain components of the Platform. These details include examples of electronically linked Third Party (130) vendors of transaction related services including (but not limited to): mapping (121), such as GPS; payment processing (122), such as banks, credit cards or Paypal©, and communications processing, such as SMS (123) providers. FIG. 2 also includes examples of the types of web (132) and database (134) software routines (136) or APIs that are operatively employed by the Platform's servers (130). FIG. 2 further shows some of the services (138) performed/controlled by the Platform, including (but not limited to): data access, parcel/courier matching, business workflow analysis, and Crisis Management Team (“CMT”) assistance.

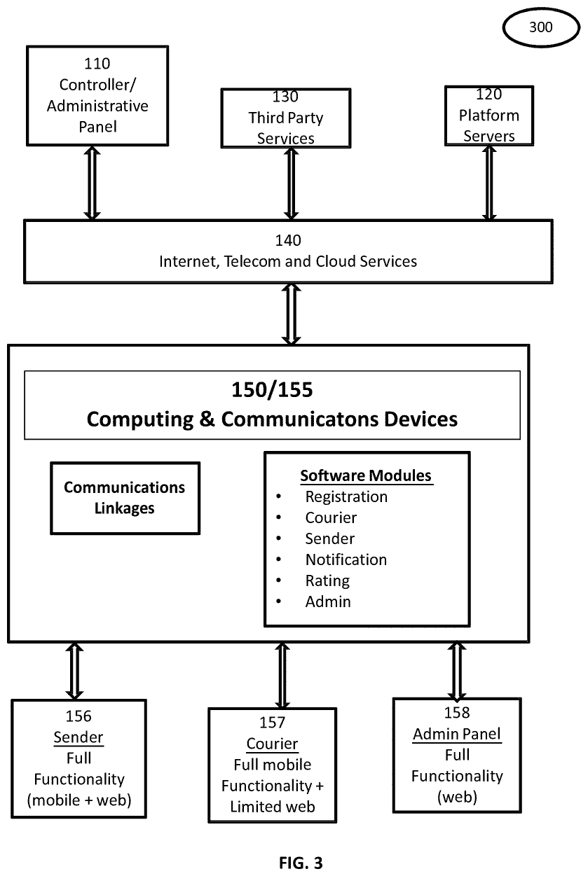

FIG. 3 is a block diagram of an embodiment showing more details, of the computing and communications devices (150, 155) including some of the software modules operatively coupled between Users (160, 180) of our electronic Platform, the communications interfaces (140), and the controller servers (130). FIG. 3 also indicates the level of functionality possessed by types of Users. For example: Sender users (156) have full functionality (both mobile and web); Courier users (157) have full mobile functionality but only limited web functionality; and Administrative Panel (158) operators have full functionality (web).

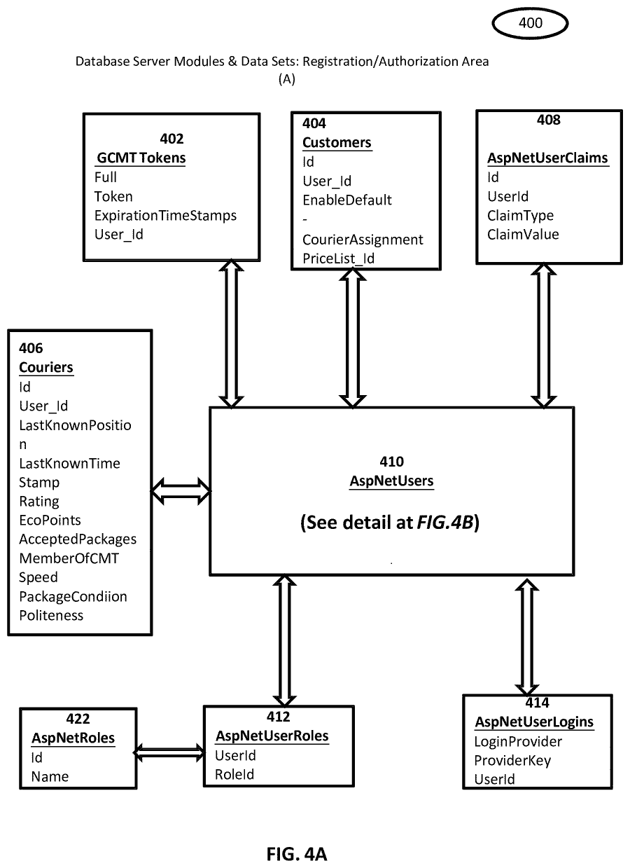

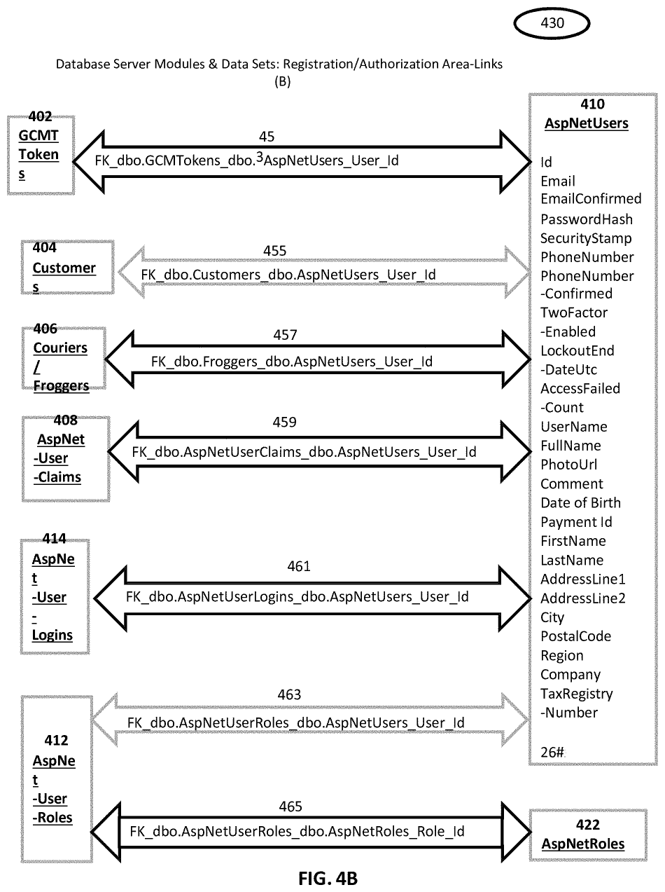

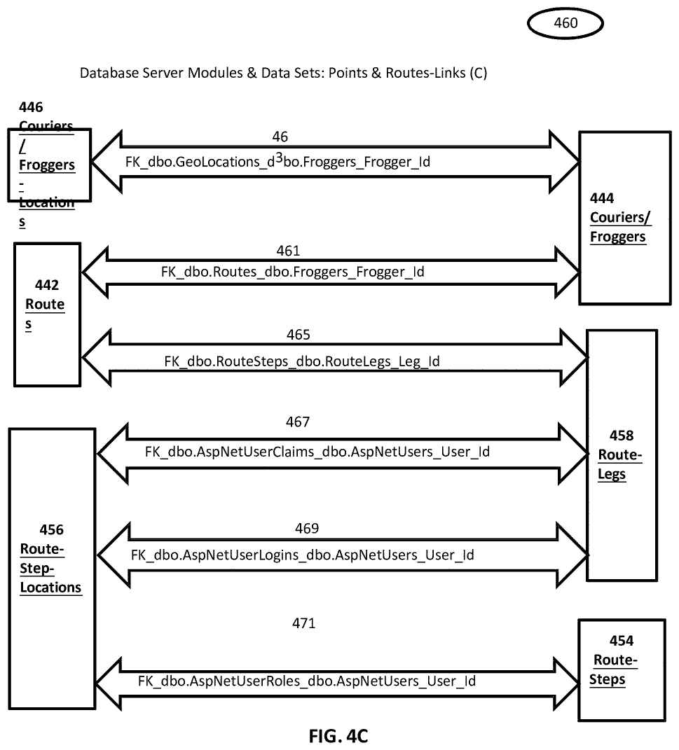

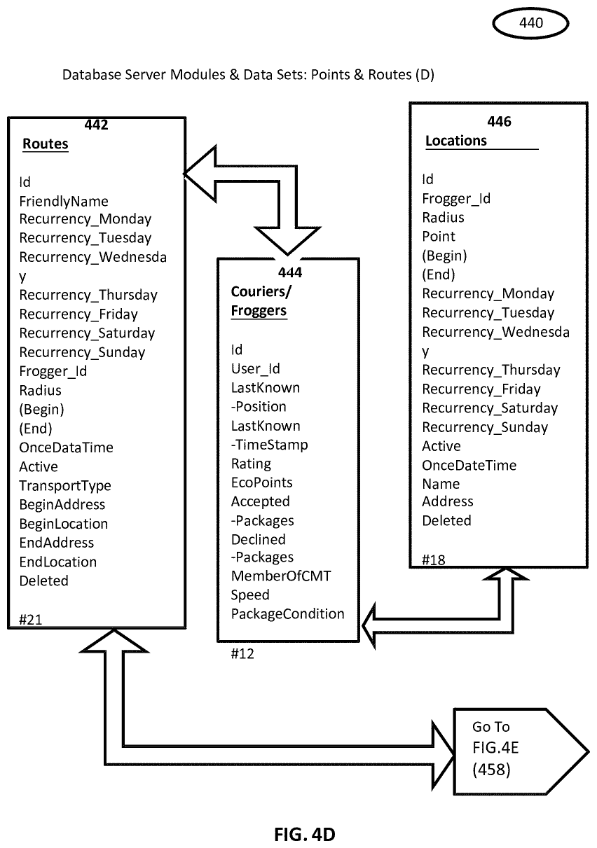

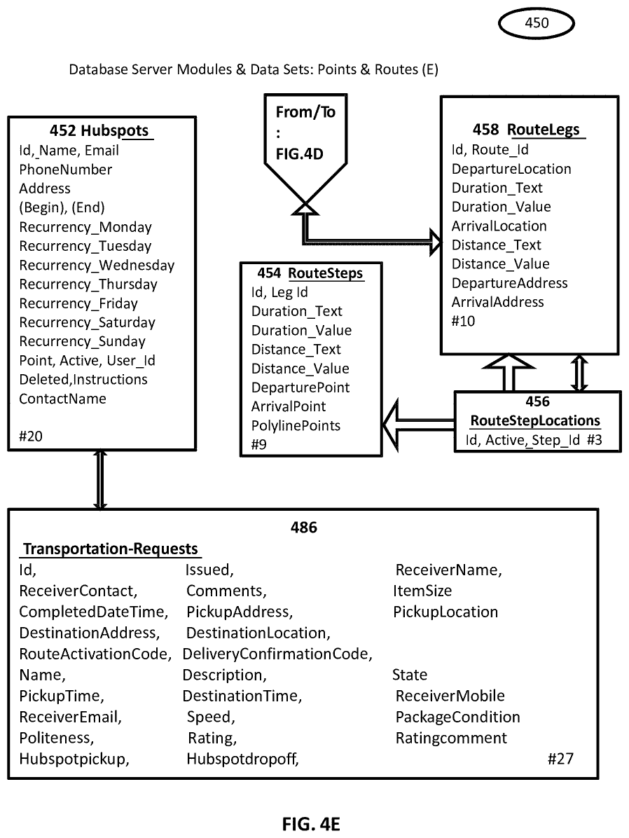

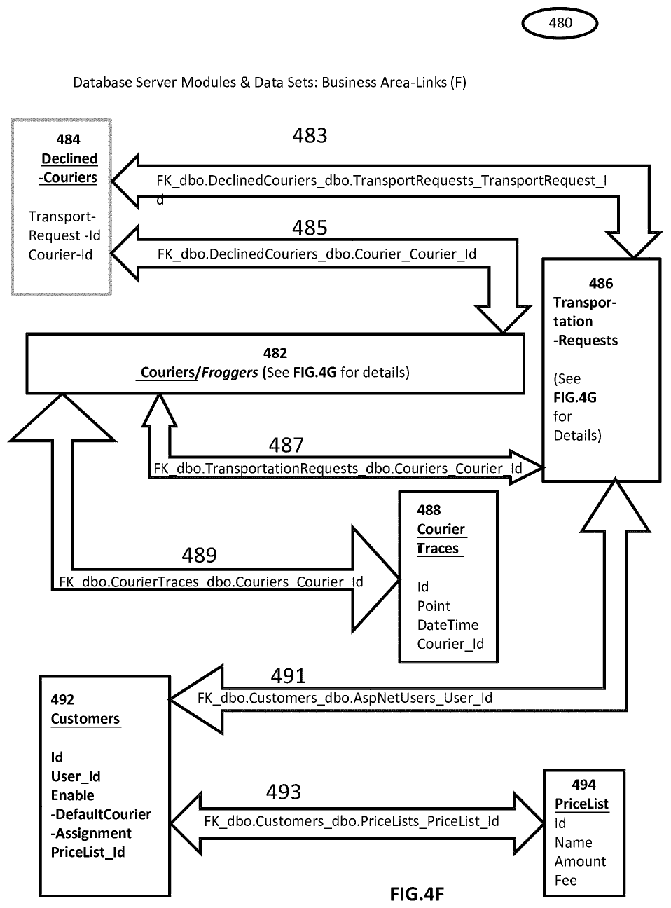

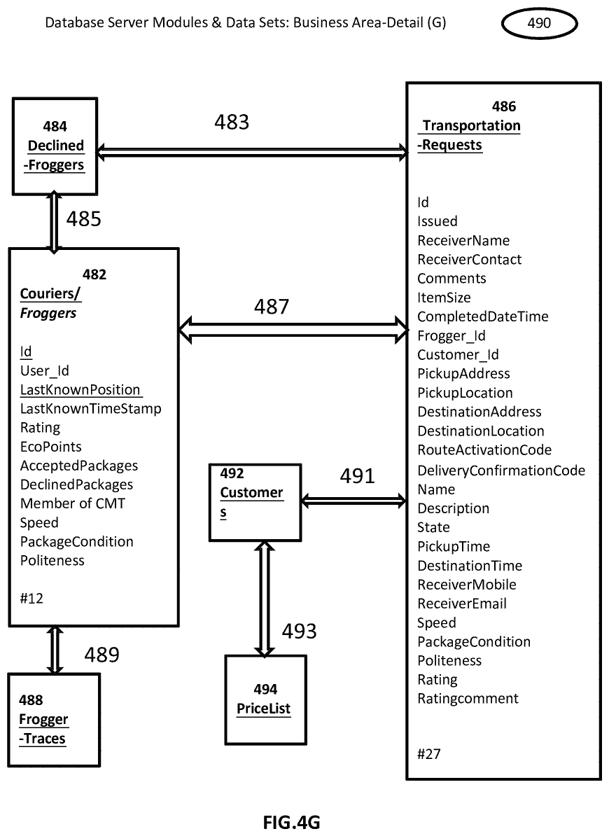

FIG. 4A is a block diagram of an embodiment showing more detail of software elements in an area of the Controller/database servers configured for Registration and Authorization. This area includes datasets and processing routines for: GMCT tokens (402), Customer profiles (404), Courier profiles (406), AspNetUserClaims (408), AspNetUsers (410), AspNetRoles (422), AspNetUserLogins (414), and AspNetRoles (422).

For example, the courier profile datasets (e.g., see elements 406@FIG. 4A, or 444@FIG. 4D) include Ecopoints data (406). In one embodiment of our Platform, courier Ecopoints are calculated on the basis of the distance he/she carried the parcel. {Note that “he” and “she” are used interchangeably herein.} In another embodiment, Ecopoints are computer by a mixture of factors, such as: as: the means of transportation used (e.g. car, moped, bike, truck, etc.), the distance covered, the time required for end-to-end delivery completion, weight/size of parcel send, CO2 emissions etc. EcoPoints serve as a parameter to distinguish between competence levels of couriers, as well as a means for collecting useful data for analysis (e.g. for upgrading given Cr profiles to a higher level, thus increasing their remuneration and/or other benefits).

FIG. 4B is a block diagram of an embodiment showing more details illustrating interactions among Controller server processing routines (402, 404, 406, 408, 412, 414) and transaction related AspNetUsers (410) datasets. For example, the AspNetUsers (410) component includes (but is not limited to) datasets for customer ID such as: email ID, Password hash, phone number, postal address, tax number, PhotoUrl, etc.

FIG. 4B also shows some illustrative links, and software program commands, used for enabling interactions among certain Controller server processing routines (402-408, 412-414) and the AspNetUsers (410) datasets. For example, for the above, such commands or computer control instructions include (but are limited to):

(453) FK_dbo.GCMTokens_dbo.3AspNetUsers_User_Id

(455) FK_dbo.Customers_dbo.AspNetUsers_User_Id

(457) FK_dbo.Froggers_dbo.AspNetUsers_User_Id

(459) FK_dbo.AspNetUserClaims_dbo.AspNetUsers_User_Id

(461) FK_dbo.AspNetUserLogins_dbo.AspNetUsers_User_Id

(463) FK_dbo.AspNetUserRoles_dbo.AspNetUsers_User_Id

(465) FK_dbo.AspNetUserRoles_dbo.AspNetRoles_Role_Id.

FIG. 4C is a block diagram of an embodiment showing more details illustrating interactions among Controller server processing routines, for computing (e.g., for pickups, hub stops, deliveries) geospatial points/locations (442, 446, 456), and potential linking routes/route-legs/route-steps (444, 454, 458) between points. FIG. 4C also shows some of the computer instructions used for these point-route computations. For example, such commands include (but are limited to):

(460) FK_dbo.GeoLocations_d³bo.Froggers_Frogger_Id

(461) FK_dbo.Routes_dbo.Froggers_Frogger_Id

(465) FK_dbo.RouteSteps_dbo.RouteLegs_Leg_Id

(467) FK_dbo.AspNetUserClaims_dbo.AspNetUsers_User_Id

(469) FK_dbo.AspNetUserLogins_dbo.AspNetUsers_User_Id

(471) FK_dbo.AspNetUserRoles_dbo.AspNetUsers_User_Id.

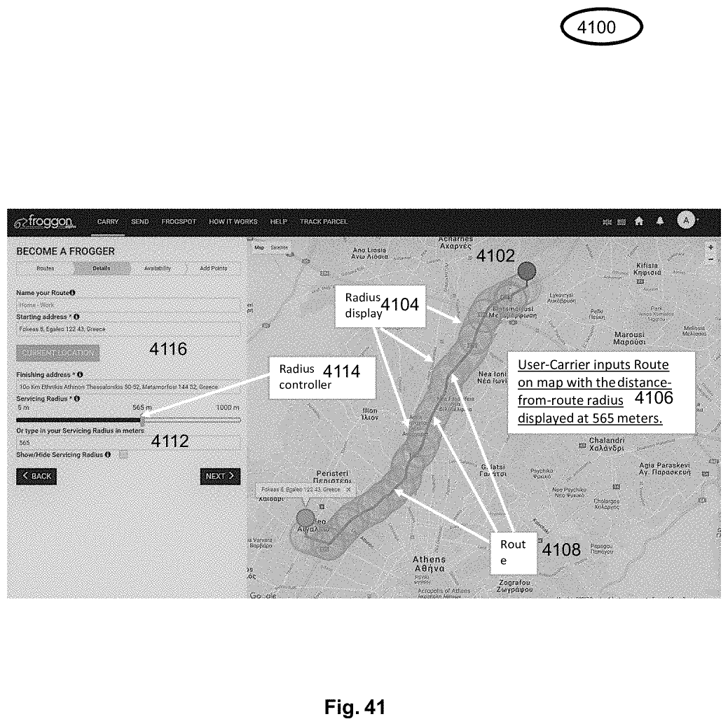

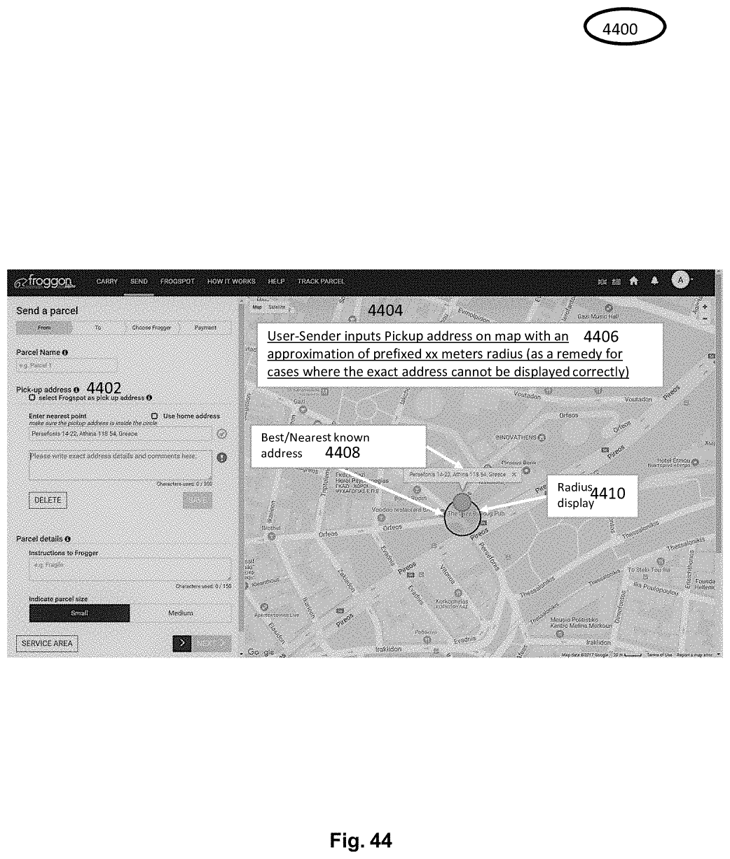

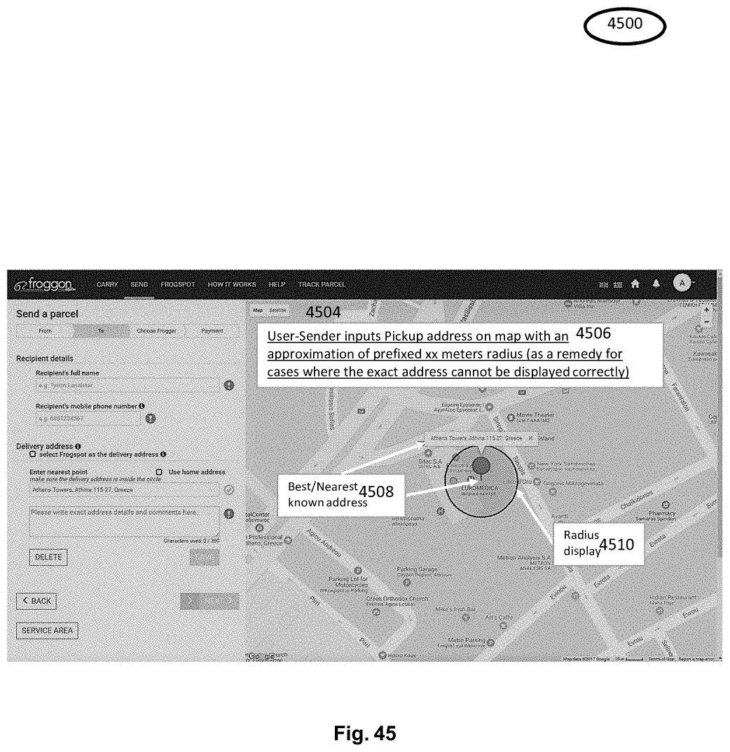

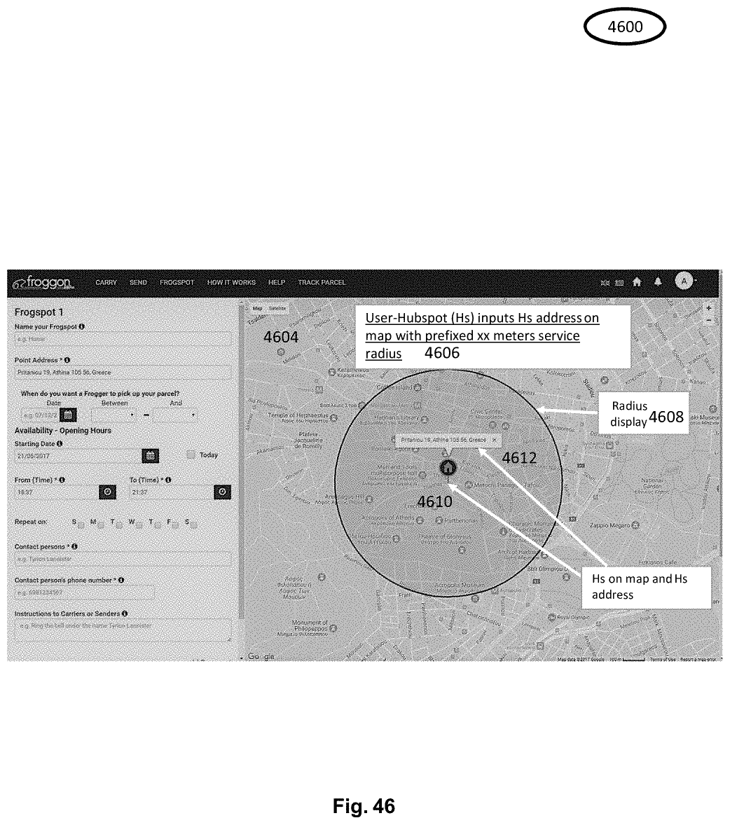

FIG. 4D is a block diagram illustrating an embodiment showing more details relating to datasets for: Routes (442), Couriers/Froggers (444), and Courier locations (446). For example, the Routes datasets includes coding for elements such as: recurrency (e.g., days of the week a given courier is available), begin/end radius, OnceDataTime, transport type, begin/end locations/addresses (442), etc. The Routes dataset (442) and the Courier dataset (446) also include “Radius” information. Note that data for radius calculations may be inputted: by a user-carrier (e.g., see FIGS. 41-43), by a user-sender (e.g., see FIGS. 44-45), or by a user-hubspot (e.g., see FIG. 46).

The Courier datasets include, for example, coding for: last know position, Timestamp, Rating, Ecopoints, declined/accepted packages, Speed, CMT member status, package condition, etc. (444). The Courier Location datasets also include, for example, coding for: begin/end points, daily recurrency, active status, OnceDateTime, etc. (446).

FIG. 4E is a block diagram illustrating an embodiment showing more details relating to database server modules such datasets for Hubspots, Transporation requests, and Points & Routes. For example, the Hubspots dataset (452) includes coding for elements such as: Id, Name, Email PhoneNumber, Address, (Begin), (End), Recurrency_Monday, Recurrency_Tuesday Recurrency_Wednesday Recurrency_Thursday Recurrency_Friday Recurrency_Saturday Recurrency_Sunday Point, Active, User_Id, Deleted, Instructions, ContactName, etc.

Similarly, the RouteSteps dataset (454) includes coding for: Id, Leg Id, Duration_Text, Duration_Value, Distance_Text, Distance_Value, DeparturePoint, ArrivalPoint , PolylinePoints, etc.

For example, the Polyline points are amenable to computational analysis and reconstruction. Consequently, through the combination of polyline points, simple as well as complex routes can be defined and computationally identified, analyzed and reconstructed (for display or other use as needed).

The RouteStepsLocation dataset (456) includes: Id, Active, Step_Id, etc. The RouteLeg dataset (458) includes coding for: Id, Route_Id, DepartureLocation, Duration_Text, Duration_Value, ArrivalLocation, Distance_Text, Distance_Value, DepartureAddress, ArrivalAddress, etc.

As further shown on FIG. 4E, the Transporatioin Requesst dataset (458) for example includes coding for: parcel ReceiverContact, Id, CompletedDateTime, DestinationAddress, RouteActivationCode, Name, PickupTime, ReceiverEmail, Politeness, Hubspotpickup, Issued, Comments, PickupAddress, DestinationLocation, DeliveryConfirmationCode, Description, DestinationTime, Speed, Rating, Hubspotdropoff, ReceiverName, ItemSize, PickupLocation, State, ReceiverMobile PackageCondition Ratingcoment, etc.

FIG. 4F is a block diagram illustrating logical linkages among different database server modules and business-area datasets. The annotated bidirectional linking arrows shown (on FIG. 4F), to illustrate instructional coding used to control interaction between such logic units, include:

link 483—between DeclinedCouriers (484) & TransportationRequests (486) modules;

link 485—between DeclinedCouriers (484) & Couriers/Froggers (482) modules;

link 487—between Couriers/Froggers (482) & TransportationRequests (486) modules;

link 489—between Couriers/Froggers (482) & CourierTraces (488) modules);

link 491—between TransportationRequests (486) & Customers (492) modules;

link 493—and, between Customers (492 & PriceList (494).

FIG. 4G is a block diagram which illustrates the same logical components as shown on FIG. 4F, but includes greater details for certain exemplary elements.

Id, User_Id, LastKnownPosition, LastKnownTimeStamp, Rating, EcoPoints, AcceptedPackages, DeclinedPackages, Member of CMT, Speed, PackageCondition, and Politeness. Note that some of the elements in this (482) dataset [e.g., speed, declined packages] might also impact calculation of the Ecopoints element in his dataset. EcoPoints thus can serve as a way to distinguish between levels of couriers as well as for collecting useful data for analysis (e.g. for upgrading their profile to a higher level thus increasing remuneration and/or other benefits).

Similarly (on FIG. 4G) TransportationRequests (486) module includes code for: Id, Issued, ReceiverName, ReceiverContact, Comments, ItemSize,

CompletedDateTime, Courier/Frogger_Id, Customer_Id, PickupAddress, PickupLocation, DestinationAddress, DestinationLocation, RouteActivationCode, DeliveryConfirmationCode, Name, Description, State, PickupTime, DestinationTime, ReceiverMobile, ReceiverEmail, Speed, PackageCondition, Politeness, Rating, and Ratingcomment.

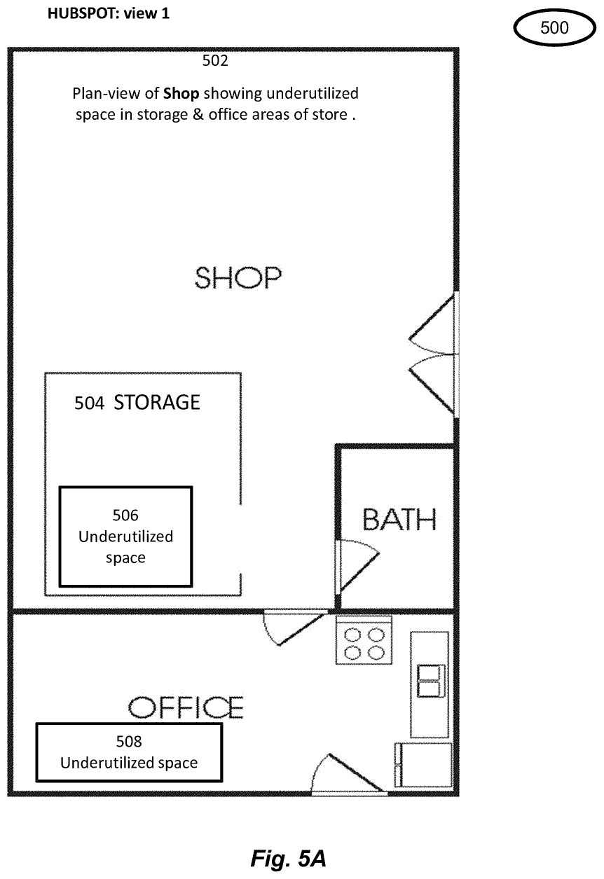

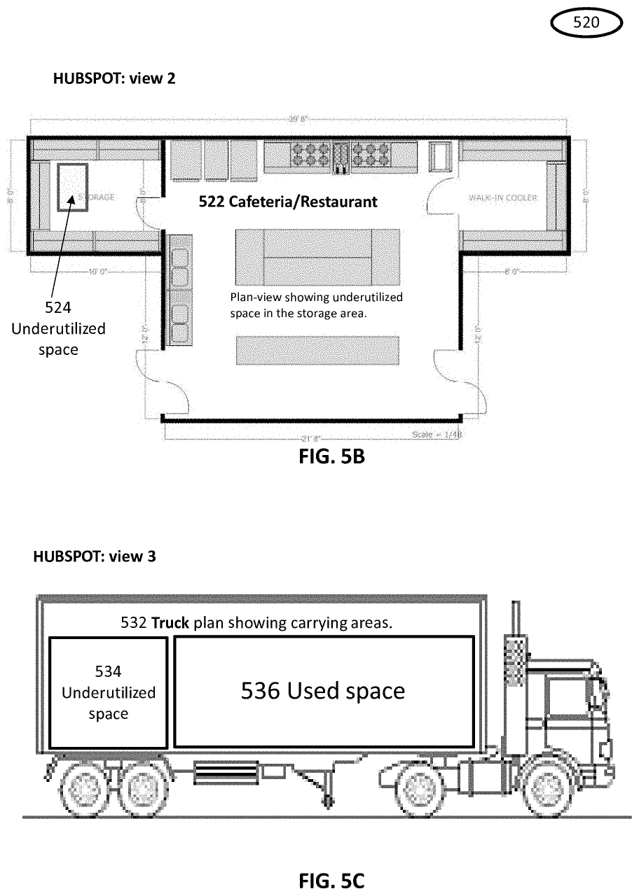

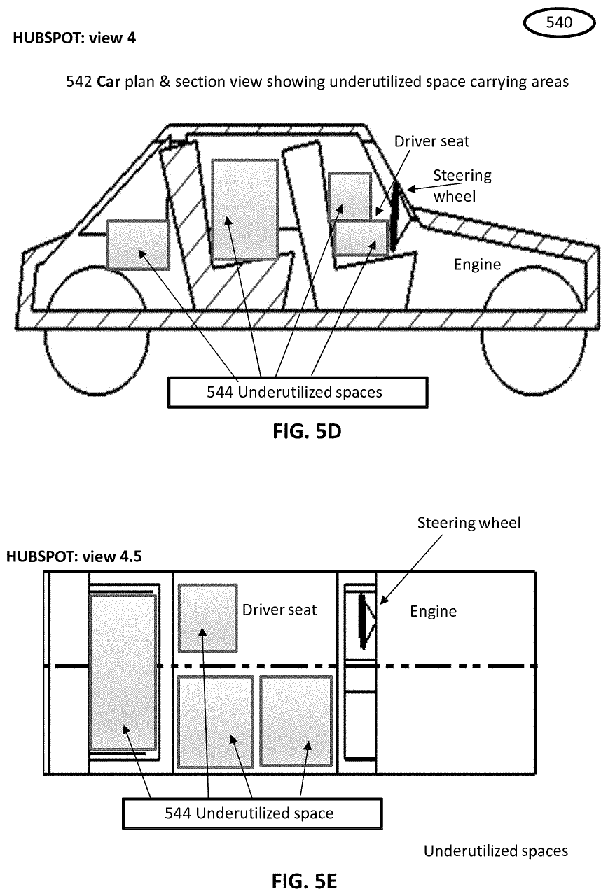

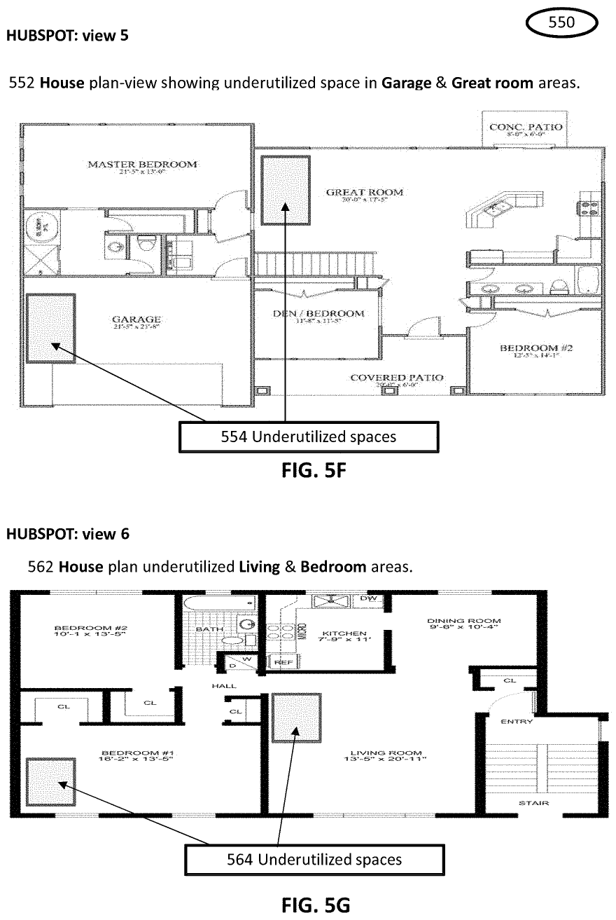

FIG. 5A is illustrates an exemplary hubspot, with available storage/carrying capacity, in a shop or store. For example, block 506 and block 508 illustrate how such underutilized space might be physically situated in storage and/or office areas of a service shop (e.g., Dry Cleaning/Barber/Beauty shop) or a retail shop (e.g., Grocery/Candy store or Pharmacy).

FIG. 5B Illustrates a hub spot with available storage/carrying capacity (524) in a cafeteria or restaurant.

FIG. 5C Illustrates Illustrate a hubspot with available storage/carrying capacity in back areas (534, 536) of a tractor-trailer truck.

FIGS. 5D & 5E Illustrate two views of a hubspot with available storage/carrying capacity—in the front & back areas (544) of a passenger automobile.

FIGS. 5F & 5G Illustrate a hubspot with available storage/carrying capacity in a home or residence. For example, this might be in a garage (554) or in different rooms (564) of a house.

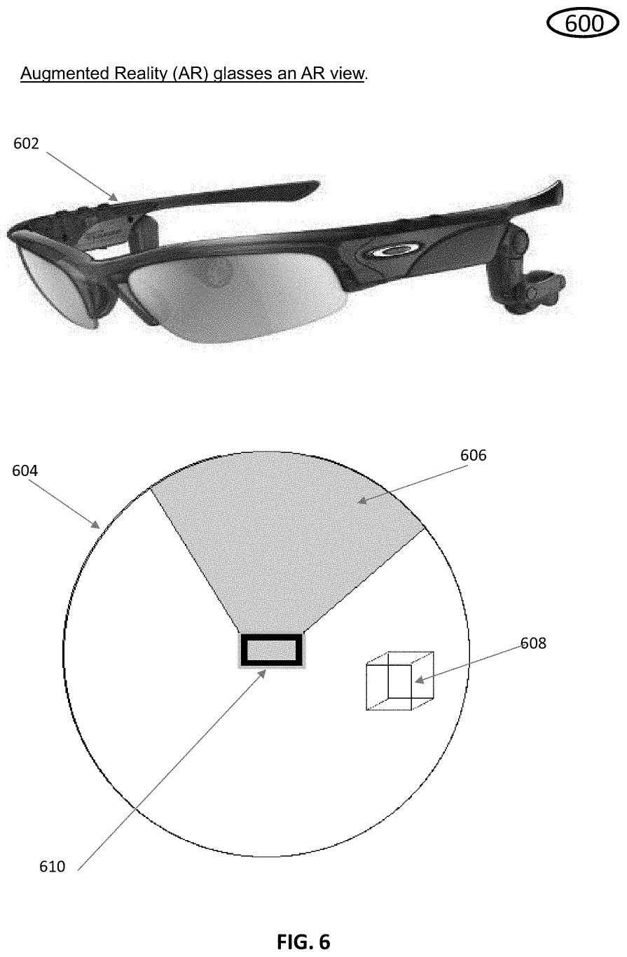

FIG. 6 is an illustration (600) of a type of Augmented Reality (AR) input device usable with our Platform (600). The main apparatuses/equipment for our AR system are displays, input devices, tracking, and computers.

Displays used for our AR processing typically include (but are not limited to): head mounted displays or “HMD” (including virtual retina displays and bionic contact lenses), handheld displays, and spatial displays. An HMD is a display device worn on the head or as part of a helmet and that places both images (608, 610) of the real and virtual environment over the user's view of the world. HMD can either be video-see-through or optical see-through and can have a monocular or binocular display optic. Virtual retina displays display information directly on the retina. Additionally, bionic contact lenses are worn in the eye(s) in a contact lenses fashion and perform similar functions to the HMD displays. FIG. 6 illustrates an exemplary eyeglass type of HMD device (602).

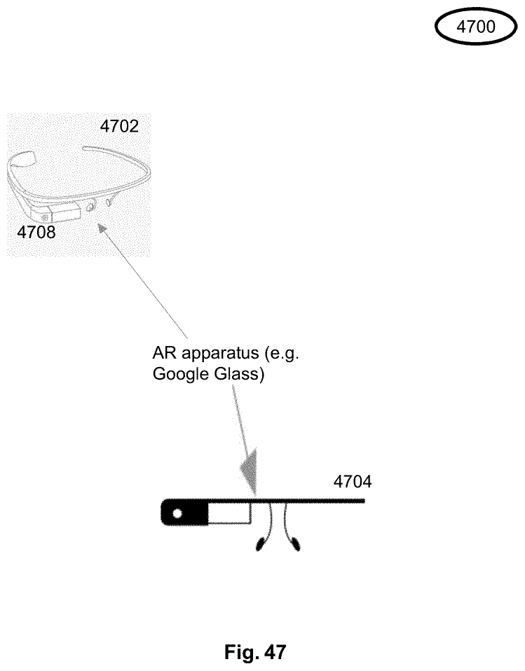

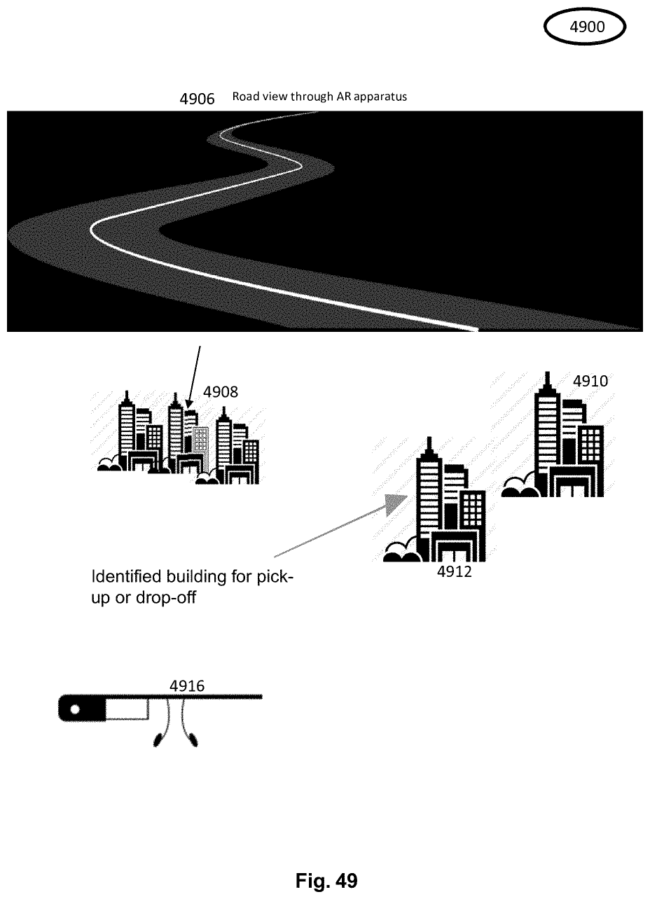

Input devices for our AR processors can include (but are not limited to): special gloves, wireless wristbands, smart-watches, and smart-phones (e.g. the phone itself can be used as a pointing device). Furthermore, gaze and gesture interaction with a number of wearable devices—e.g., HMD displays (such as Google Glass©), can be used as input means. For example, see FIGS. 47, 49 & 51. Similarly, if a user employs a handheld ECD with a touch screen display, the screen itself can also be utilized as an AR data input device.

Tracking device technologies usable with our AR system include (but are not limited to): digital cameras and/or other optical sensors (be it marker-based, marker-less, outside-in, inside-out optical technologies), GPS, accelerometers, gyroscopes, solid state (e.g. electronic) compasses, wireless sensors, WiFi, magnetic (including the Earth magnetic field as well as steel shells of buildings), ultrasound, inertial, infrared, Bluetooth©, ultra-wideband tracking systems, RFID (both active and/or passive), computer vision tracking techniques, and hybrid combinations of such and/or similar technologies.

Tracking methods for our Platform depend on the type of environment/ecosystem at a given Cr/Hs space. Given the diverse set of Cr/Hs spaces (500, 520, 540, 550) that our Platform accommodates, often no assumptions can be made about the 3D geometry (608) of the scene (606). For these types of variable 3D geometry (608) situations, we use SfM (Structure from Motion) methods such as feature point tracking and camera parameter estimation (or similar technologies) for reconstructing and registering (1218, 4006) views of the underutilized carrying/storage spaces [see FIGS. 5A through 5G (506, 508, 524, 534, 544, 554)].

Computers for our Platform (as indicated previously) include both centralized and decentralized elements. For example, some of the data processing takes place through our Platform utilizing remote/central elements (e.g., our own AC servers or cloud servers) and some of the computing takes place through the Platform but by using the processing power of the users' ECD.

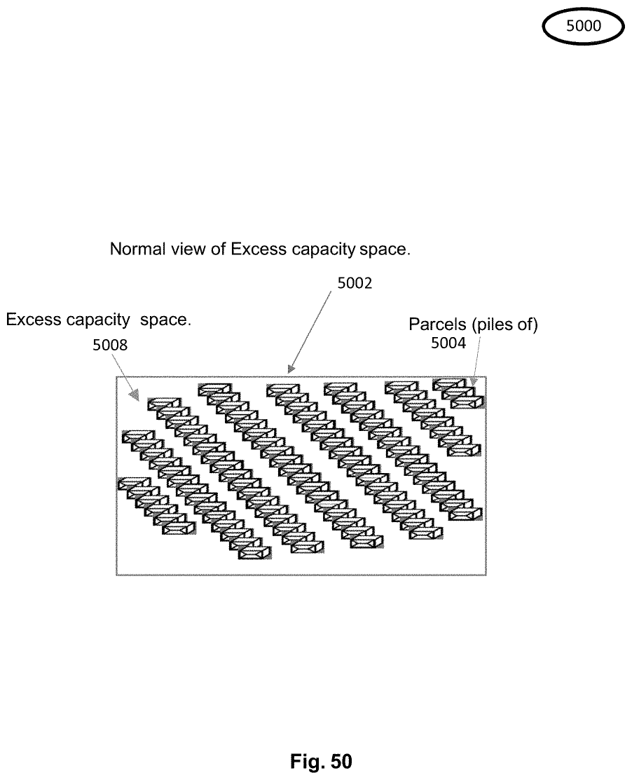

Our Platform can use both 2D and 3D imaging (608). In some embodiments we use a mixture of AR and advanced image processing including computer vision methods for assessing the space availability (606) within a carrying container/storage space (604). This provides a solution to the problem of knowing live the available space (e.g., see element 5008 at FIG. 50) of a registered carrying space/storage area, thus allowing more accurate directing of orders placed for delivery.

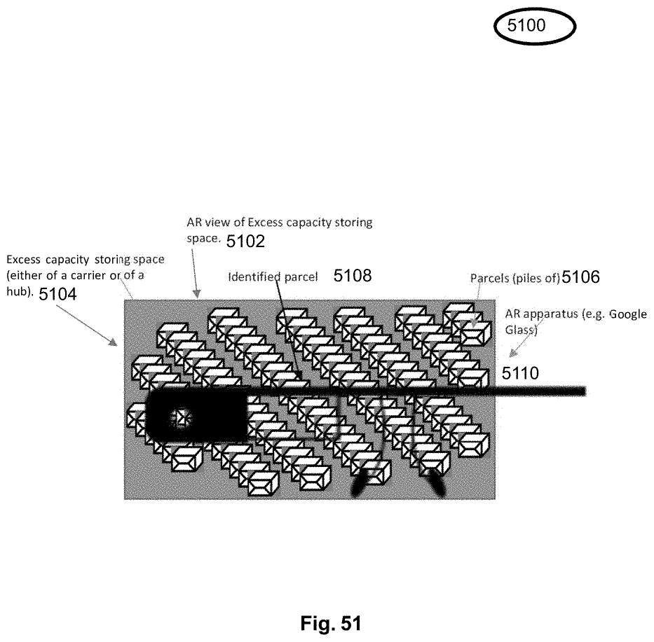

Our Platform also incorporates use of AR markers (and other tracking means such as RFID) for identifying (610) target packages (5106); and for computing the optimal arrangement of groups of parcels (see FIG. 50). AR thus provides a solution to the problem of having a truckload/heap (5004) of parcels with a person trying to manually (i.e., visually) identify the correct parcel (5108). For example, compare FIG. 50 (Normal view of Excess capacity space) and FIG. 51 (AR view of Excess capacity space).

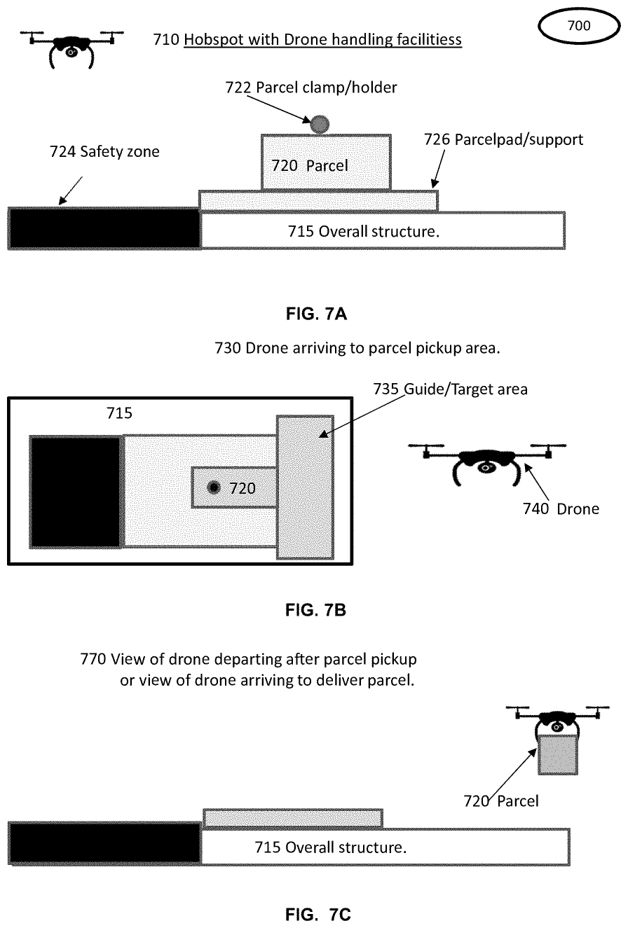

FIG. 7A & 7B illustrate a drone in flight approaching a hubspot, with drone-handling facilities (710), to pick-up a parcel (720). The drone landing zone structures include: a dedicated overall supportive structure (715) or base physical element (e.g., table/platform/ramp, net, ground, roof, empty swimming pool, etc).

As shown on FIG. 7A, the parcel awaiting pickup can be positioned (mechanically or manually) between a parcel holder—such as a clamp (722), and a parcel support—such as a pad (726), or other structures configured to hold the parcel in place. Our drone landing zone also includes a safety zone (724). For example, the drone might drop the parcel in the safety zone in the event of an incomplete/improper pickup.

FIG. 7B shows a view (730) of a drone arriving at a parcel pickup area. Some embodiments also include guide means/target area (735) to help navigate the drone (740) toward the awaiting parcel (720).

FIG. 7C is an illustration of a view (770), after parcel pickup, of a drone flying away from a drone handling hubspot with a parcel (720) that it picked up at the hub.

Next we turn to more detailed descriptions of some embodiments, of our electronic logistics control platform (“ePlatform”). These (along with the appended claims and drawings) help illustrate how our systems and processes work to: match up senders, receivers, and other ePlatform users; and to coordinate and facilitate parcel flow from along routes from one geographic point to another point.

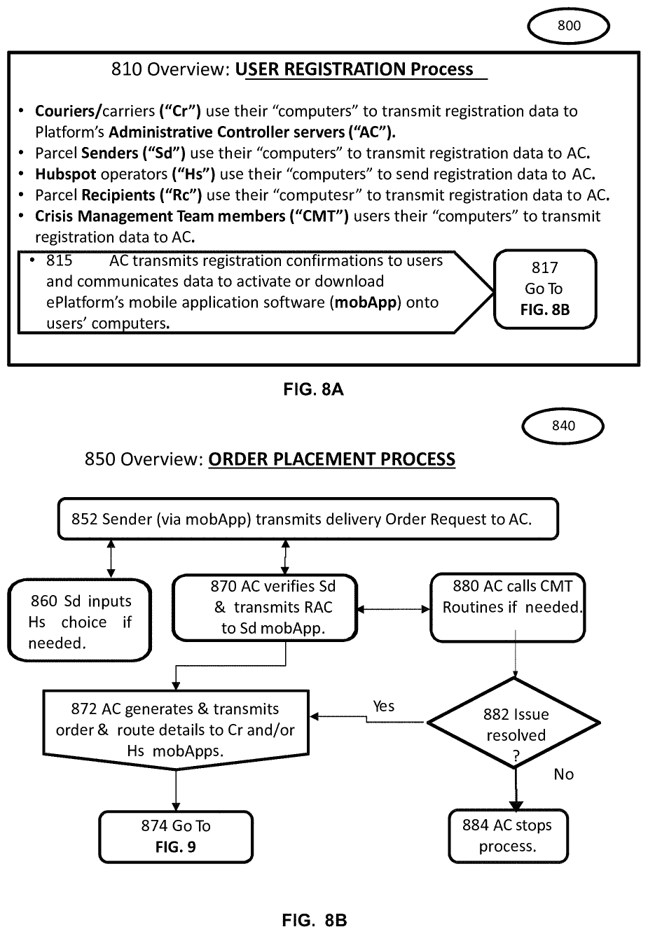

FIG. 8A is an overview diagram of the User Registration Process (800). Block 810 lists some of the parties (collectively, “Users”) who interact with our ePlatform. Such Users include: parcel transporters or Couriers/carriers (“Cr”), Parcel Senders (“Sd”), Hubspot operators (“Hs”), Parcel Recipients (“Rc”), and Crisis Management Team member (“CMT”) users.

Prospective users can transmit requests to be registered with our ePlatform through different types of electronic communications devices (“ECDs”). Such ECDs may be cell phones, tablet/laptop digital computers, etc. ECD control elements, or “computers”, may be real or virtual. In other words, some of the electronic/logical computer components (e.g., memories, processors, I/O) may be physically part of the device structure itself; or may be remotely located (e.g., at a physically separate server or in the Cloud), but operatively coupled to other ECD components.

Registration requests may or may not be accepted, based on internal criteria (such as location, type of conveyance, prior history, etc). If the prospective users are accepted, their “computers” are then adapted or configured to transmit their registration data to servers that are part of (or communicatively coupled to) our ePlatform's Administrative Controller (hereinafter, “PAC” or “AC”). After the PAC receives registration data from accepted users, it transmits registration confirmations to such users (815).

In addition, the PAC then effectively converts the (general purpose) ECD computers into specialized computers, and upgrades the technological capabilities of the ECDs, for operational interaction with the technology of our ePlatform. The PAC effects this reconfiguring/specializing of the ECD by communicating data to the user ECD to activate or download our ePlatform's mobile application software (mobApp) onto users' computers (815). Thereby the user's ECD machine is adapted or modified for parcel handling operations. A given sender-user is then equipped to begin package processing activities such as order placement (817).

FIG. 8B is an overview (840) diagram of the Order Placement Process (850). Initially, a parcel sender (“Sd”) uses his (previously downloaded) mobApp to transmit a delivery Order Request to the AC (852). At step 860, the Sd inputs his hubspot (Hs) choice, if needed. At step 870 AC verifies the Sd (e.g., Is he a registered user?); and thereafter transmits a RAC to the Sd's mobApp. At his point the AC may also callup CMT software Routines (880), if needed to resolve an issue with the Sd order. If the issue is not resolved (882), the AC stops the Order Placement process (884).

If there is no issue with the order, or the issue is resolved (882), then the AC generates & transmits (872) order & route details to the mobApps of the Cr (courier) and/or Hs (Hubspot). The system then proceeds to the Order Pickup process (874).

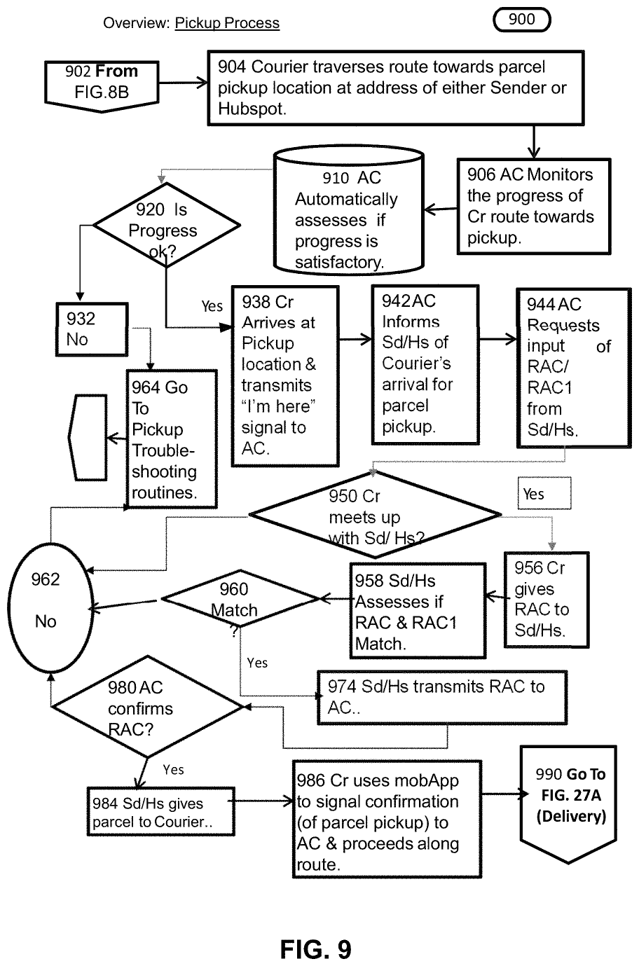

FIG. 9 is an overview diagram of the Pickup Process. At step 904, a courier (Cr) traverses a route (from his starting location) towards a parcel pickup location, at either a Sender address or a Hubspot address, which had been transmitted to Cr by the AC. The AC monitors the progress of Cr along his route towards pickup (906); and automatically assesses if progress is satisfactory (910).

If the Cr's progress is NOT ok (920,932), the AC automatically calls up software routines for Pickup-Process-Troubleshooting (964). If Cr progress is OK (920); when the Cr arrives at the Pickup location, the Cr uses his mobApp to transmit an, “I'm here” signal, to the AC (938). AC then informs Sd/Hs of Courier's arrival for parcel pickup (942); and AC requests input of RAC/RAC1 from the Sd or Hs (944). At step 950, there is a determination of whether the Cr meet-up with the Sd/Hs was ok. If not, process goes to the Pickup-Troubleshooting-Routines (964).

If meet-up was Ok, Cr gives RAC to Sd/Hs (956). Sd/Hs then assesses if RAC & RAC1 match (958). If no match, then process goes to Pick-up-Trouble-shooting Routines (964). If match is Ok, Sd/Hb uses mobApp to transmit RAC to AC (958); and AC determines whether to confirm the RAC (980). If RAC is NOT confirmed, then process goes to Pick-up-Trouble-shooting Routines (964). If RAC is confirmed, then Sd/Hs gives parcel to Courier (984). Next, the Cr uses his mobApp to signal confirmation (of parcel pickup) to AC, and Cr proceeds along route toward delivery of package (990).

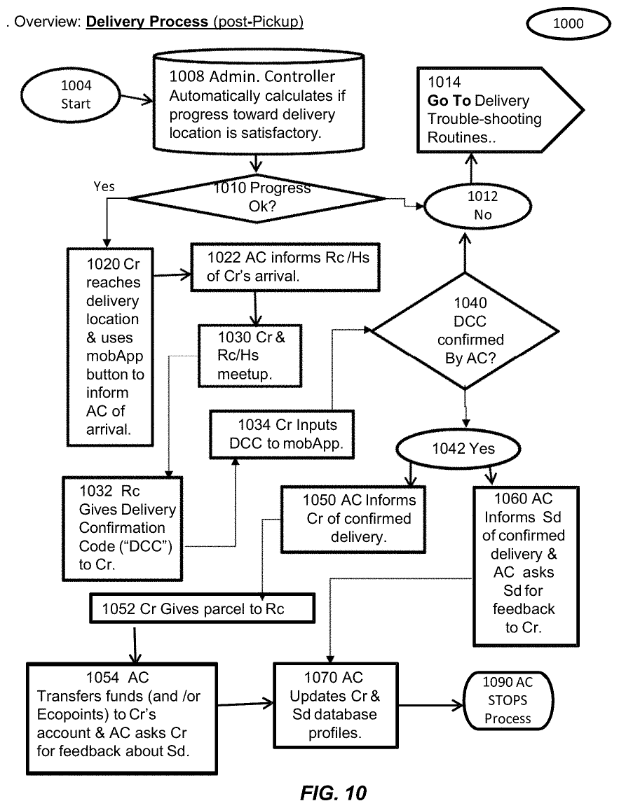

FIG. 10 is an overview (1000) diagram of the Delivery Process (post-pickup). At step 1008, the AC automatically calculates whether progress toward the delivery location is satisfactory (1010). If NOT (1012), the AC calls up Delivery Trouble-shooting Routines (1014).

On the other hand, if progress is OK (1010), when he reaches the delivery location; the Cr engages a mobApp button on his ECD to inform the AC of his arrival (1020). AC then informs the package collector at the delivery location (i.e., the Receiver or Hubspot)) of Cr's arrival (1022). Cr then meets up with the Rc/Hs (1030). Next, Rc/Hs gives Delivery Confirmation Code (“DCC”) to the Cr (1032); and Cr inputs DCC at his mobApp for transmission to AC (1034). If AC does NOT confirm DCC (1040), then process goes (1012) to Delivery-Trouble-shooting Routines (1014).

If DCC is confirmed (1042): AC Informs Cr of confirmed delivery (1050); and Cr Gives parcel to Rc (1052). AC then electronically transfers funds (i.e., payment for making a successful package drop-off) to Cr's account. AC may or may not also electronically credit Cr's account with Ecopoints. AC also asks Cr for feedback about Sd (1054), through the mobApp. The process then proceeds to step 1070.

Simultaneously, after confirmation of DCC (1042), the AC informs Sd of confirmed delivery and asks Sd for feedback about Cr (1060) through the mobApp. The process then proceeds to step 1070; where the AC updates Cr and Sd database profiles. At step 1090, the AC STOPS the process.

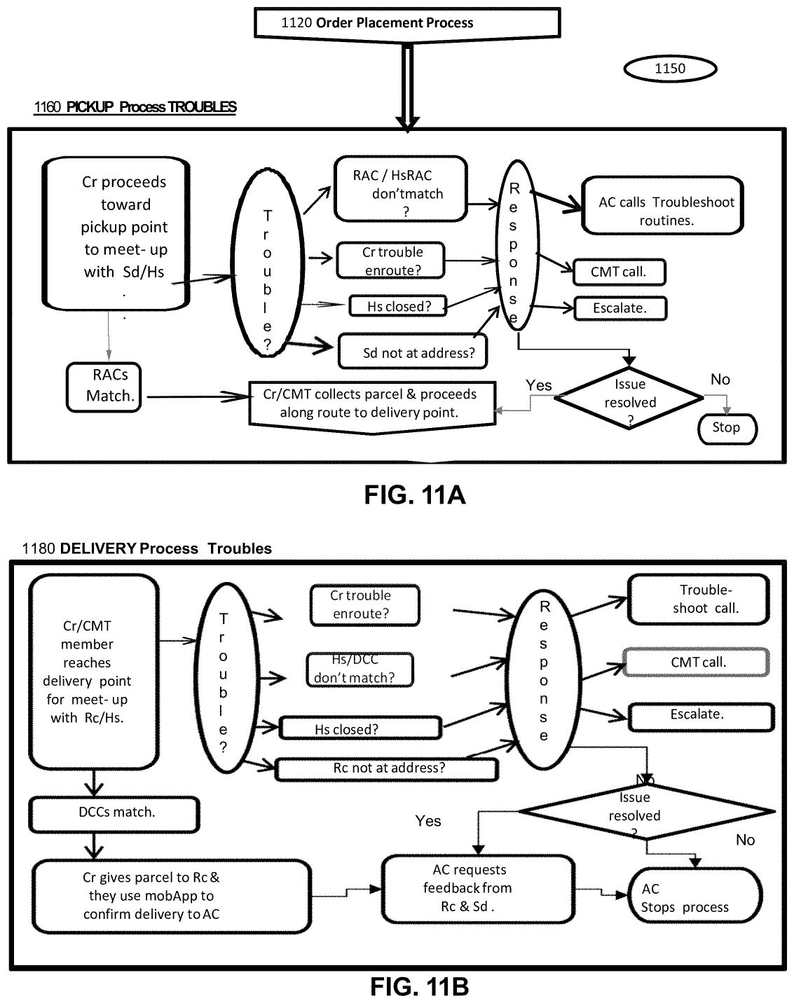

FIGS. 11A & 11B illustrate logical overviews of Problem Resolution procedures during the parcel Pickup and parcel Delivery Processes (1150). For example, issues/troubles that can arise the, while a Cr is attempting to pick-up a parcel from a sender or hubspot (1160), or deliver a parcel to a receiver/hubspot (1180) include: RAC/HsRAC don't match; Cr encounters trouble enroute (e.g., injury/accident/obstruction); Hs closed or Sd not at address in system (when Cr arrives); etc.

Some of the remedies employed in our system include: automated AC subroutine calls to Troubleshooting program modules (e.g., for verification/correction of address or timing data); activation of a CMT (Crisis Management Team) member by AC; or (if necessary), Escalation of issue to a higher management level. Note that CMT members are more experienced and skilled than regular couriers. [See later figures or more details.] Typically, they also have previously proven themselves adept at handling particular types of problems. Moreover, our PAC database includes information to help determine an appropriate CMT selection using stored data such as: proximity to Cr's route, availability, skill level in dealing with the type of issue currently being encountered by the Cr, etc.

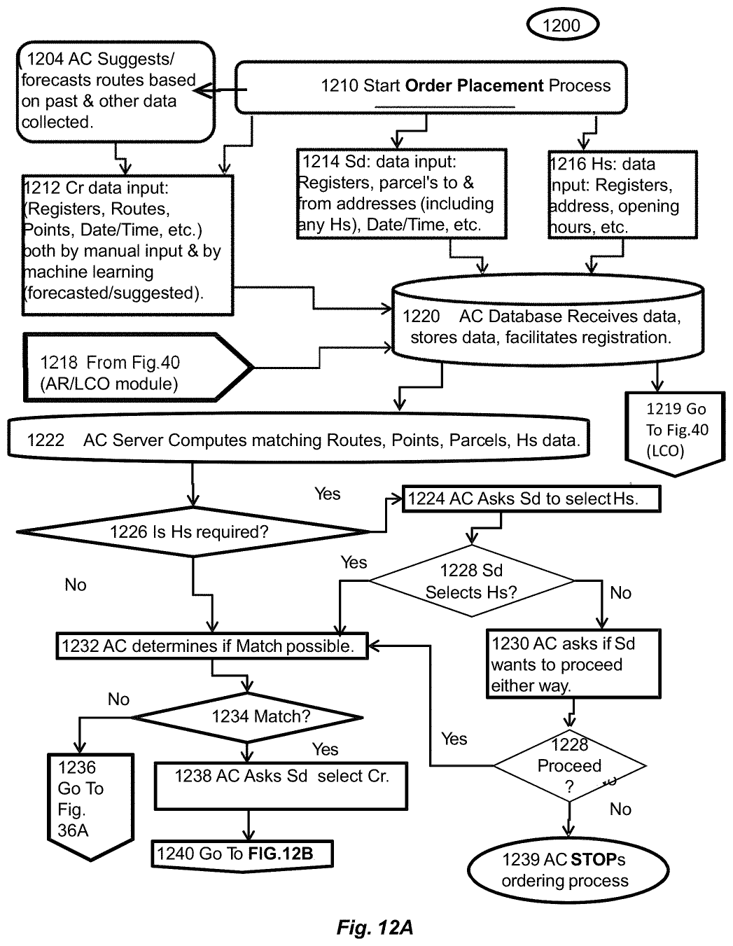

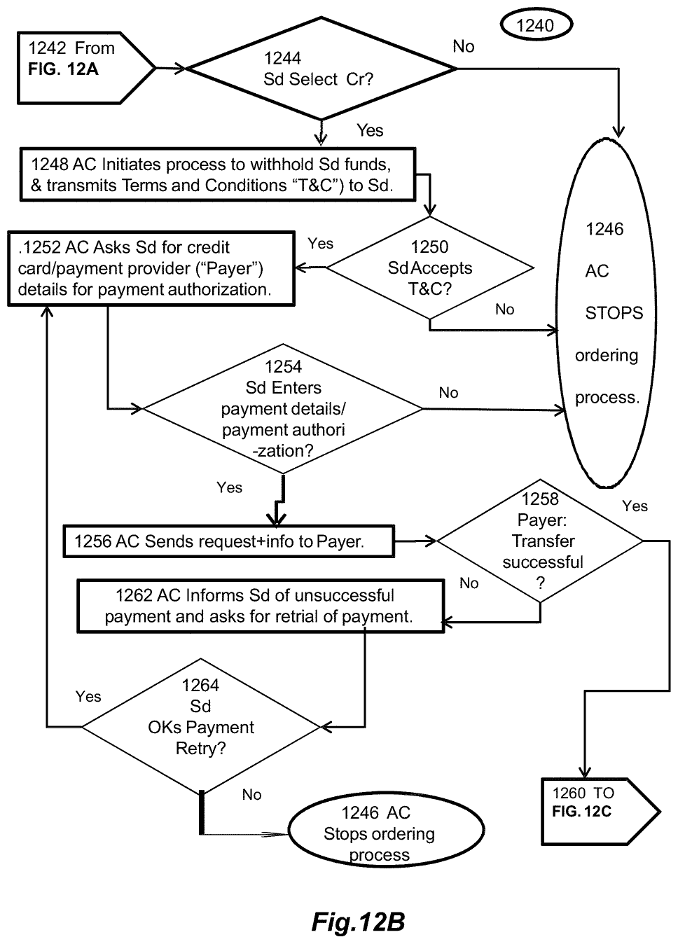

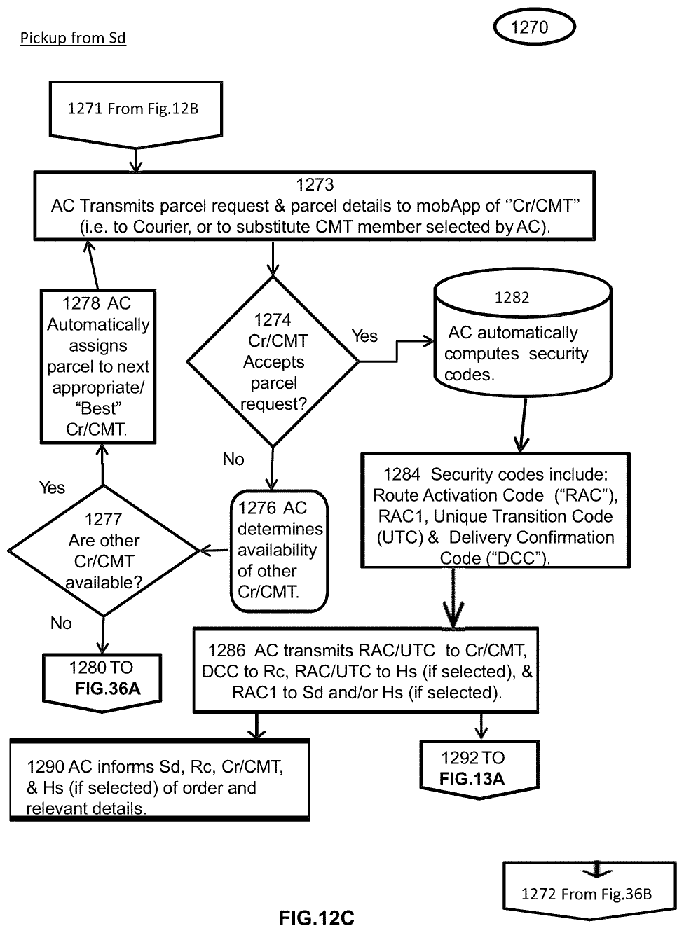

FIG. 12A is a logic flowchart for the Order Placement Process (1200). The PAC Database receives and stores information from a plurality of users and other sources (1210, 1220). For example, the PAC Database stores information from public sources like State Highway/Transportation Departments (e.g., road construction/closures), natural obstructions (e.g., flooding/fallen trees across roadways); GPS/weather satellites; and other third party sources. The AC uses such collected data and other historical information, along with machine learning and other Artificial intelligence (AI) generated data, to calculate/forecast/predict/suggest best available routes from one given geospatial point to another geographical point. (1204, 1212). Sender data input includes: registration data, parcel (to & from) addresses (including any Hs the Sd wishes to use), Date/Time, etc. (1214).

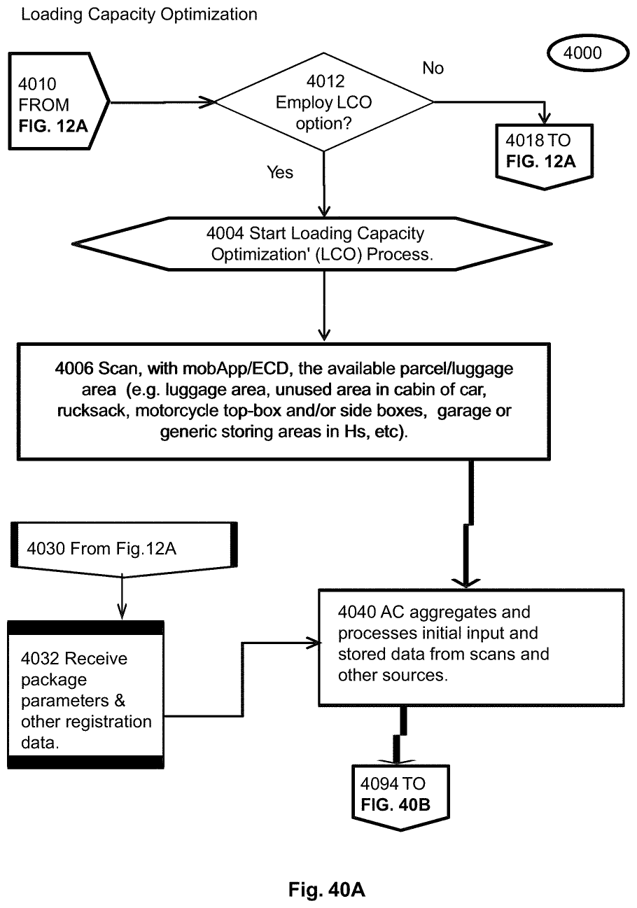

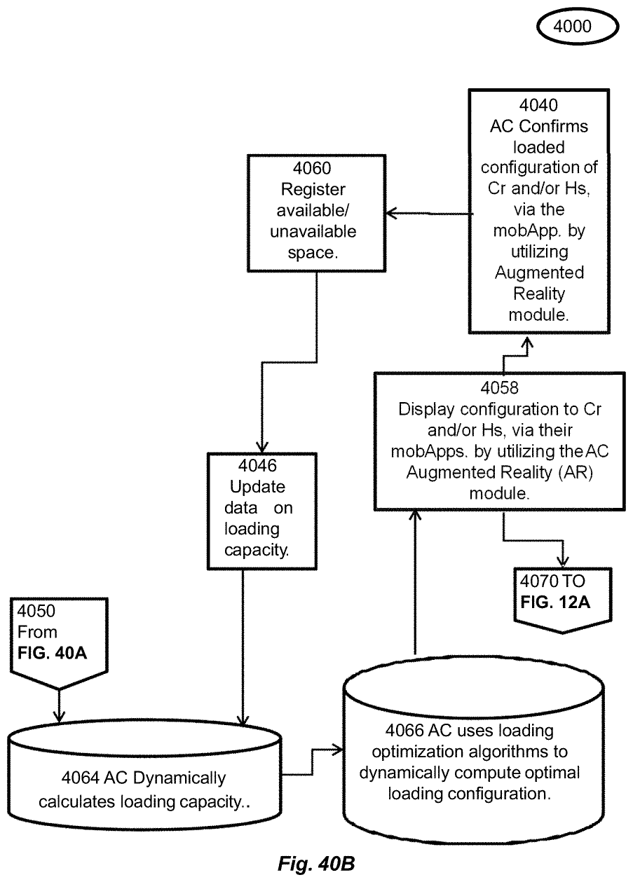

AC database software controls processing of input data and facilitates registration by users (1220). Hubspot input data includes: registration data, address, hours of operation, holding capacity, etc. (1216). Courier input (both manual and machine learning data) includes: registration data, routes & points within his capacity, dates/times available, etc. (1212). AC database also receives data from (1218), and sends data to (1219), our platform's LCO (Loading Capacity Optimization) process module (e.g., see FIG. 40).

AC Server algorithms compute matching Routes, Points, Parcels, and Hs data based on requirements for efficient execution of the Sd's order (1222). If the order does not require an Hs, process goes to step 1232. If the order does require an Hs, AC transmits list of possible Hs to mobApp of Sd, and asks Sd to select one (1224). If Sd does not select an Hs, AC asks if Sd still wants to proceed (1230). If Sd elects to not (1228) proceed, AC STOPS ordering process (1239).

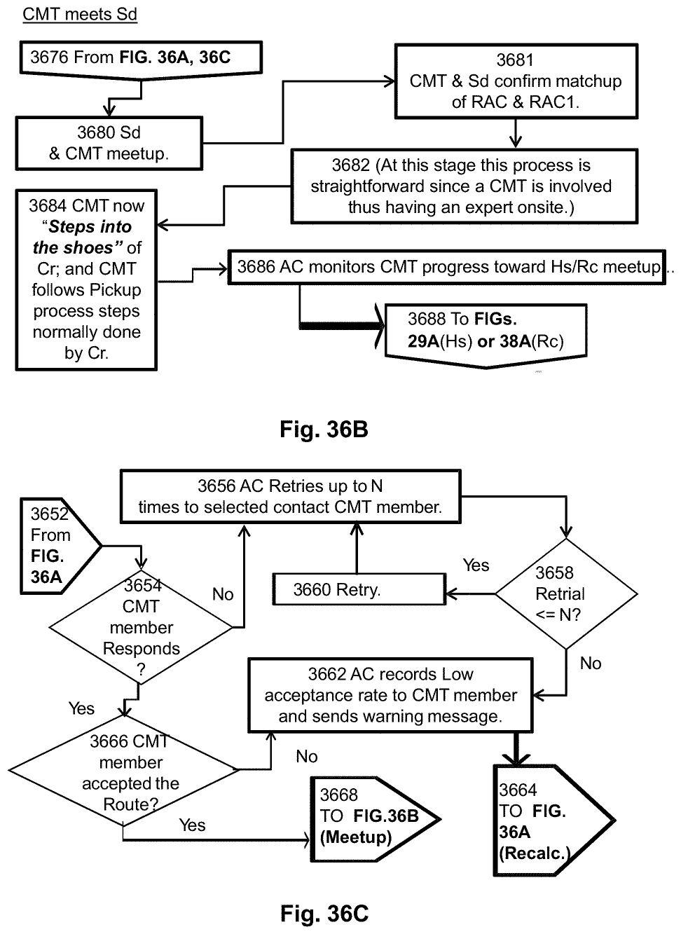

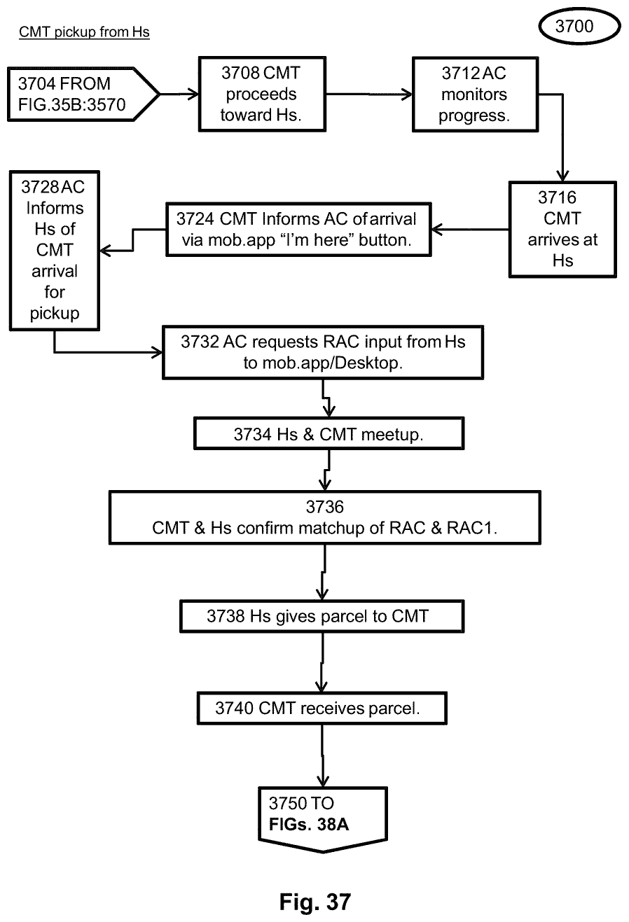

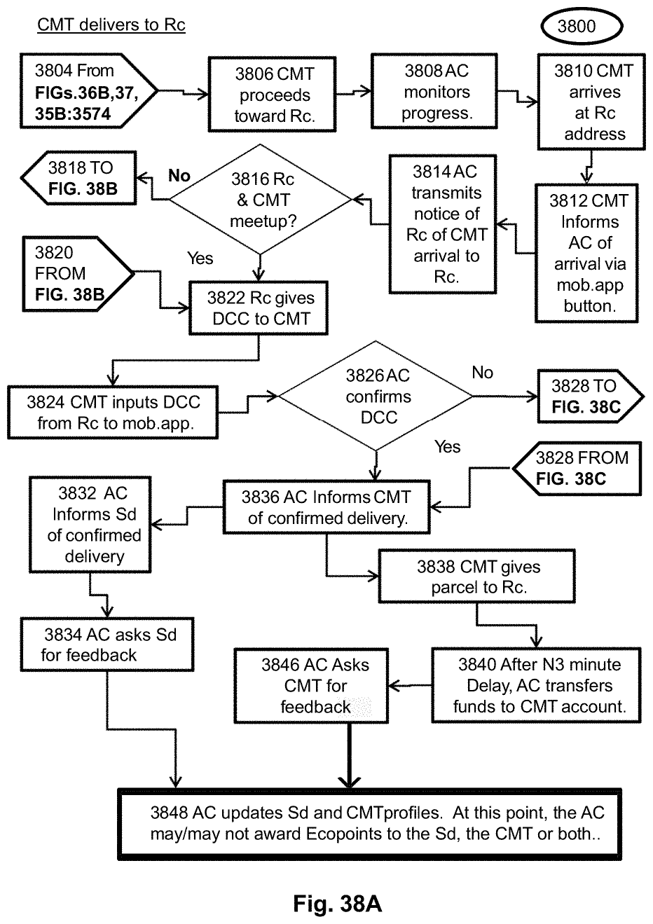

If Sd elects to proceed (without use of an Hs), process goes to Step 1232, where the AC determines if a Cr match is possible with an available Cr. If no match is possible, process goes (1236) FIG. 36A, where the system evaluates possible use of a CMT. If a Cr match is possible (1232), AC transmits list of matched Hs to mobApp of Sd, and asks Sd to select one of the matched Hs's (1240).

FIG. 12B is a logic flowchart illustrating continuation of the Order Placement Process (1240). If the Sd does not select one of the matched Cr's proffered by the PAC, the process goes to Step 1246. If Sd selects a Cr, then the AC Initiates process steps to withhold Sd funds, and to transmit Terms and Conditions (“T & C”) to Sd (1248). If the Sd does not T & C, the process goes to Step 1246. If the Sd accepts T & C, then AC asks Sd use his mobApp to input credit card/payment provider (“Payer”) details for payment authorization (1252). Sd enters payment details and AC seeks payment authorization (1254).

If Sd input payment data, process goes to step 1246. If Sd does input payment data, AC sends payment request and data to Payer (1256). If transfer of funds (from Payer to PAC) is not successful, AC informs Sd of unsuccessful payment and asks for retrial of payment (1262). If Sd agrees to retry, payment process recycles (via step 1252). If Sd does not authorize payment retry, process goes to step 1246, where the AC stops the ordering process. If transfer of funds (from Payer to PAC) is successful, ordering process continues. (See FIG. 12C).

FIG. 12C is a logic flowchart further illustrating continuation of the Order Placement Process (1270). After designation of a Cr (1271) or CMT (1272) to execute the order, AC transmits parcel request & parcel details to mobApp of “Cr/CMT”—i.e. to Courier, or to substitute CMT member selected by AC (1273). If the Cr/CMT does not accept parcel request 1274), then the AC determines availability of other Cr/CMT (1276). If one is available (1277), then AC automatically assigns parcel to next appropriate “best” Cr/CMT (1278).

Process then recycles (via Step 1273). If there is no appropriate “Best” Cr/CMT available, then process goes to a trouble shooting routine (1280). If a Cr/CMT accepts the parcel request (1274), then AC automatically computes security codes (1282). These algorithmically determined Security codes include (1284): Route Activation Code (“RAC”), RAC1, Unique Transition Code (“UTC”), and Delivery Confirmation Code (“DCC”). Note that: the UTC are used for any in-between transitions of the parcel. For example, between two Cr or between a Cr and a Hs. UTC can be transmitted only to Cr/CMT or Hs. Sd and Rc only operate through RAC and DCC codes.

Thus, AC next transmits RAC/UTC to Cr/CMT, DCC to Rc, RAC/UTC to Hs (if selected), and the RAC1 to Sd and/or Hs (if one selected). AC also. informs Sd, Rc, Cr/CMT, and Hs (if selected) of order and relevant details (1290), and pickup process begins (1292).

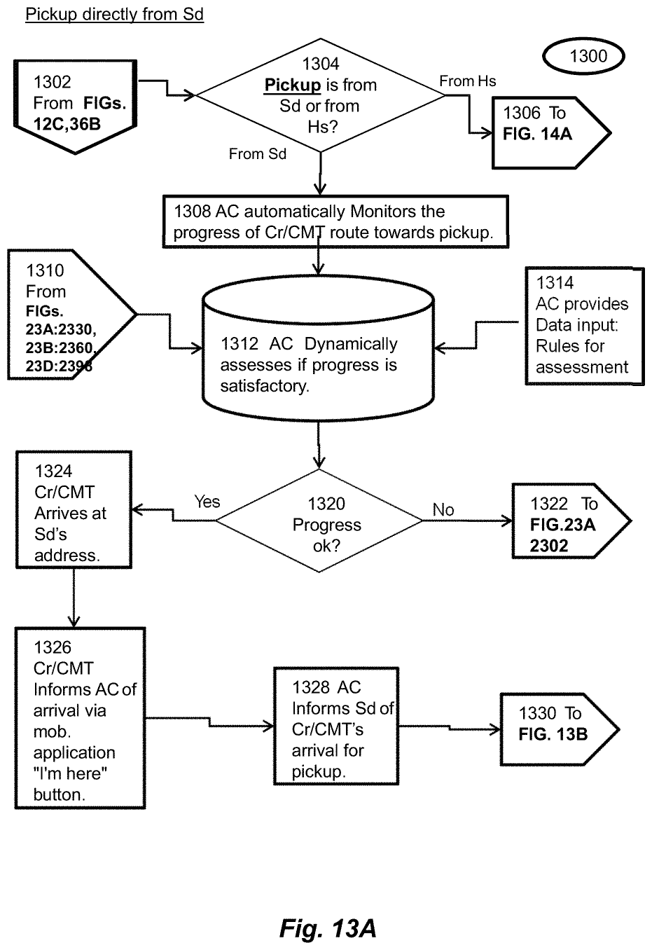

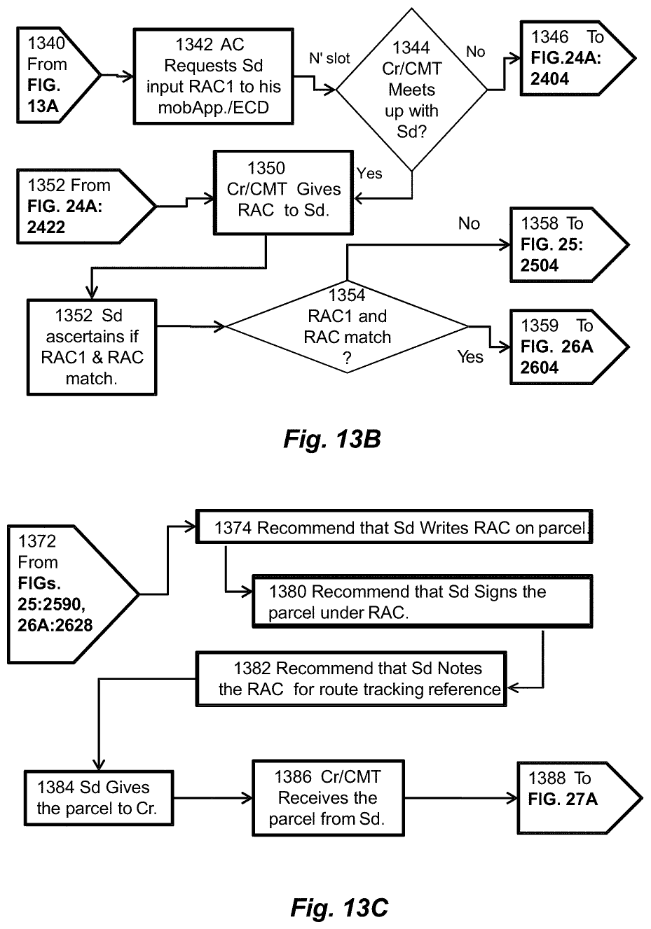

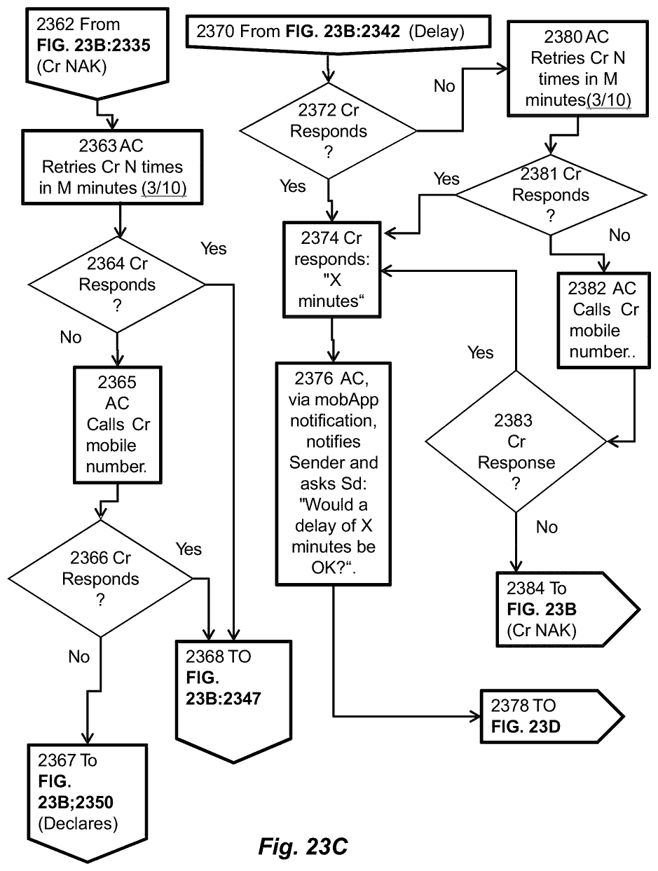

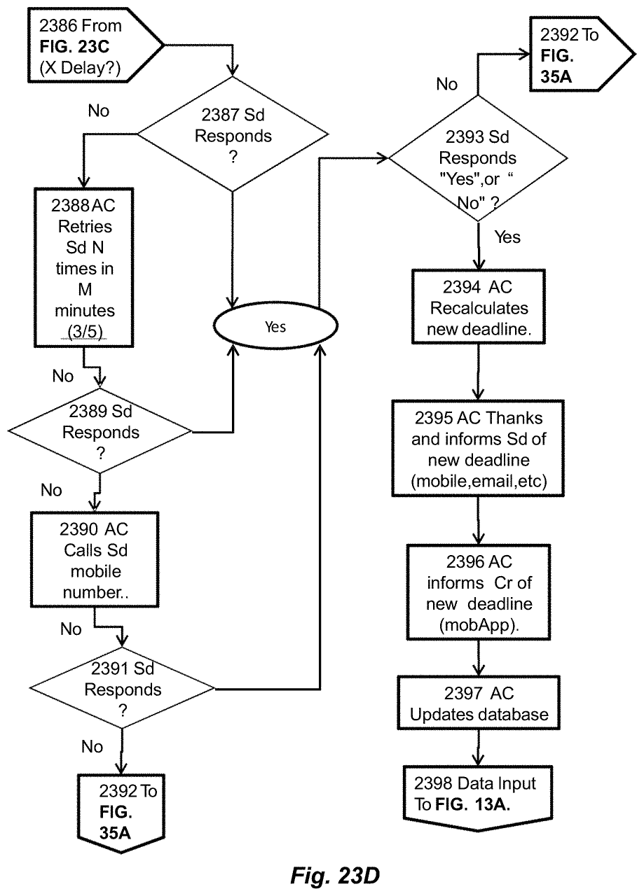

FIGS. 13A, 13B & 13C are logic flowcharts for the parcel Pickup Process (1300)—where the Pickup is directly from a Sender. As illustrated on FIG. 13A, if pickup is to be from a Hs, system branches (1304) to a separate subroutine (1306). If pickup is to be from a sender, AC automatically monitors progress of Cr/CMT route towards Sd pickup point (1308). AC also receives input (1310) from: FIG. 23A:2330, FIG. 23B:2360, and FIG. 23D:2398.

Using input data (1310) and rules based (1314) assessment criteria (some of which are AI derived), AC dynamically assesses if progress is satisfactory (1312). If progress is NOT ok (1320), system goes (1322) to a troubleshooting subroutine (FIG. 23A:2302). If progress is OK, when she arrives at Sd's address (1324), Cr/CMT informs AC of her arrival using mobApp “I'm here” button on his ECD (1326); and the AC informs Sd of Cr/CMT's arrival for pickup (1328). Process then goes (1330) to FIG. 13B.

As illustrated on FIG. 13B, AC next requests that Sd input RAC (previously transmitted to him by the AC) into Sd's mobApp/ECD (1342). As indicated earlier, the Platform's mobApp software, or comparable computer program code, may be downloaded to/reside on a plurality of different types of ECDs (Electronic Control Devices). Such ECDs include desktops laptops, tablets and other PCs. (See glossary definition of “ECD”.)

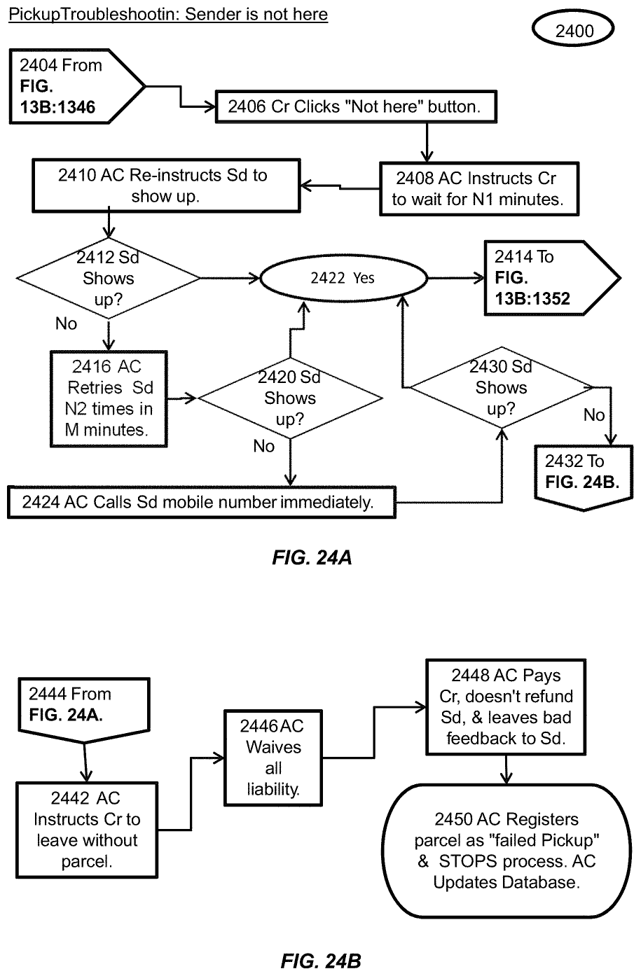

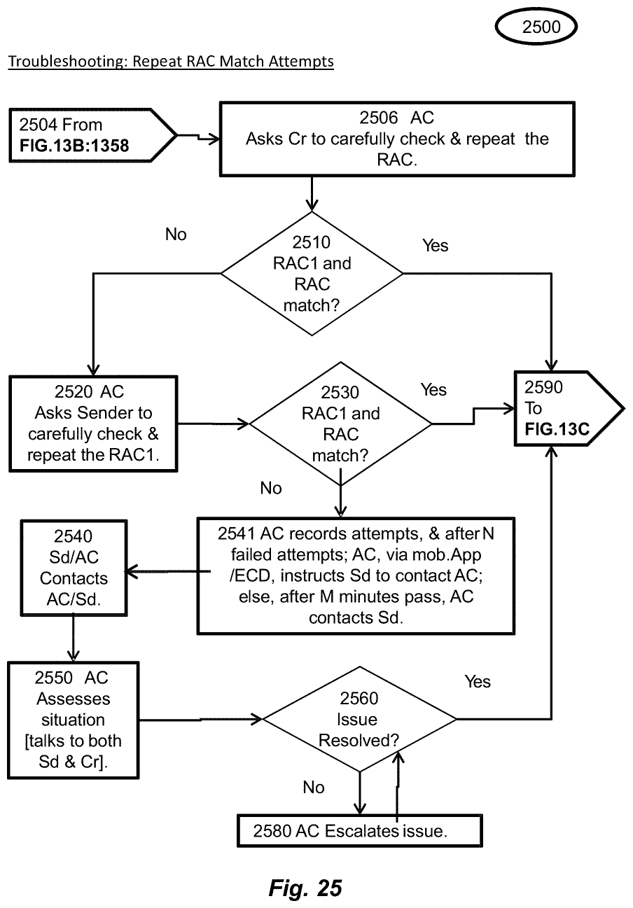

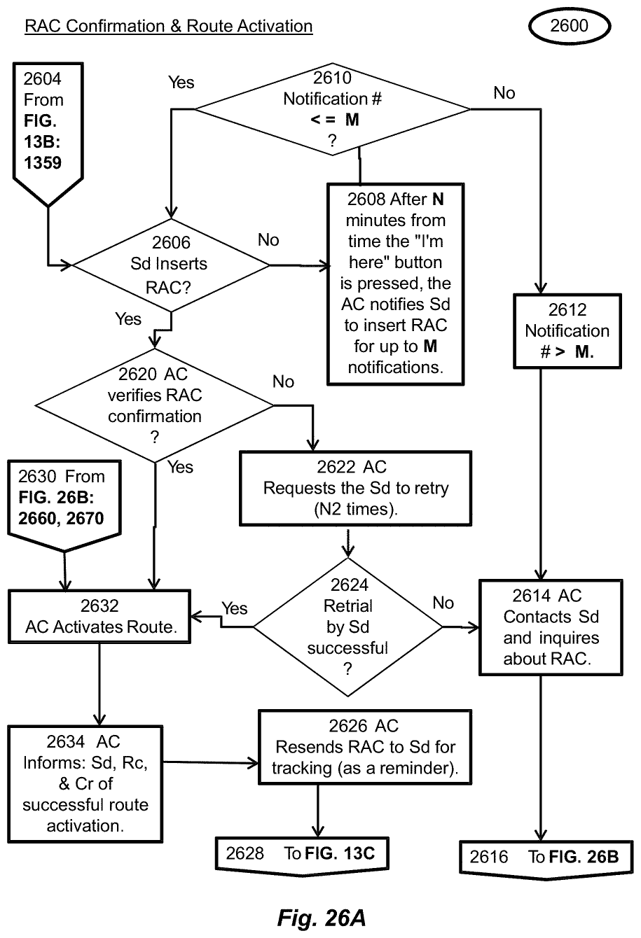

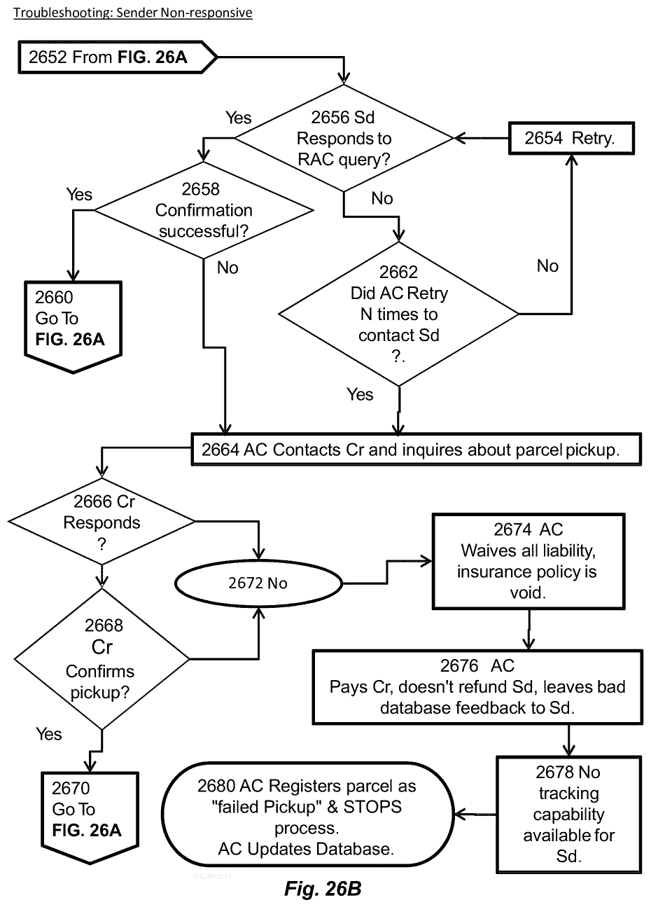

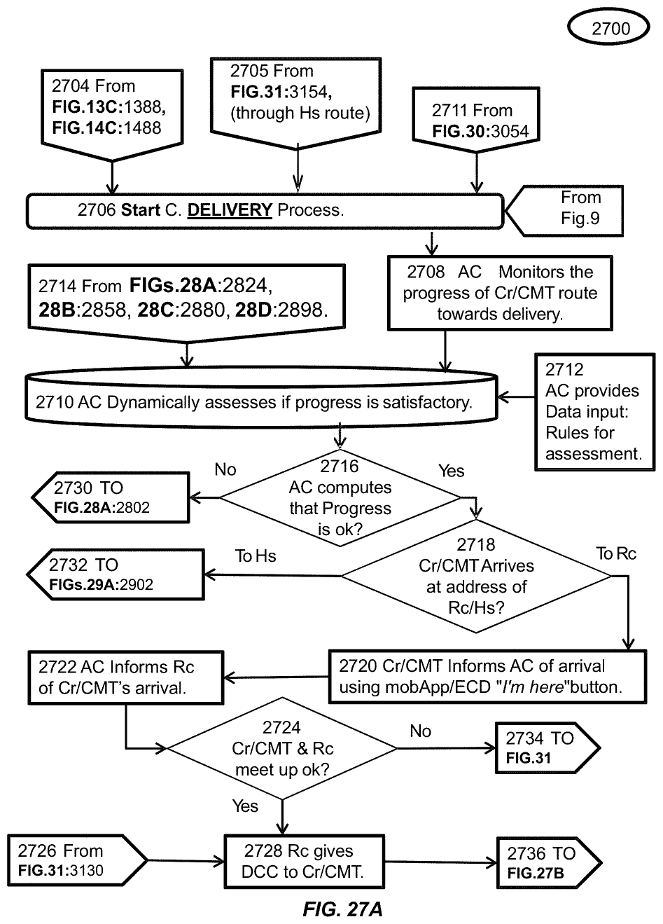

Continuing on FIG. 13B (step 1344), Cr/CMT attempts, for a pre-set time slot (i.e., up to N-minutes) to meetup with Sd. If they do Not meetup, process goes (1346) to FIG. 24A (2404). If they meetup Ok, Cr/CMT (1350) gives his RAC to Sd; and Sd ascertains if RAC1 and RAC match (1352). If no match (1354), process goes (1358) to a troubleshooting routine (FIG. 25:2504). If there is a match (1354), then process goes (1359) to a confirmation procedure (FIG. 26A:2604).

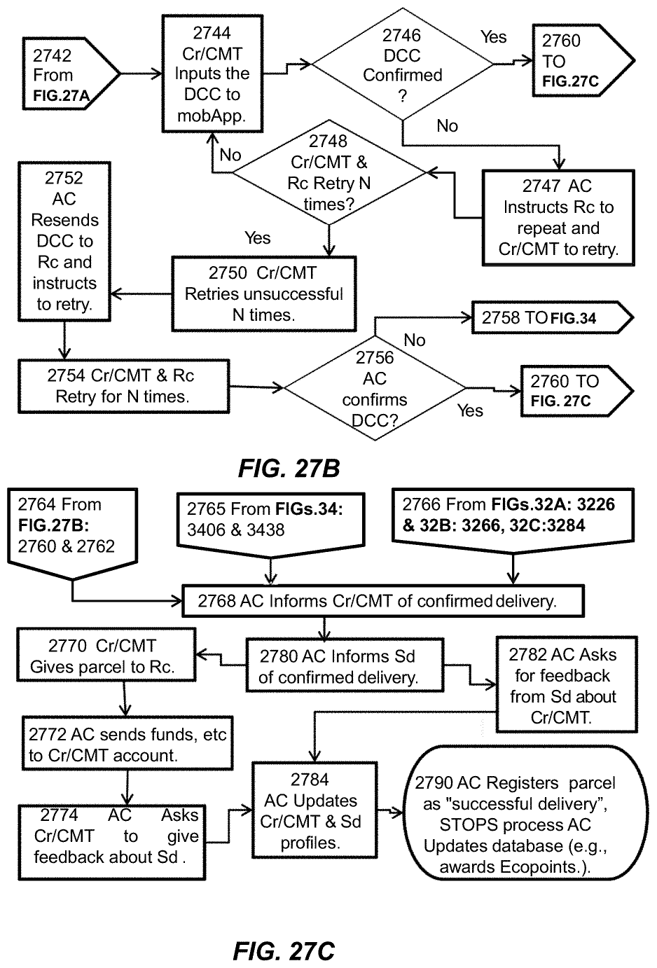

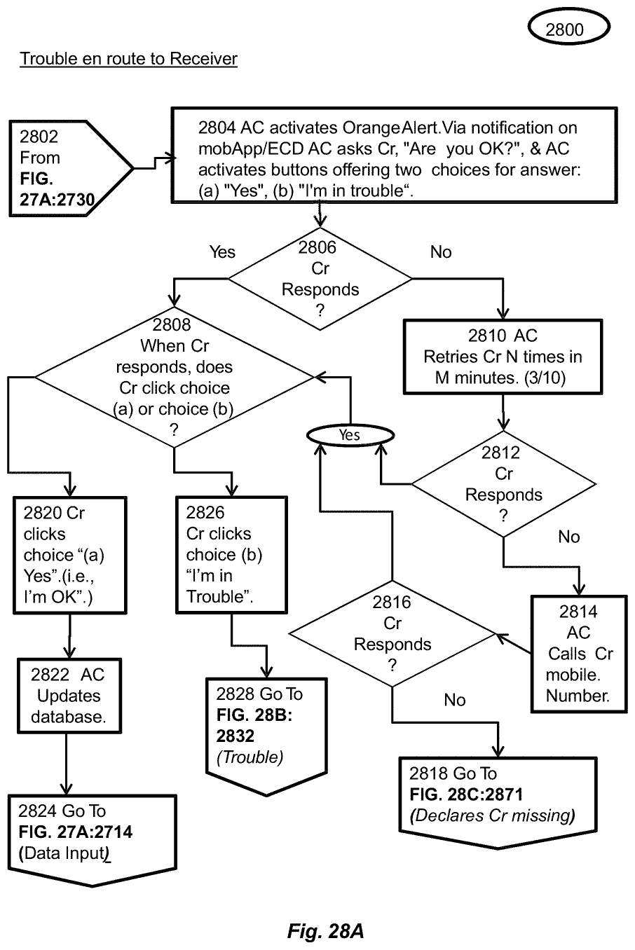

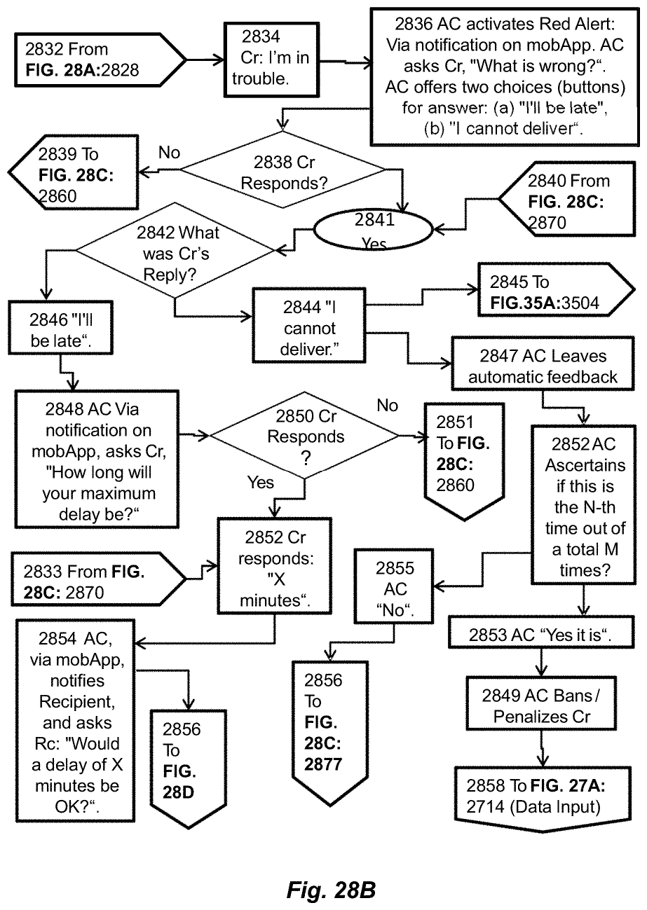

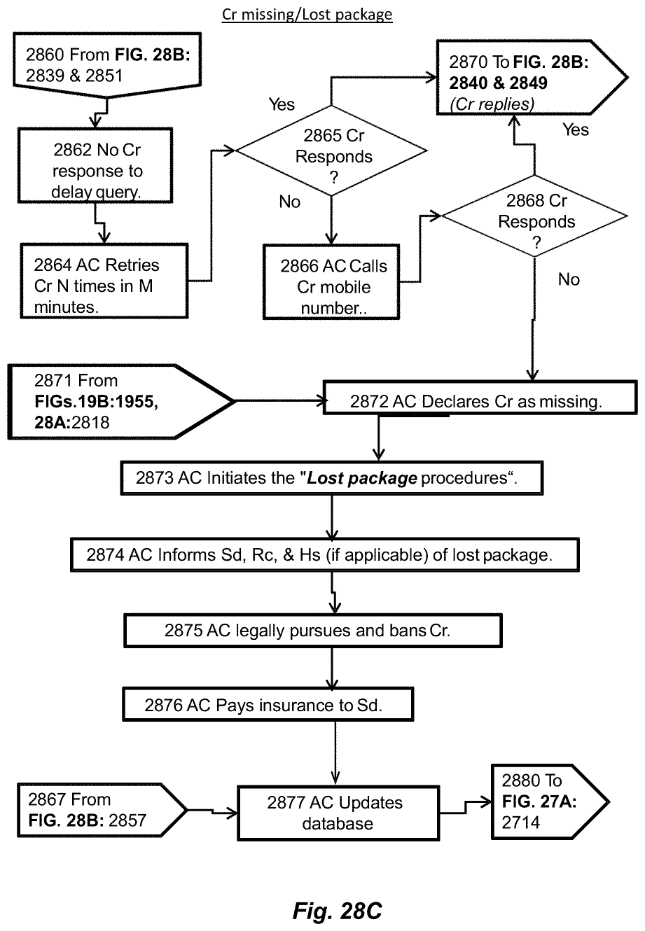

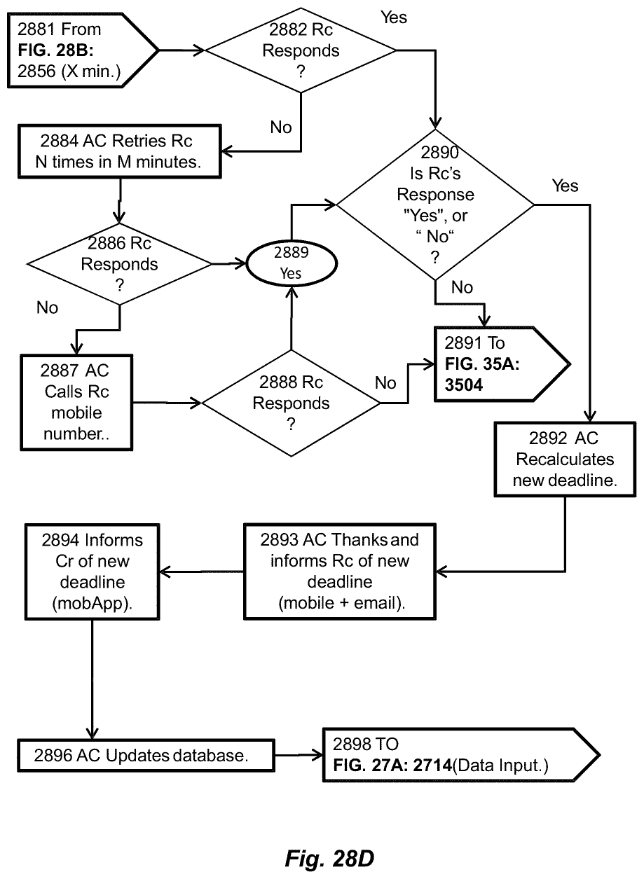

After RAC issues are resolved, process returns (1372) to FIG. 13C. The following three steps are then recommended (as options) to the user: that Sd writes the confirmed RAC on the parcel (1374); that Sd signs the parcel under the RAC (1380); and that Sd notes the RAC for route tracking reference (1382). Next, Sd gives the parcel to the Cr/CMT (1384). Cr/CMT receives the parcel from Sd (1386) and starts (1388) the delivery process (FIG. 27A).

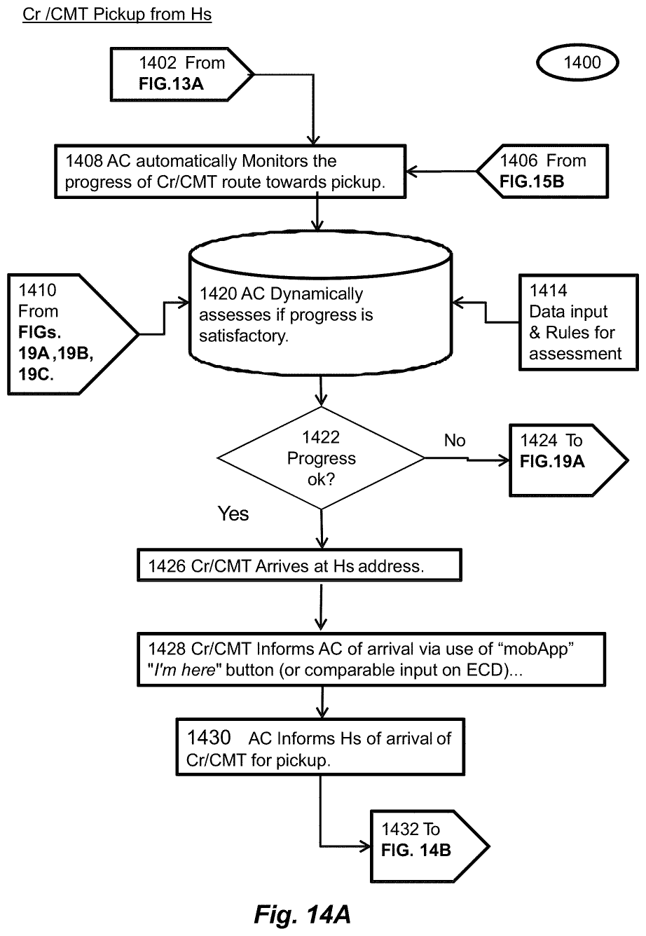

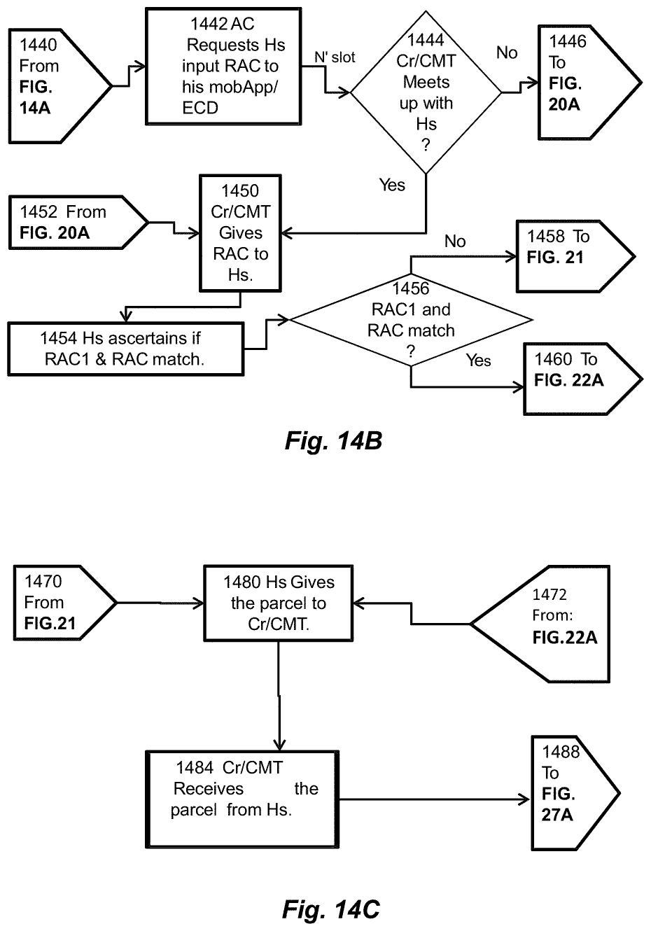

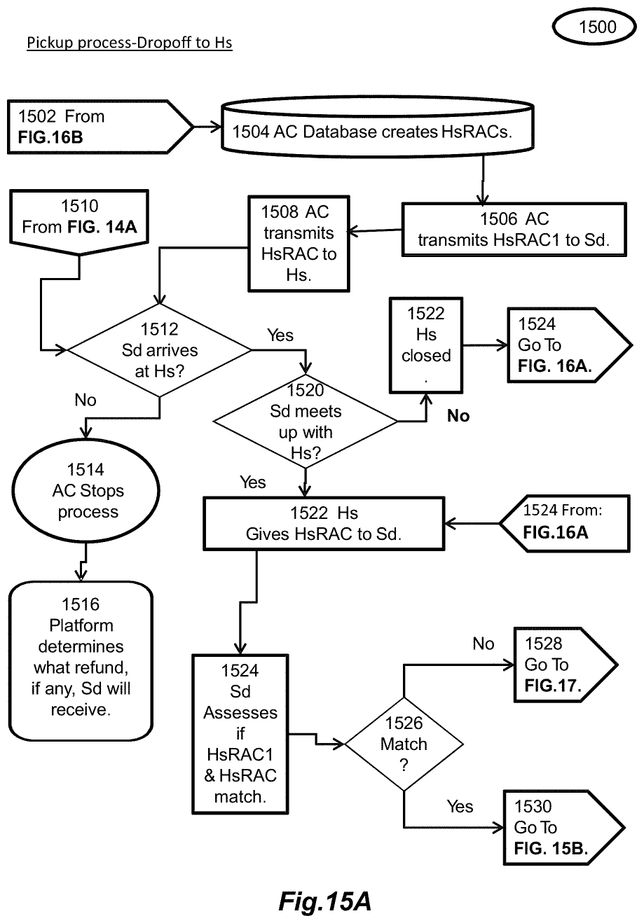

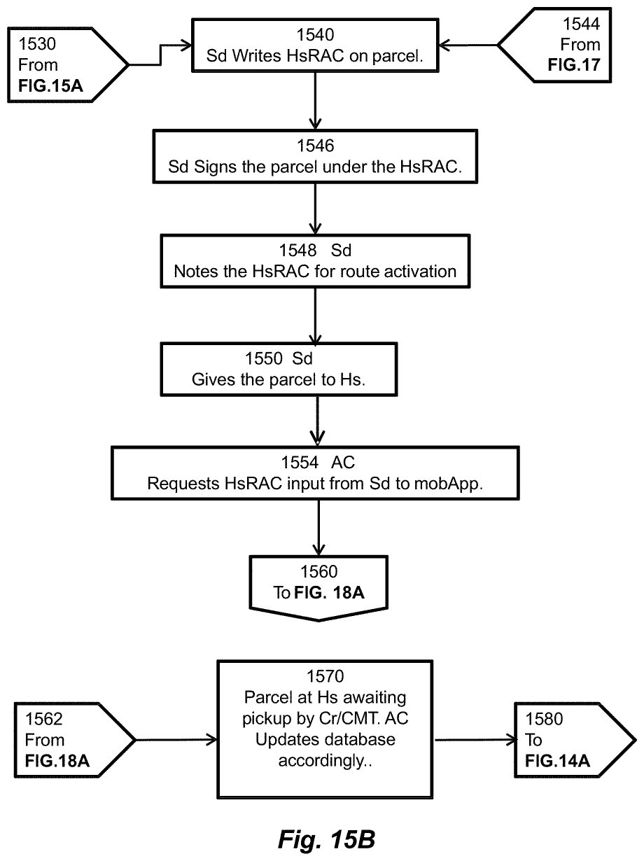

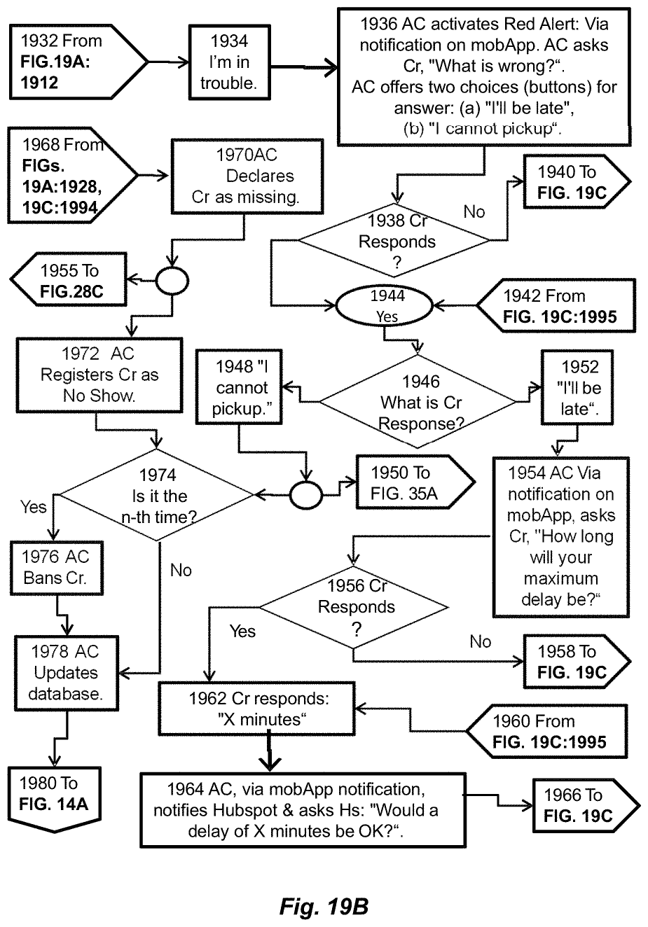

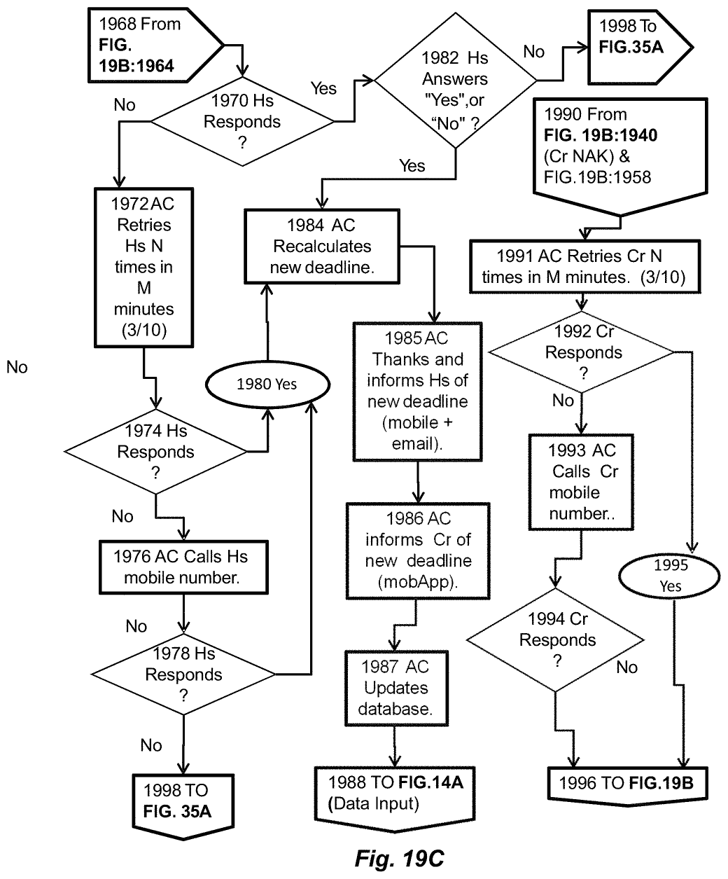

FIGS. 14A, 14B & 14C are logic flowcharts for the Pickup Process—where the Pickup is from a Hubspot (1400). On FIG. 14A, at step 1408, the AC automatically monitors progress of Cr/CMT route towards Hs pickup point. Using input data and rules based (1414) assessment criteria (some of which can be AI derived), AC dynamically assesses if progress is satisfactory (1420). If progress is NOT ok, system goes (1424) to a troubleshooting subroutine (FIG. 19A). If progress is OK (1422), when he arrives at Sd's address (1426), Cr/CMT informs AC of his arrival using mobApp “I'm here” button or comparable input on his ECD (1428); and the AC informs Hs of Cr/CMT's arrival for pickup (1430).

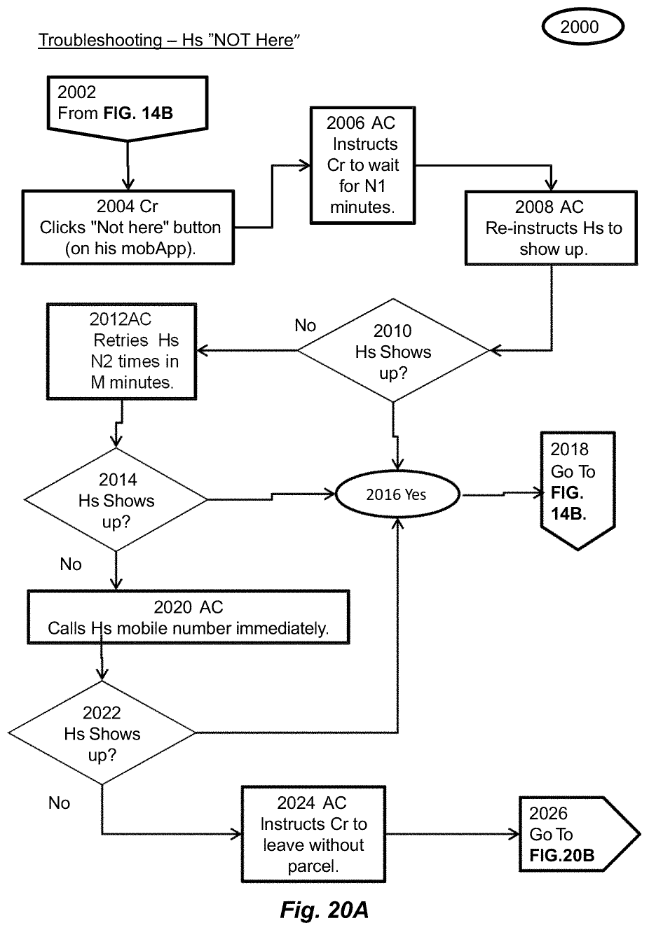

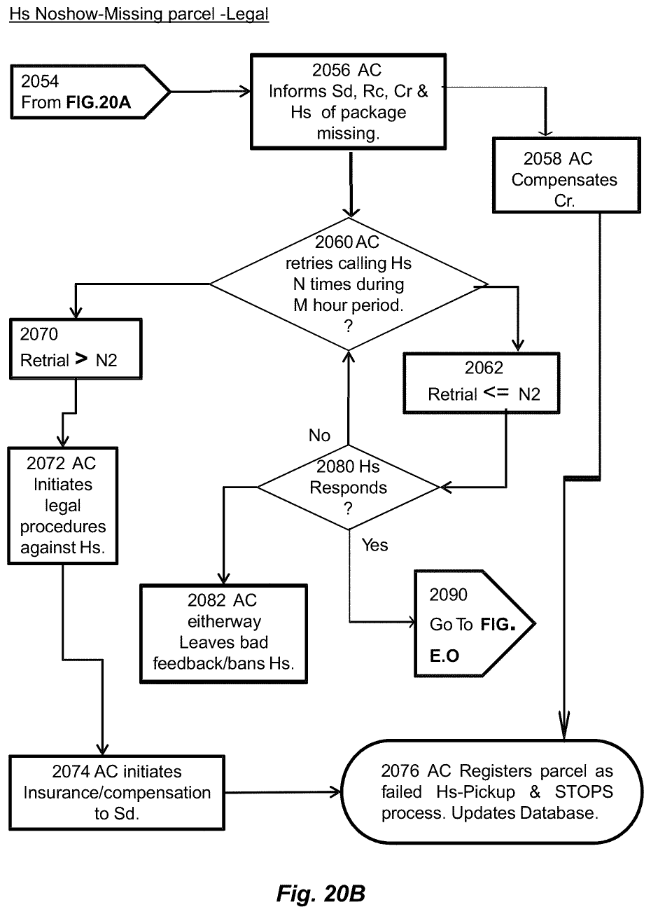

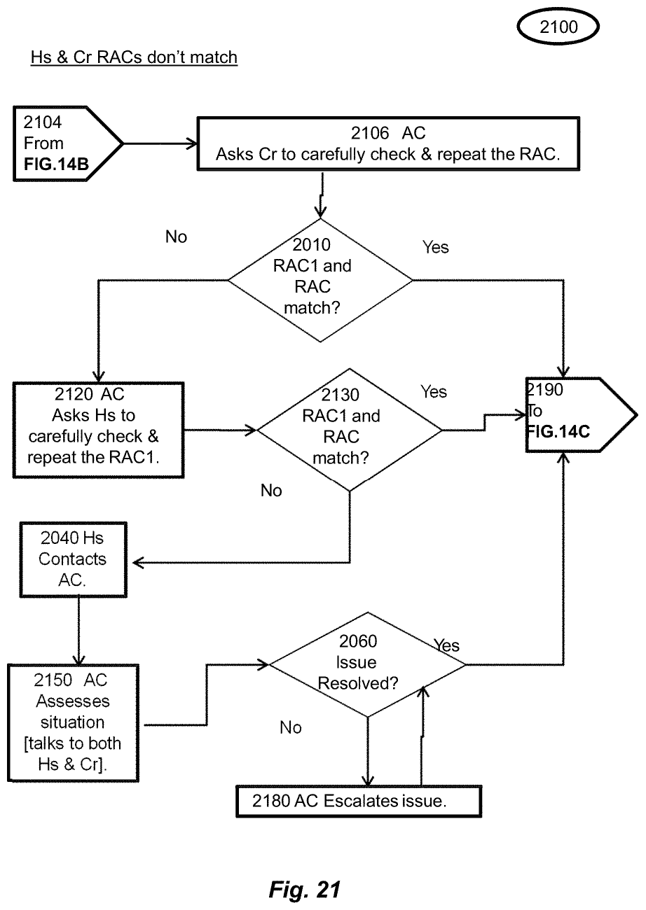

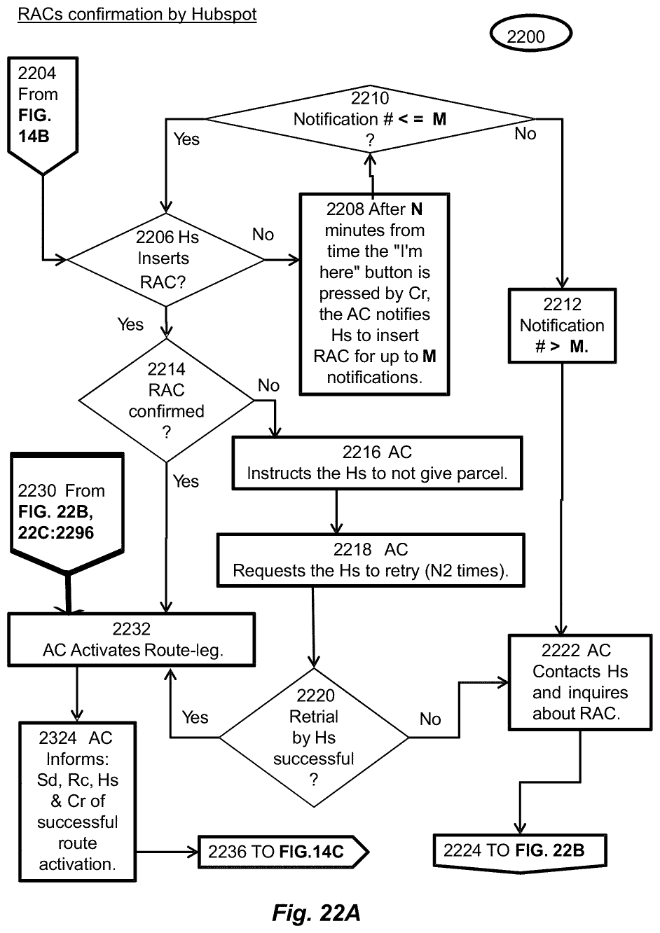

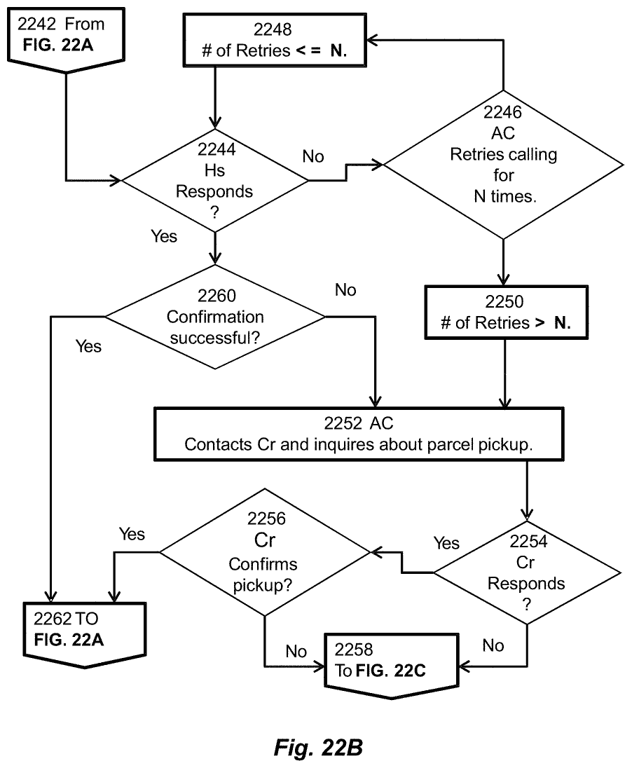

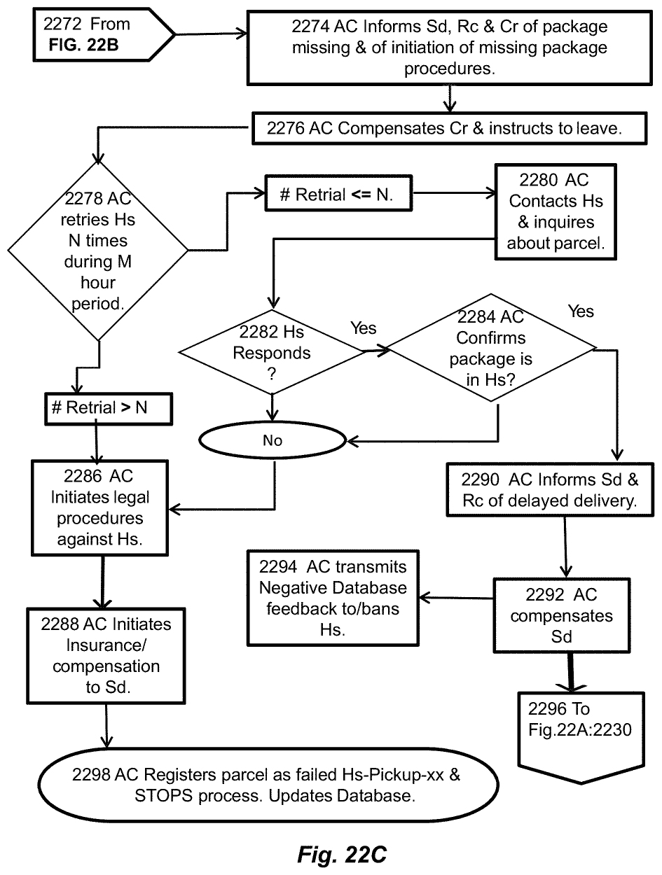

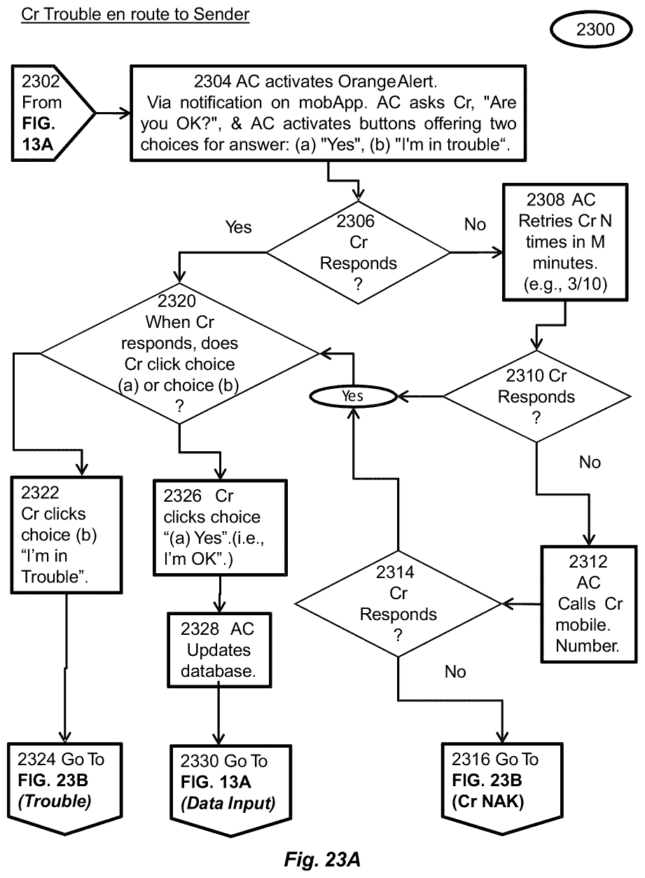

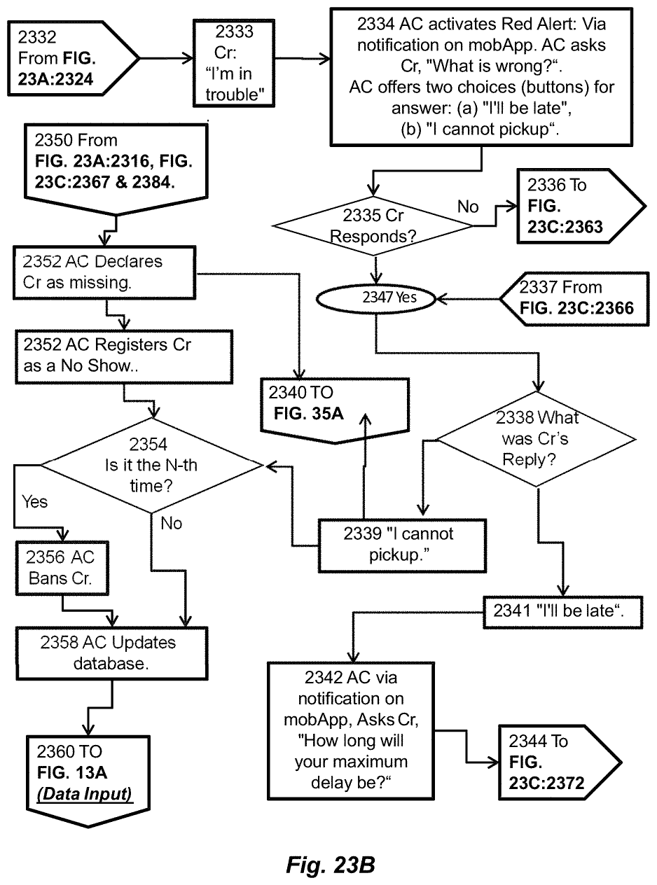

On FIG. 14B, at step 1442, the AC requests Hs input RAC to his mobApp/ECD. At step 1444, Cr/CMT attempts (up to N-times) to meetup with Hs (1444). If no meetup, process goes (1446) to a troubleshooting routine (FIG. 20A). If they meetup Ok, Cr/CMT (1450) gives his RAC to Hs; and Hs ascertains if RAC1 and RAC match (1454). If no match (1458), AC initiates (1458) a troubleshooting routine (FIG. 21). If there is a match (1460), then process begins a confirmation and Route Activation procedure (see FIG. 22A.).

After RAC issues are resolved, process returns (1470, 1472) to FIG. 14C. Hs gives the parcel to the Cr/CMT (1480). Cr/CMT Receives the parcel from Hs (1484) and starts (1488) the delivery process (FIG. 27A).

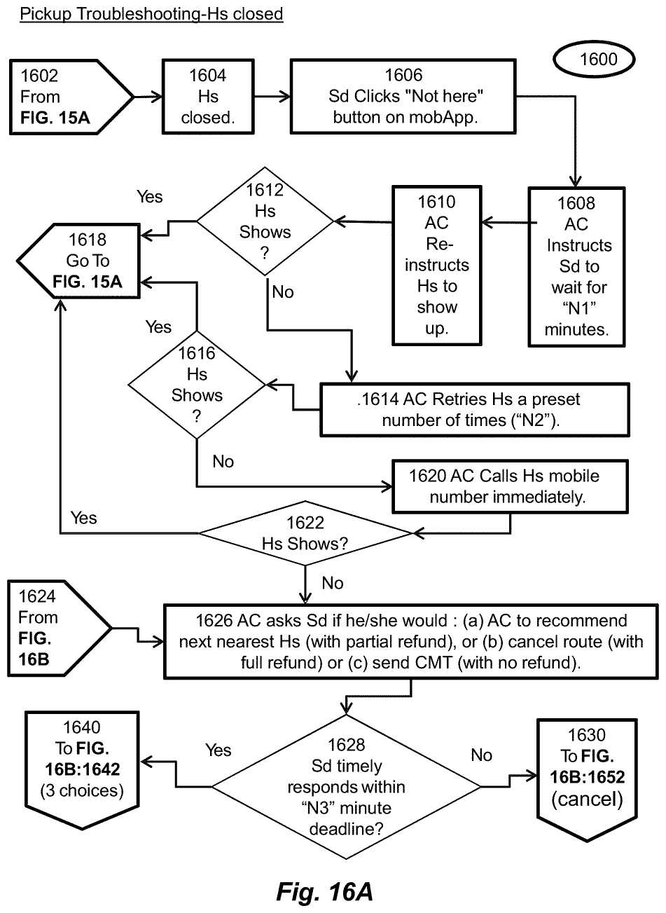

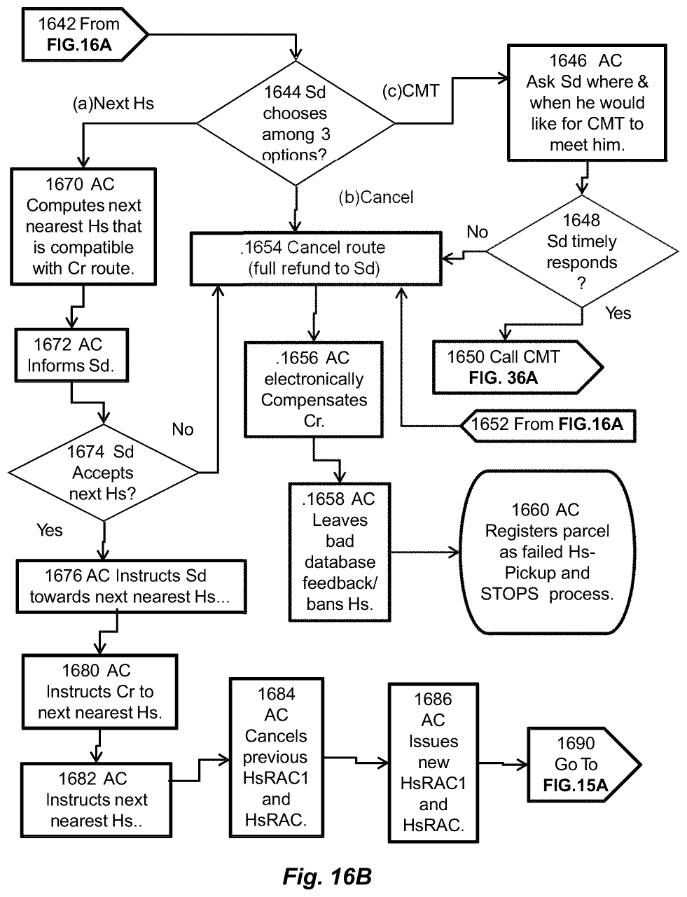

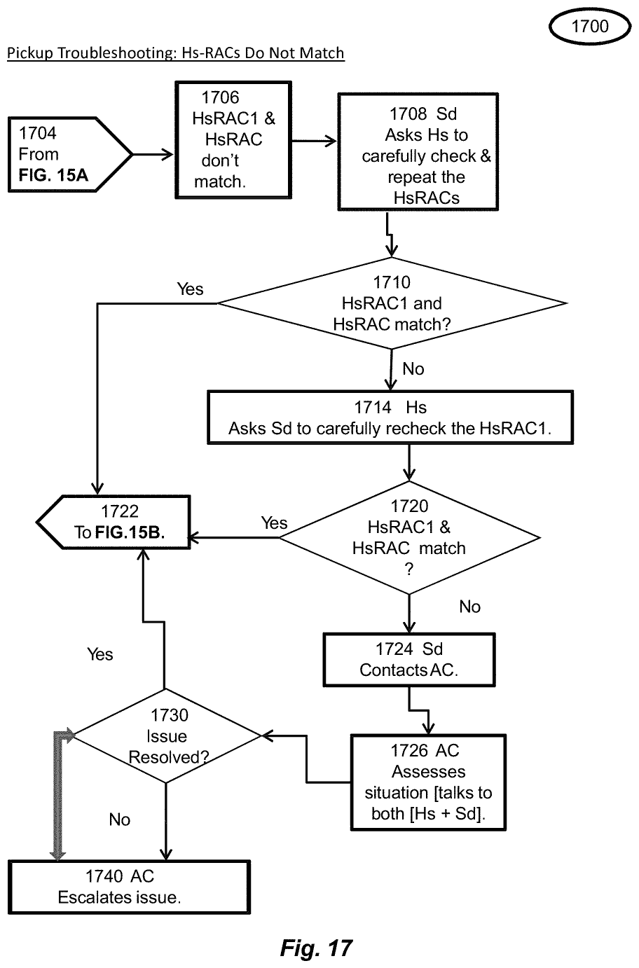

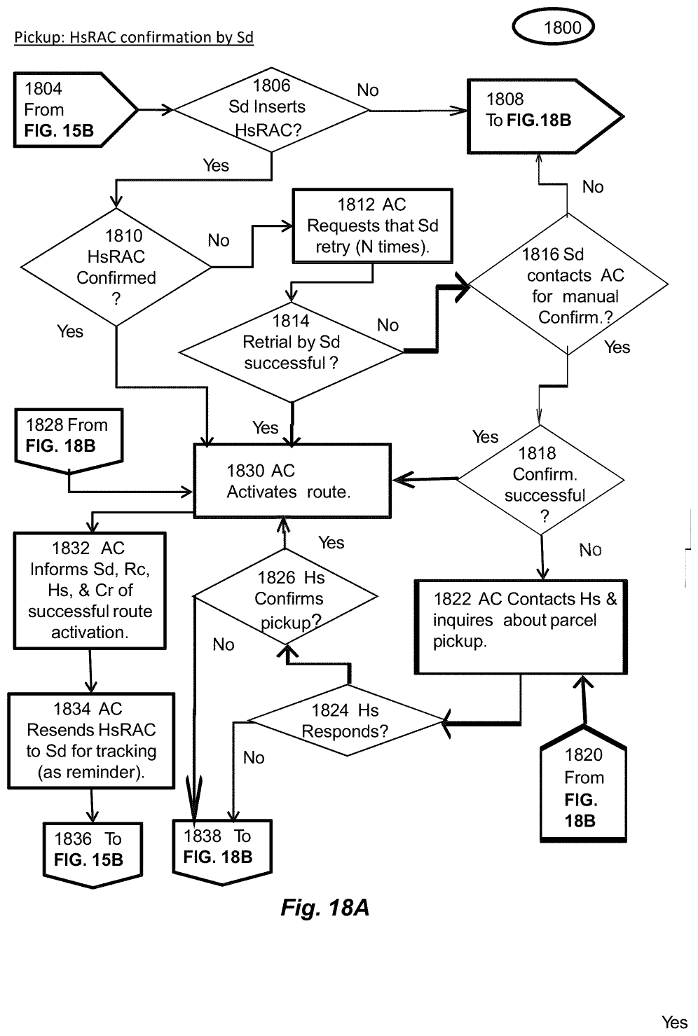

FIGS. 15A & 15B are logic flowcharts for the Pickup Process—Dropoff to Hubspot. On FIG. 15A, AC Database software creates HsRACs (1504). The AC transmits on of these (HsRAC1) to Sd (1506), and transmits another (HsRAC) to the Hs (1508). If the Sd does not arrive at the Hs, the AC STOPS the process (1514). In this event, the Platform determines what refund, if any, that the Sd may receive, based on the circumstances. For example, such circumstances might include previous good behavior as evidenced by prior history (e.g., ratings/feedback/Ecopoint accumulation). On the other hand, the Hs & Cr/CMT have already accepted the order for the route (and may be entitled to payment). Consequently, Sd may get a partial refund or no refund, if he is a No-show.

Continuing on FIG. 15A, if the Sd arrives at the location of the Hs (1512), but finds that the Hs is closed (1522), process goes (1524) to a troubleshooting routine (FIG. 16A). If Sd meets up with Hs (1520), then the Hs gives HsRAC to the Sd (1522); and the Sd assesses whether the HsRAC1 & HsRAC match (1524, 1526). If no match, process goes (1528) to a troubleshooting routine (FIG. 17). If there is a match (1530), Hs pickup continues (FIG. 15B).

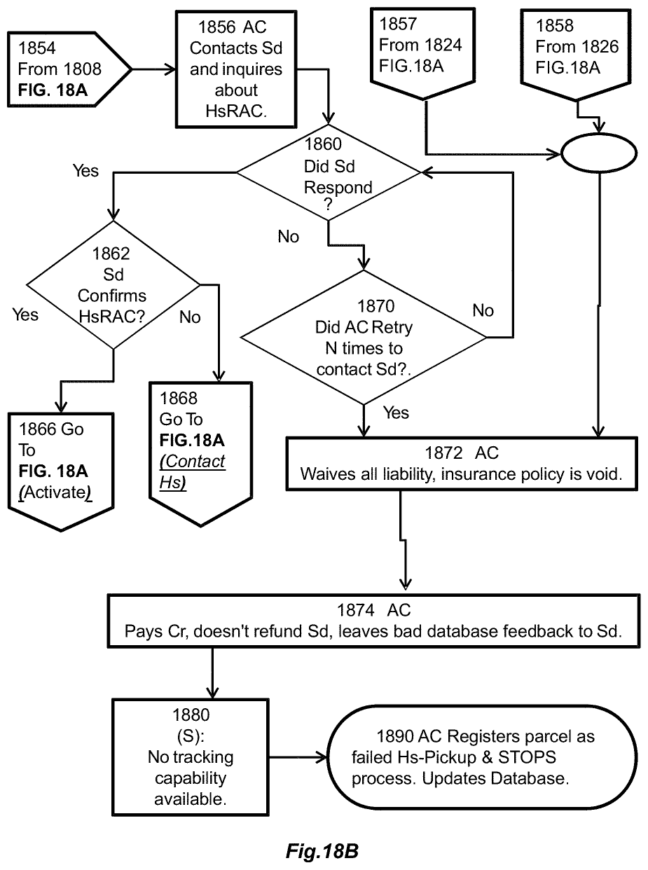

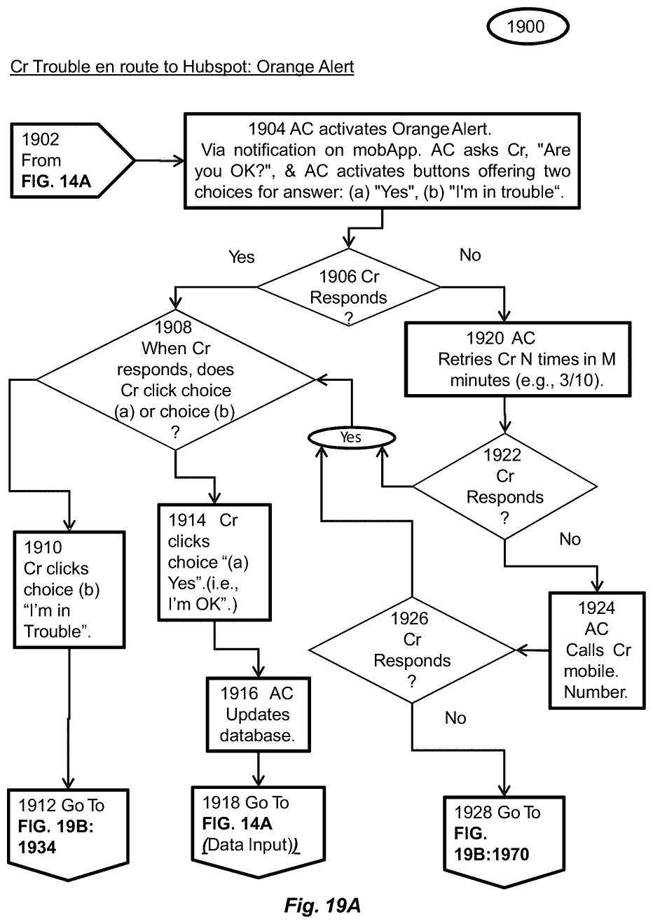

After process returns (from the matching of the HsRACs), sender dropoff of package at Hubspot continues, as illustrated on FIG. 15B. The Sd: Writes HsRAC on parcel (1540); Sd Signs the parcel under the HsRAC (1546); notes the HsRAC for route activation (1548); and Sd then gives the parcel to Hs (1550). AC next requests that Sd input HsRAC to mobApp. Process then proceeds (1560) to HsRAC confirmation & Route Activation routine. (E.g., see FIG. 18A). After return from that routine (1562), parcel is held at Hs awaiting pickup by Cr/CMT (1570), and AC updates database accordingly. Process then continues (1580) as previously discussed [i.e., see FIG. 14A, where AC monitors progress of Cr/CMT toward pickup location (at Hs this time)].

FIGS. 16A & 16B are logic flowcharts for the Pickup Process Troubleshooting: Dropoff to Hubspot—Hs Closed—Troubleshooting (1600). If Sender arrives at Hs and finds that it is closed (1604), then Sd Clicks “Not here” button on mobApp (1606). AC then instructs Sd to wait for “N1” minutes (1608); and AC Re-instructs Hs to show up (1610). If Hs shows (1612), pickup process returns to Normal procedures as previously discussed. (E.g., see FIG. 15A.) If Hs does not show (after re-instruction to do so), AC Retries Hs a preset number (“N2”) of times (1614).

If Hs then shows, pickup process continues as previously discussed on FIG. 15A (1618). If Hs has not shown after N2 Retries, AC calls Hs mobile number immediately (1620). If Hs then shows, pickup process again continues as previously discussed on FIG. 15A (1618). If Hs is still a No-Show, AC asks Sd (1626) if he/she would: (a) like AC to recommend next nearest Hs (with partial refund), or (b) cancel route (with full refund) or (c) send CMT (with no refund).

Sd is given “N3” minute deadline to timely responds (1626). If no timely response, AC calls a cancellation routine (1680). If there is a timely response, and Sd accepts one of the three choices offered, AC calls the appropriate routine for execution of the selected choice (1640).

On FIG. 16B, if the Sd (at the closed Hs) selects the Next best Hs (a) option; then AC computes next nearest Hs that is compatible with Cr route (1670), and informs Sd (1672) of same. If Sd does NOT accept next Hs offered by AC (1674), then process goes to Step 1654. If Sd does accept offered next Hs (1674), then AC transmits: instructions for Sd travel towards next nearest Hs (1676), instructions for Cr travel towards next nearest Hs (1680), and instructions to next nearest Hs regarding expected arrival of Sd and Cr (1682). AC also: cancels previous HsRAC1 & HsRAC (1684), and issues new HsRAC & HsRAC (1686). Process then returns to “Normal” pickup procedures (1690). [E.g., see FIG. 15A.].

On FIG. 16B, if the Sd (at the closed Hs) selects (1644) the CMT(c) option; then AC ask Sd where & when he would like for CMT to meet him (1646). If Sd does not timely respond (1648), then process again goes to Step 1654. If Sd does timely respond, process calls (1650) a CMT notification subroutine (FIG. 36A).

If Sd does not choose any of the three options (1644), then (at step 1654), the AC: cancels the Route (thereby entitling Sd to a full refund); and, AC electronically compensates the Cr (1656). Next, the AC electronically: leaves bad feedback in database about no-show Hs/bans Hs (1658); Registers parcel as failed Hs-Pickup; and STOPS the process (1660).

If Sd chooses (1644) option (a) Next Hs, then 1670 AC computes next nearest Hs that is compatible with Cr route; and informs Sd of same (1672). If Sd does accept the offered next Hs (1674), then AC transmits: instructions to guide Sd towards next nearest Hs (1676); and instructions, to next nearest Hs, advising of on-coming Cr (1682). AC also: cancels (1684) previous HsRAC1 and HsRAC, and AC issues (1686) new HsRAC1 and HsRAC. Process then returns (1690) back to FIG. 15A.

FIG. 17 is a logic flowchart (1700) for the Pickup Process—Troubleshooting (Hs-RACs Do Not Match). If (1706) Sd & Hs RACs do not initially match, then (1708) Sd asks Hs to carefully check & repeat the HsRAC. If (1710) HsRAC1 and HsRAC then do match, process goes to Step 1722 (FIG. 15B). If HsRAC1 and HsRAC still do not match, then Hs asks Sd to carefully recheck and repeat his HsRAC1 (1714). If there is then a match, process again goes to Step 1722.

If there is still no match, Sd contacts AC (1724); and the AC assesses the situation [communicates with both Hs and Sd] (1726). If issue is not thereby resolved (1730), AC Escalates the issue (1740). Once Escalation has taken place, the process requires some sort of issue resolution. This will probably take place by Platform management talking to both Hs and Sd. When issue is resolved, the flow again goes to Step 1722, where the process returns to Normal dropoff procedures. [E.g., see FIG. 15B].

FIGS. 18A & 18B are logic flowcharts for the Pickup Process—HsRAC Confirmation by Sender (1800). If Sd does NOT make a timely insertion of HsRAC in to his mobApp (1806), process calls (1808) a troubleshooting routine (FIG. 18B). If Sd inserts HsRAC (1806), but it is NOT confirmed (1810), AC requests (1812) that Sd retry (N times). If retrial by Sd (1814) is NOT successful, Sd contacts AC for manual confirmation (1816). If no confirmation, process again calls a troubleshooting routine (1808). If manual confirmation is successful, process goes to Step 1830. AC also contacts Hs about parcel pickup (1822). If Hs responds (1824) and confirms pickup (1826), process goes to Step 1830. If Hs responds, but does NOT confirm pickup (1826), process calls (1838) a troubleshooting routine (FIG. 18B).

If HsRAC is confirmed at initial insertion (1806) into mobApp by Sd (1810), process goes to Step 1830, where the AC activates the Route. AC also informs Sd, Rc, Hs, & Cr of successful route activation (1832); and AC resends HsRAC to Sd (as reminder) for tracking (1834). Process then returns (1836) to Normal procedures (FIG. 15B).

On FIG. 18B, we come from FIG. 18A:1808 at step 1854. AC then contacts Sd and enquires about HsRAC (1856). If Sd Responds (1860) and confirms HsRAC (1862), process returns to FIG. 18A route activation branch (1866). If Sd responds (1860) but does NOT confirm HsRAC (1862), process returns to FIG. 18A contact Hs branch (1868). If Sd does NOT respond to initial inquiries (1860), AC retries to contact Sd up to N times (1870). If no response from Sd, AC waives all liability, and insurance policy is void (1872).

Also, the AC: pays Cr, doesn't refund Sd, and leaves bad database feedback about Sd (1874). Sd also has no tracking capability available (1880). This means that if the sender does not uphold his responsibility input his HsRAC, then in addition to waiving of all liability, the Platform does not offer him the parcel tracking capability (normally accorded to senders).

AC next: registers parcel as failed Hs-Pickup; STOPS process; and updates Database (1890).

FIGS. 19A, 19B & 19C are logic flowcharts for the Pickup Process: Courier in Trouble on way to Hubspot. As it monitors travel progress of the Cr (or CMT), if AC determines that progress is not satisfactory (1902), the AC (FIG. 19A) can electronically activate an Orange Alert (1904). Via notification by mobApp instruction, AC asks Cr, “Are you OK?”, & AC activates (mobA/ECD) buttons offering two choices (1904) for answer:

(a) “Yes”, (b) “I'm in trouble”.

If there is no initial response from Cr (1906), AC retries (via mobApp) to contact Cr [up to N times in M minutes] (1920). If Cr still does not respond, AC calls Cr mobile number (1924). If Cr does NOT respond to AC call, AC goes (1928) to a missing person routine (FIG. 19B:1970 [Data input]). If Cr does respond (1922, 1926), AC determines whether Cr clicked choice (a) or choice (b). [See Step 1904.] If Cr clicks choice “(a) Yes” (i.e., I'm OK”.), then AC updates database (1916), and returns (1918) to Normal procedures (FIG. 14A). If Clicks choice (b) “I'm in Trouble” (1910), process goes (1912) to “Red Alert” routine (FIG. 19B:1934).

On FIG. 19B, AC activates Red Alert: Via notification on mobApp. AC asks Cr, “What is wrong?” (1936) AC also offers two choices (buttons) for answer:

(a) “I'll be late”, (b) “I cannot pickup”.

If Cr does not respond (1938), process goes (1940) to a troubleshooting routine (FIG. 19C). If Cr responds and clicks choice (a) “I'll be late” (1952), then via notification by mobApp instruction, AC asks Cr “How long will your maximum delay be?” (1954). If Cr does NOT respond, process goes (1952) to a troubleshooting routine (FIG. 19C). If Cr transmits a response such as (for example), “X-minutes”; then AC, via mobApp notification, contacts Hubspot & asks Hs: “Would a delay of X minutes be OK?” (1964). Process then goes (1966) to a routine to consider a new deadline (FIG. 19C).

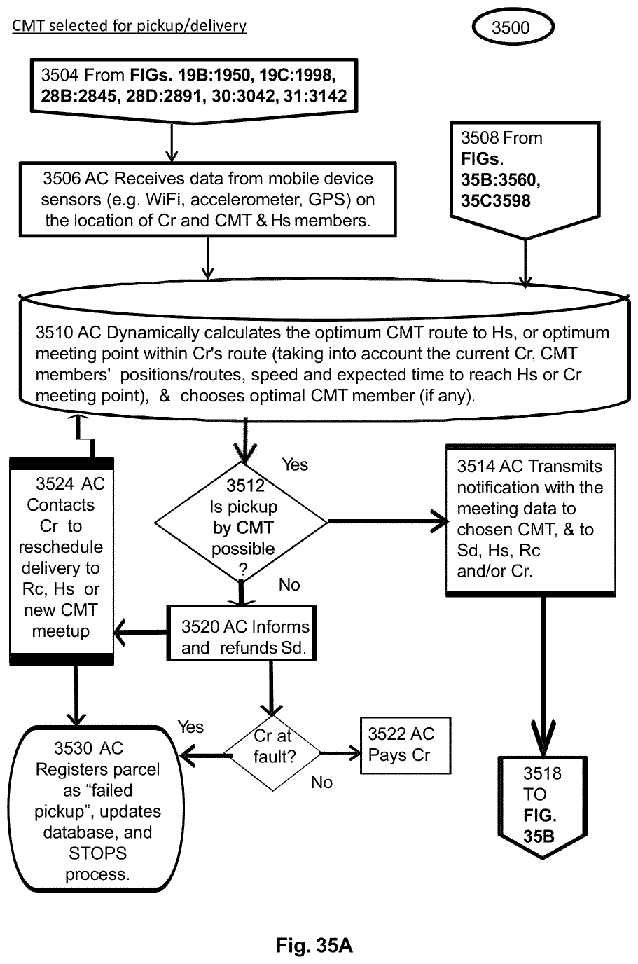

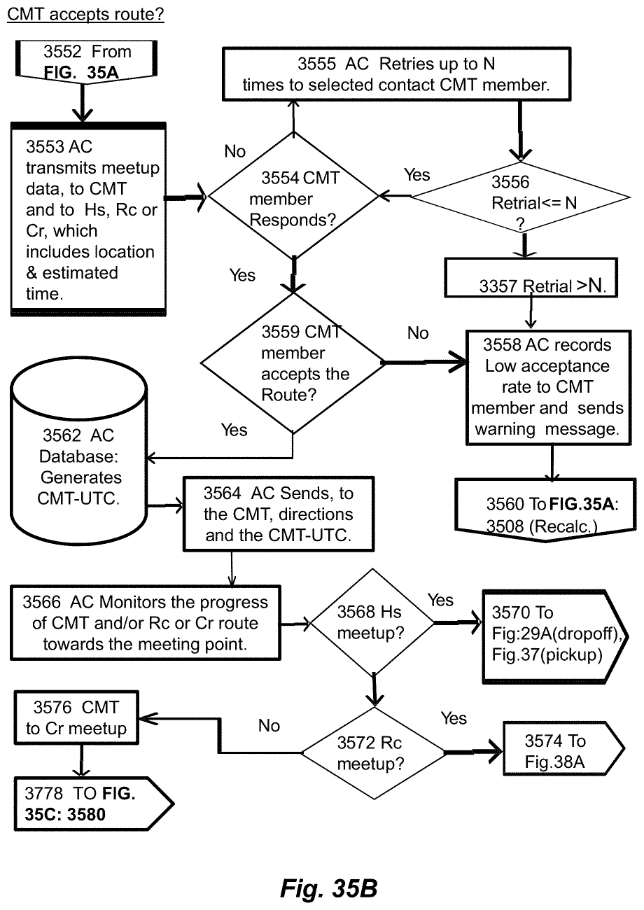

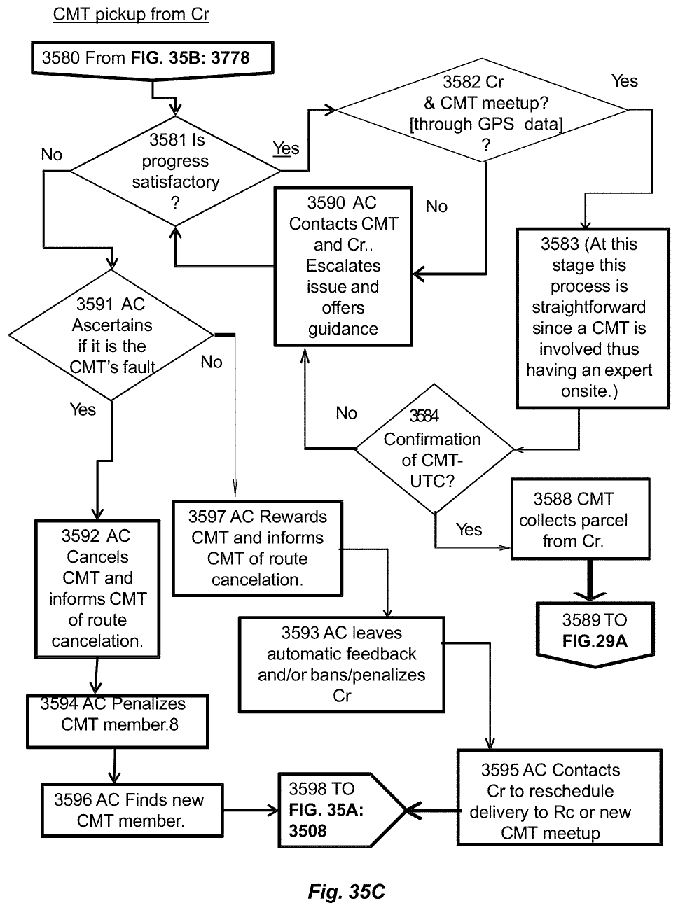

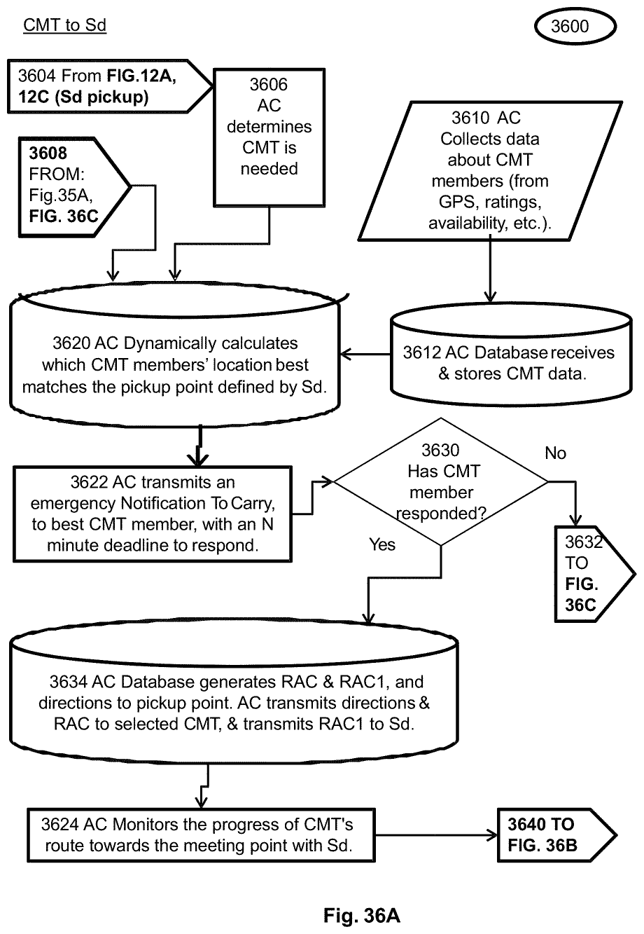

Further on FIG. 19B, If Cr responds and clicks choice (b) “I cannot pickup” (1948), then process calls (1950) a troubleshooting routine (FIG. 35A). In addition, AC goes to Step 1974.

Based on inputs from FIG. 19A & 19C, at step 1970, AC declares Cr as missing (1970). Process then also goes (1955) to a troubleshooting routine (FIG. 28C). In addition, AC registers Cr as a No-Show (1972) and goes to Step 1974. There, the AC determined if this is the n-th time (1974) for this particular courier. If not, the database is updated (1978). If this is the n-th time, AC bans Cr (1976), AC the updates database accordingly (1976), and process returns (1980) to Normal procedures (14A).

On FIG. 19C, If Hs does not respond (1970) to query (“X-minute” delay ok?), then AC automatically Retries (1972) transmitting query to Hs mobApp, up to N-times in M-minutes (e.g., 3 times in 10 minutes). If Hs responds (i.e., within M-minutes), process goes to Step 1980. If no (mobApp) response (1974), AC calls Hs mobile number (1976). If Hs does not respond to call (1978), If Hs answers “X-minute” query with a “NO”, then process (1998) to a troubleshooting routine (FIG. 35A).

If Hs answers “yes” to query (1980, 1982), process goes to Step 1984, and the AC recalculates a new deadline. Next (1985), the AC thanks and informs Hs of new deadline (via mobile+email). AC then informs Cr (1986) of new deadline (via mobApp transmission); and updates database (1987). Process then returns (1988) to Normal pickup procedures (FIG. 14A).

FIGS. 20A & 20B are logic flowcharts for the Pickup Process: Troubleshooting—Hs closed. When Hs caretaker does not meetup with arriving courier (2002), Cr (FIG. 20A) Clicks “Not here” button on his mobApp (2004). AC instructs Cr to wait for N1 minutes (2006), and AC Re-instructs Hs to show up (2008). If (2010) Hs Shows up, process goes to Step 2016.

If Hs does NOT show up (2010), AC Retries Hs N2 times in M2 minutes (2012). If (2014) Hs Shows up (i.e., within M2 minutes), process goes to Step 2016. If not, AC Calls Hs mobile number immediately (2020). If (2022) Hs responds to call and shows up, process again goes to Step 2016. From there, process returns (2018) to Normal pickup procedures (FIG. 14B). If Hs is still a No-Show (2022), AC instructs Cr to leave without parcel (2024) and then process goes (2026) to a (failed pickup) troubleshooting routine (FIG. 20B).

On FIG. 20B, at step 2056, AC informs Cr, Sd, Rc, & Hs of package missing, and compensates the Cr (2058). Also, the AC retries calling Hs up to N3 times during an H-hour period (2060). If Hs responds (2080) process goes to another troubleshooting routine (2090). [E.g., see Fig. E.O. XXX] If no response, AC Leaves bad feedback/bans Hs (2082). If no response, system also determines (2062) if the number of retries (“n”) is up to N3 (e.g., 5 retries during a 24-hour period). If (n<N3), then AC retries Hs call again (2060). If (n=>N3), then AC initiates legal action against Hs (2072), and AC initiates Insurance/compensation to Sd (2074). Further, AC registers parcel as failed Hs-Pickup & updates database (2076). AC then STOPS process (2078).

FIG. 21 is a logic flowchart for a Pickup Process Troubleshooting Routine: Hs & Cr RACs don't match (2100). When a Cr arrives (2104) at an Hs to pick-up a parcel, if their RACs do not initially match, then AC asks Cr to carefully check & repeat the RAC (2106). If RAC1 and RAC then do match (2010), process goes to Step 2190. If RAC1 and RAC still do not match, then AC asks Hs to carefully recheck and repeat his RAC1 (2120). If there is then a match (2130), process again goes to Step 2190. If there is still no match, Hs contacts AC (2140); and the AC assesses the situation [communicates with both Hs and Sd] (2150). If issue is not thereby resolved (2160), AC Escalates the issue (2180). If issue is resolved, again the flow goes to Step 2190, where process returns to Normal procedures (FIG. 14C).

FIGS. 22A, 22B & 22C are logic flowcharts for the Pickup Process: RACs confirmation by Hubspot (2200). On FIG. 22A, after arriving Cr inputs “I'm here” signal (2205) at his mobApp, system checks whether Hs has inserted his RAC (2206). If not, after N minutes from time the “I'm here” button is pressed by Cr, the AC notifies Hs to insert RAC for up to M notifications (2208). If RAC is not inserted by Hs after M notifications (2212), process goes to Step 2222.

If Hs does make a timely insertion of RAC (2206), system determines if RAC is confirmed (2214). If so, process goes to Step 2232. If no RAC confirmation, then: AC instructs the Hs to not give parcel to Cr (2216), and AC requests the Hs (2218) to retry confirmation (up to N2 times). If (2220) retrial by Hs is successful, process again goes to Step 2222. There, the AC contacts Hs and enquires about RAC, and process goes (2224) to troubleshooting routine (FIG. 22B).

If RAC confirmation retrial is successful (2220), process again goes to Step 2232. There, AC activates Route-leg, and AC informs: Sd, Rc, Hs & Cr of successful route-activation (2324). Process then returns (2236) to Normal procedures (FIG. 14C).

On FIG. 22B, if Hs responds to AC calls (2244), then system checks for a successful confirmation of RACs (2260). If so, process goes (2262) back to FIG. 22A. If Hs does not respond to AC calls (2246) after N retries (2248, 2250), then AC contacts Cr and enquires about parcel pickup (2252). If Cr does not respond (2254), process goes (2258) to FIG. 22C. If Cr confirms pickup, process returns to Normal procedures at step 2262. If Cr does not confirm pickup (2256), process goes to Step 2258, where a (missing parcel) troubleshooting routine is called (FIG. 22C).

On FIG. 22C, 2274 AC: informs Sd, Rc & Cr of package missing and of initiation of “missing package” procedures (2274), and AC Compensates Cr & instructs to leave (2276). Also, AC retries contacting Hs, up N-times during a M-hour period (2278, 2280). If no response, process goes to Step 2286. If there is a response (2282), but Hs does not confirm that package is in Hs (2284), process again goes to Step 2286. There, the AC initiates legal procedures against Hs.

AC also: initiates Insurance/compensation to Sd (2288); registers parcel as failed Hs-Pickup; updates Database, and STOPs process (2290). If AC does confirm that package is at Hs (2284), then AC Informs Sd and Rc of delayed deliver (2290), and AC compensates Sd (2292). The amount of compensation (2288, 2292) is determined by the Platform. Process then goes (2296) to FIG. 22A:2230. Further, AC transmits Negative feedback to Database about Hs, and may/may not ban Hs (2294) depending on the circumstances.

FIGS. 23A, 23B, 23C & 23D are logic flowcharts for the Pickup Process: Courier in Trouble on the way to Sender.

As it monitors travel progress of the Cr (or CMT), if AC determines that progress is not satisfactory (2302), the AC (FIG. 23A) can electronically activate an Orange Alert (2304). Via notification by mobApp, AC asks Cr, “Are you OK?”, and AC activates buttons (or equivalent ECD function keys/symbols) offering two choices (2304) for answer:

(a) “Yes”, (b) “I'm in trouble”.

If there is no initial response from Cr (2306), AC retries (via mobApp) to contact Cr [up to N times in M minutes] (2308). If Cr still does not respond, AC calls Cr mobile number (2312). If Cr does not respond (2314) to AC calls, AC goes to a (Cr NAK) routine (2316). If Cr does respond (2306, 2310, 2314), AC determines whether Cr clicked choice (a) or choice (b). [See Step 2320.] If Cr clicks choice “(a) Yes” (i.e., I'm OK”.), then AC updates database (2328), and returns to Normal procedures (2330). If Clicks choice (b) “I'm in Trouble” (2322), process goes to “Red Alert” routine (2324).

On FIG. 23B, AC activates Red Alert. Via notification on mobApp. AC asks Cr, “What is wrong?” (2334) AC also offers two choices (buttons) for answer:

(a) “I'll be late”, (b) “I cannot pickup”.

If Cr does not respond (2335), process goes (2335) to another troubleshooting routine (FIG. 23C). If Cr responds (2338) and clicks choice (a) “I'll be late” (2341), then via notification on mobApp, AC asks Cr, “How long will your maximum delay be?”(2342), process goes (2344) to a troubleshooting routine (FIG. 23C:2372). Further on FIG. 23B, If Cr responds and clicks choice (b) “I cannot pickup” (2339), then process goes (2340). There, process calls another troubleshooting routine (FIG. 35A). In addition, at Step 2354 AC determines if this is this C's N-th transgression. If no, process goes to step 2358. If yes, AC bans Cr (2356), and goes to step 2358 where AC updates database.

Based on inputs from FIG. 23A & 23C (2350), AC declares Cr as missing (2352). Process then also goes (2340) to a troubleshooting routine (FIG. 35A). In addition, AC registers Cr as a No-Show (2352) and goes to Step 2354. There, the AC determined if this is the N-th time (2354) for this particular courier. If not, the database is updated (2358). If this is the n-th time, AC bans Cr (2356), AC the updates database accordingly (2358), and process returns to Normal procedures (2360).

On FIG. 23C, after AC retries Cr N times in M minutes (2363), with no response (2364), AC calls Cr mobile number (2365). If Cr does not respond to call, then process goes (2367) to a (Cr missing) troubleshooting routine (FIG. 23B:2350). If Cr does respond (2364, 2366) process returns (to FIG. 23B) to assess response (2368). If Cr responds (2372, 2381, 2383) that he will be delayed (for example), “X minutes”; then AC transmits a mobApp notification to Sender, and asks Sd: “Would a delay of X-minutes be OK?” (2376).

Next (on FIG. 23D), system determines if Sd responded (2387). If not, AC retries Sd N times in M Minutes (2388). If Sd does not respond to mobApp notifications (2389), AC calls Sd's mobile number (2390). If no response to call (2391), then process calls (2392) another troubleshooting routine (FIG. 35A). If Cr does respond and says “No”, then process again goes to Step 2392. If Cr responds with a “Yes” (2387, 2391, 2393), then AC re-calculates new deadline (2394). Also, AC: thanks Sd and informs Sd (via mobile, email, SMS, etc) of new deadline (2395); informs Cr of new deadline (via mobApp); and updates database (2397). Process then returns to Normal procedures (2398).

FIGS. 24A & 24B are logic flowcharts for Pickup Process: Troubleshooting—Sender is not here. On FIG. 24A, after Cr clicks the, “”Not here” button (2406), then AC Instructs Cr to wait for N1 minutes (2408), and AC re-instructs Sd to show up (2410). If Sd does not show-up (2412), AC retries Sd N2-times in M-minutes (2416). If Sd still does not show-up, then AC Calls Sd mobile number immediately (2424). If Sd does not show-up after AC call (2430), process goes to another (e.g., failed pickup) troubleshooting routine (2432). If Sd does show-up (2422), process returns to Normal procedures (2414).

On FIG. 24B, after continued Sd no-show (2440), AC then: instructs Cr to leave without parcel (2442); AC waives all liability (2446); pays Cr; doesn't refund Sd; and leaves bad feedback about Sd (2448). Also, the AC: registers parcel as Failed Pickup; updates Database; and STOPS process (2450).

FIG. 25 is a logic flowchart for the Pickup Process Troubleshooting: Sd & Cr RACs do Not match (2500). When a Cr arrives (2504) at an Sd location to pick-up a parcel, if their RACs do not initially match, then AC asks Cr to carefully check & repeat the RAC (2506). If RAC1 and RAC then do match (2510), process goes to Step 2590. If RAC1 and RAC still do not match (2510), then AC asks Sd to carefully recheck and repeat his RAC1 (2520). If there is then a match (2530), process again goes (2590) back to FIG. 13C.

If there is still no match (2530), then: AC records number of match attempts, and after N failed attempts, the AC transmits instructions to Sd (via mob.App) for the Sd to contact AC. If Sd does not contact AC within M minutes, then AC contacts Sd (2541). After contact is made, AC assesses the situation [talks to both Sd & Cr] (2550). Here, the duality of the relationship/interaction shown on the drawing (Sd/AC, AC/Sd) is meant to convey that even if (for whatever reason) the sender does not contact the AC, Platform will still be contacting him to resolve the issue/investigate further.

If issue is not resolved (2560), then AC escalates issue (2580). If issue is resolved, system goes to Step 2590, where process returns to Normal pickup procedures.

FIGS. 26A & 26B are logic flowcharts for the Pickup Process: Sd & Cr RACs confirmation. (2600). On FIG. 26A, system checks whether Sd has inserted his RAC (2606). If not, after N minutes from time the “I'm here” button is pressed by Cr, the AC notifies Sd to insert RAC for up to M notifications (2608). If RAC is not inserted by Hs after M notifications (2612), process goes to Step 2614.

If Sd does make a timely insertion of RAC (2606), AC determines if RAC is confirmed (2620). If so, process goes to Step 2632. If no RAC confirmation, then (2622) AC requests the Sd to retry (up to N2 times). If retrial by Sd is successful (2624); process again goes to Step 2632, where AC Activates Route; and AC informs Sd, Rc, & Cr of successful route activation. Next, (2626) AC resends RAC to Sd for tracking (as a reminder); and process goes (2628) back to Normal procedures (FIG. 13C).

If retrials are not successful (2624), then process goes to step 2614, where AC contacts Sd and enquires about RAC, and system goes to step 2616 (FIG. 26B).

On FIG. 26B, If Sd does not respond to RAC query (2656), AC retries up to N-times to contact Sd (2662, 2654). After N unsuccessful retries, AC contacts Cr and enquires about parcel pickup (2664). If Cr responds and confirms pickup (2668), process returns (2660) to regular (route activation) procedures (FIG. 26A:2630). If Cr does not respond, or if Cr responds but does not confirm parcel pickup, then process goes to Step 2674. There, AC waives all liability, and insurance policy is void (2674). Next, the AC: pays Cr, doesn't refund Sd, and leaves bad database feedback about Sd (2676). Also, there is No tracking capability available for Sd (2678). In addition, AC Registers parcel as “failed Pickup”, Updates Database, and STOPS process (2680).

FIGS. 27A, 27B & 27C are logic flowcharts for the Delivery Process (2700). After successful parcel pickup and route activation; on FIG. 27A, delivery starts (2706). At 2708, AC monitors the progress of Cr route, (or CMT route, if a CMT has “stepped into the shoes” of a Cr), towards delivery. AC also provides data input rules for assessment of progress (2712). AC software dynamically assesses if progress is satisfactory (2710). If AC computes that Progress is NOT ok (2716), process goes to a delivery troubleshooting routine (2730).

If progress is OK, system determines if Cr has arrived at address of parcel collecting Rc or Hs (2718). If Cr is at a Hs, process goes to a Cr drop-off at Hs routine (2732). If Cr is at a Rc address, Cr Informs (2720) AC of arrival using mobApp/ECD “I'm here” button (or equivalent ECD function key). AC Informs Rc of Cr's arrival (2722), and system determines if Cr and Rc meetup ok (2724). If not, process goes to another (Rc not here) delivery troubleshooting routine (2734). If they meet up OK, Rc gives DCC (Delivery Confirmation Code) to Cr (2728) and delivery process goes to (2736) to FIG. 27B.

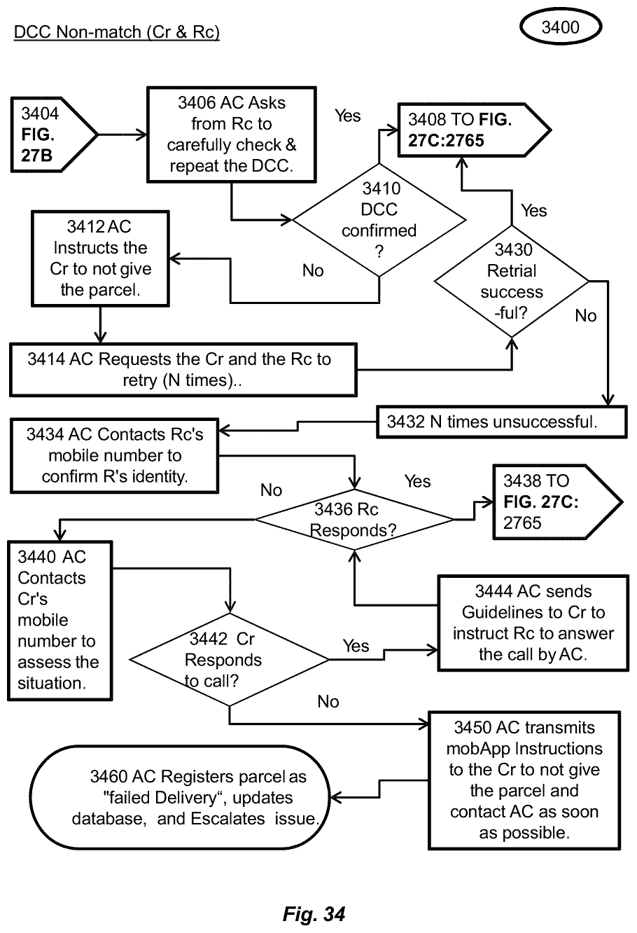

On FIG. 27B, Cr inputs the DCC to mobApp (2744). If DCC is confirmed, process goes (2760) to FIG. 27C. If not, AC instructs Rc to repeat and Cr/CMT to retry (2747), up to N-times (2748). If no success after N-retries, AC resends DCC to Rc, and instructs to retry (2752, 2754); and if there is still no confirmation, process goes (2758) to FIG. 34. If DCC is confirmed (within N-retries), process again goes (2760) to FIG. 27C.

On FIG. 27C, AC Informs Cr and Sd of confirmed delivery (2768, 2680); asks Sd for feedback about Cr (2782); and goes to Step 2734. Also, Cr gives parcel to Rc (2770). Then, AC sends funds and or other compensation (2772) to Cr/CMT account. Such compensation can include award (2790) of Ecopoints (see Glossary). As an example, for senders of parcels, AC uses database to collect, analyze, and project aggregated information about the parcels they send (e.g., for distinguishing senders that prefer longer routes, heavier/bulky objects etc.). This type of data is also usable by the AC in determining what Ecopoints (if any) should be credited to a given Sd account.

AC also asks Cr to give feedback about Sd (2774); and updates Cr/CMT & Sd profiles (2784). AC then registers parcel as “successful delivery”; STOPS process (2790); and updates database (e.g., incorporates delivery data that might impact Ecopoint awards).

FIG. 28A, 28B, 28C & 28D are logic flowcharts for the Delivery Process: Troubleshooting (Courier en route). On FIG. 28A, AC activates Orange Alert via notification on mobApp (2804). AC asks Cr, “Are you OK?”, and AC activates buttons offering two choices for answer: (a) “Yes”, or (b) “I'm in trouble”. If Cr does not respond (2806), then AC retries Cr (2810) up to N-times in M-minutes (e.g., 3 times in ten minutes). If still no response (2812), then AC Calls Cr mobile Number (2814). If Cr does not respond (2816) then process (2818) goes to FIG. 28C (2871, Declares).

If and when (2808) he does responds, if Cr click choice (b) “I'm in trouble” (2826), then process goes (2828) to FIG. 28B (2832, Trouble). If Cr clicks (2820) choice “(a) Yes” (i.e., I'm OK”.), then AC updates database (2822), and process (2824) goes to FIG. 27A (2714, Data Input). This Data input branch returns to FIG. 27 so as to feed into the Normal process, (in effect, the data saying something like, “Hey Database and algorithms, issue has been resolved, continue monitoring and reporting as usual”).

On FIG. 28B, after Cr signals “I'm in trouble” (2834), AC activates Red Alert: Via notification on mobApp. AC also (2836) asks Cr, “What is wrong?”. AC further offers two choices (buttons) for answer: (a) “I'll be late”, (b) “I cannot deliver” 2836). If Cr does not respond (2838) then process (2839) goes to FIG. 28C (2860, Retries). If Cr responds (2844) “I cannot deliver.”, then process (2845) goes to FIG. 35A (3504, CMT call). Also, AC leaves automatic feedback in database (2847); and AC ascertains if this is the N-th ((2852) time out of a total M-times? If so (2853) AC Bans/Penalizes Cr (2849), and process (2858) again goes to FIG. 27A (2714, Data Input). If AC determines that it is not the N-th time that Cr signaled that he could not deliver (2855), then process goes to step 2866 (FIG. 28C:2877).

On the other hand, if Cr's reply is (2842) “I'll be late.”(2846); then via mobApp/ECD notification, AC asks Cr, “How long will your maximum delay be?” (2848). If Cr does not respond (2850 then process (2851) goes to FIG. 28C (2860, Retries). If Cr responds with, (for example) “X minutes” (2852), then AC, via mobApp, notifies Recipient; and AC asks Rc: “Would a delay of X minutes be OK? (2854)”. Process then goes to step 2856 (FIG. 28D).

On FIG. 28C, If Cr does respond to the AC's delay query (2862) within the preset number of retries (2864), then process goes (2865, 2870) to FIG. 28B (2840 & 2849, Cr replies). If Cr does NOT respond to the AC's delay query (2865), then AC calls Cr mobile number (2866). If Cr does not respond (2868) to call, then AC: (2872) declares Cr as missing; (2873) initiates “Lost package” procedures; (2874) informs Sd, Rc, & Hs (if applicable) of lost package; (2875) legally pursues and bans Cr; and (2876) pays insurance to Sd. AC then updates database (2877) and process then goes to step 2880 (FIG. 27A: 2714).

On FIG. 28D, If Rc does not respond (2882) to the AC's (X-minutes) query, after a preset number of retries (2884, 2886); then AC calls Rc mobile number (2887). If Rc does not respond to call (2888), or if Rc responds with a “NO” (2890), then process goes to step 2891(FIG. 35A: 3504). If Rc responds to (X-minute query) with a “YES” (2890), AC recalculates a new deadline (2892). Also, AC: (2893) thanks Rc and informs Rc of new deadline (mobile+email); (2894) informs Cr of new deadline (mobApp); and updates database (2896). System then returns (2898) to Normal procedures (FIG. 27A: 2714). This means that since the issue has been resolved, the database and algorithms can resume updating time and records, and continue monitoring and reporting as usual.

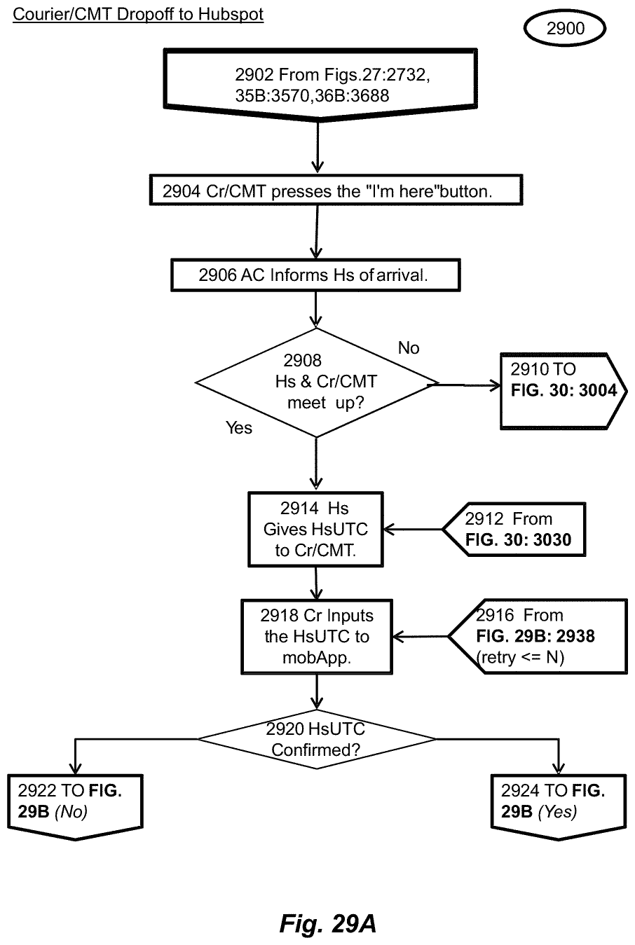

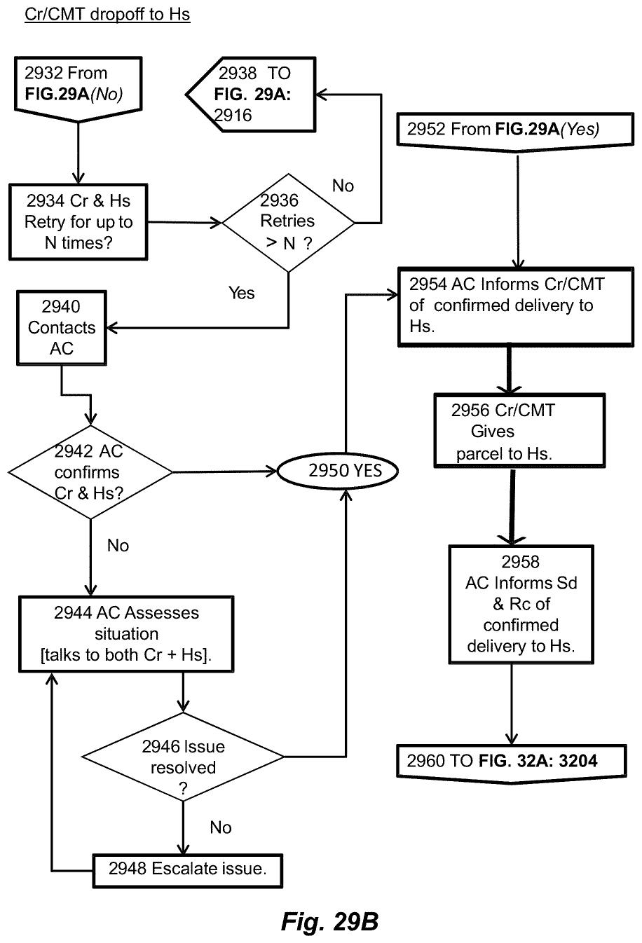

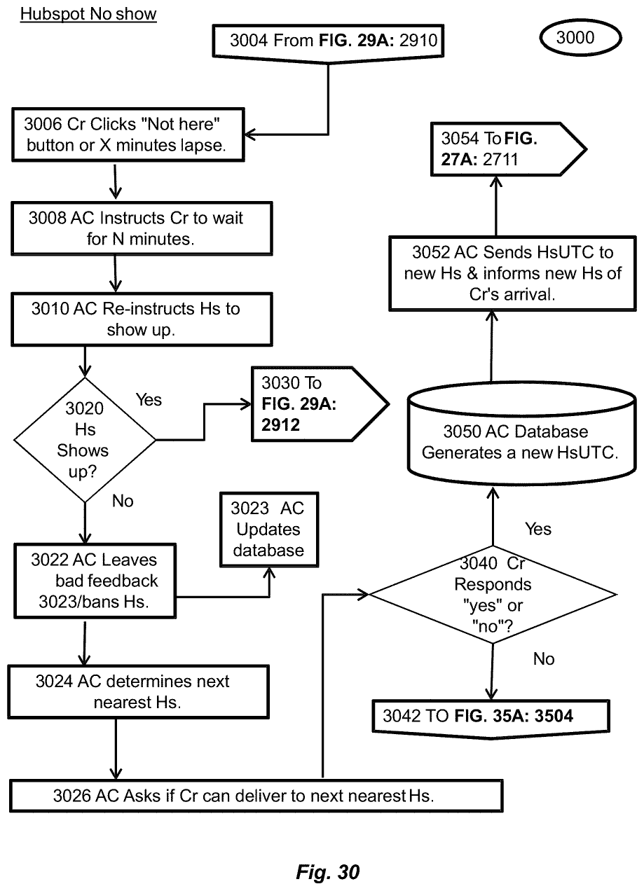

FIGS. 29A & 29B are logic flowcharts for the Delivery Process: Courier/CMT Delivers to Hubspot (2900). [Note that at this point, a CMT may have “stepped into the shoes of” (i.e., replaced) the Cr. (See FIGS. 35C:3589, 36B:3688.)] On FIG. 29A, after Cr/CMT presses (2904) the “I'm here button), (2906) AC Informs Hs of arrival of Cr. If Hs & Cr/CMT do not meetup (2908), process goes to step 2910 (FIG. 30:3004). If Hs & Cr/CMT do meetup (2908), Hs gives HsUTC (2914) to Cr; and Cr/CMT inputs the HsUTC to mobApp/ECD (2918). If HsUTC is not confirmed (2920, 2922), process goes to FIG. 29B (No). If HsUTC is confirmed (2924), process goes to FIG. 29B (Yes).

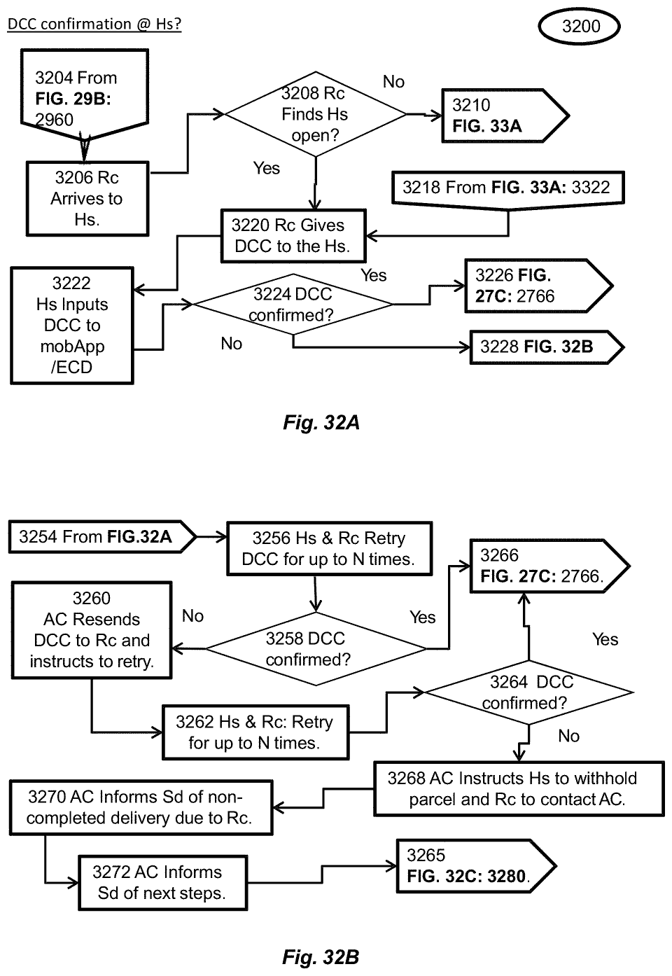

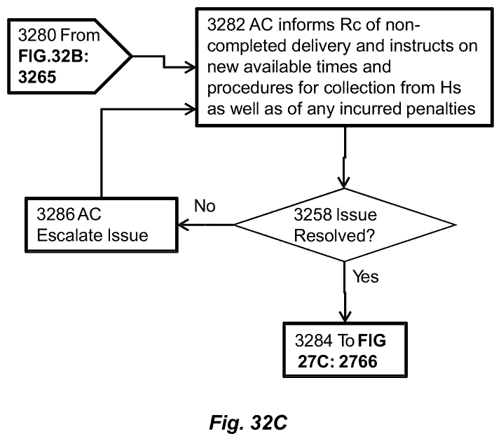

On FIG. 29B, if Cr/CMT & Hs retry to confirm up to N-times (2934), and are not successful; the AC is contacted (2940). If (2942) AC confirms Cr & Hs; process goes (2950) to Step 2954. If AC does not confirm Cr & Hs; then (2944) AC Assesses situation [talks to both Cr+Hs]. If issue is not resolved (2946), AC Escalates issue (2948). If issue is resolved, process goes to step 2954, where AC Informs Cr of confirmed delivery to Hs. Then Cr gives parcel to Hs (2956). Next, (2958) AC informs Sd & Rc of confirmed delivery to Hs; and process goes to step 2960 (FIG. 32A:3204).

FIG. 30 is a logic flowchart for the Delivery Process: Troubleshooting—Hubspot closed (3000). After (3006) Cr Clicks “Not here” button or X minutes lapse, (3008); AC Instructs Cr to wait for N minutes; and (3010) AC re-instructs Hs to show up. If (3020) Hs shows up, process goes to step 3030 (FIG. 29A:2912). If (3020) Hs fails to show up, then AC: (3022) leaves bad feedback/bans Hs; AC updates database (3023); and AC determines next nearest Hs (3024). AC then, (3026) asks if Cr can deliver to next nearest Hs. If Cr responds (3040) “No”, process goes (3042) to FIG. 35A:3504. If Cr responds (3040) “Yes”, then AC database: generates a new HsUTC (3050); sends HsUTC to new Hs & informs new Hs of Cr's arrival (3052). Process then goes to step 3054 (FIG. 27A:2711).

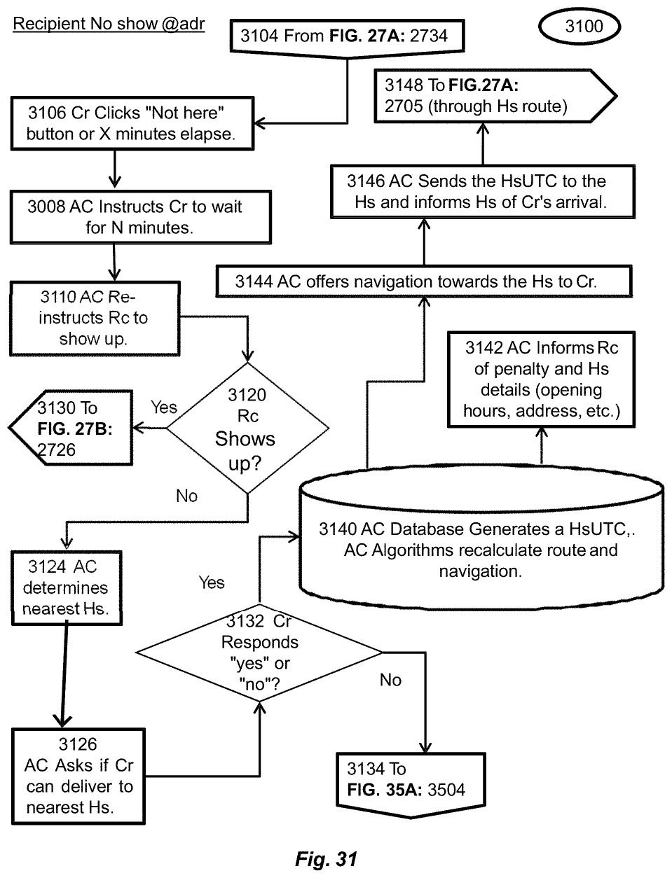

FIG. 31 is a logic flowchart for the Delivery Process Troubleshooting: Recipient is not here (3100). After Cr Clicks “Not here”button, or after X minutes elapse (3106); the AC: instructs Cr to wait for N minutes (3108); and (3110) AC re-instructs Rc to show up. If Rc shows up (3120) process goes to step 3130 (FIG. 27B:2726). If Rc does Not show-up, then AC: (3124) determines nearest Hs, and (3126) asks if Cr can deliver to nearest Hs. If Cr responds “No” (3132), process goes to step 3134 (FIG. 35A:3504). If Cr responds “Yes”, then: (3140) AC database Generates a HsUTC, and AC algorithms recalculate route and navigation. AC then (3142) informs Rc of penalty and Hs details (opening hours, address, etc.). Next, (3144) AC offers navigation towards the Hs to Cr, and (3146) AC Sends the HsUTC to the Hs and informs Hs of Cr's arrival. Process then goes (3148) to FIG. 27A: 2705 (through Hs route).

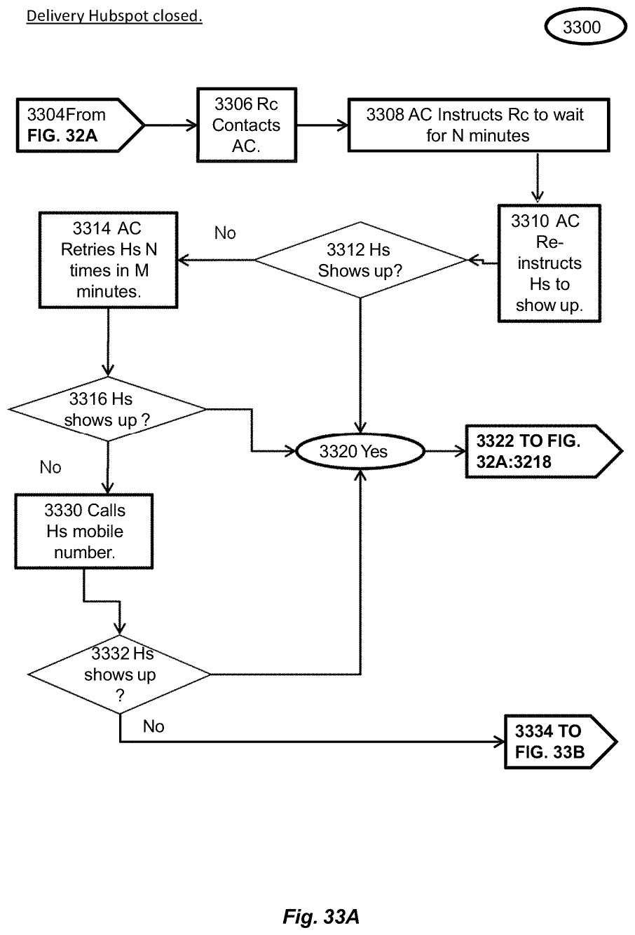

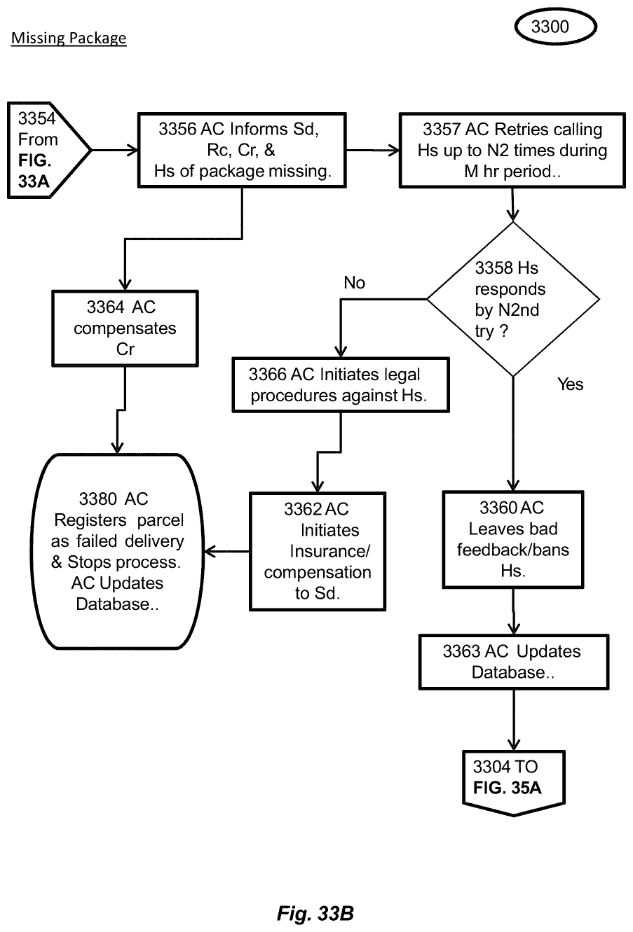

FIGS. 32A, 32B & 32C are logic flowcharts for the Delivery Process: Recipient collects the parcel from a Hubspot (3200). On FIG. 32A, if Rc arrives at Hs (3206) and finds that Hs is Not open (3208), process goes to step 3210 (FIG. 33A). If Hs is open, (3220) Rc Gives DCC to the Hs; and (3222) Hs Inputs DCC to mobApp/ECD. If DCC is confirmed (3224), process goes to step 3226 (FIG. 27C:2766). If DCC is Not confirmed (3224), process goes (3328) to FIG. 32B.

On FIG. 32B, at step 3256, Hs & Rc Retry DCC for up to N times. If is confirmed (3258), process goes to 3266 (FIG. 27C:2766). If no confirmation, then: (3260) AC resends DCC to Rc and instructs to retry; and (3262) Hs & Rc: retry for up to N times. If DCC is confirmed (3264), process again goes to step 3266 (FIG. 27C:2766). If DCC is Not confirmed (3264), then AC: (3268) AC instructs Hs to withhold parcel; instructs Rc to contact Hs; (3270) AC Informs Sd of non-completed delivery due to Rc; and (3272) AC Informs Sd of next steps. Process then goes to step 3265 (FIG. 32C:3280).

On FIG. 32C, at step 3282, AC informs Rc of non-completed delivery and instructs on new available times and procedures for collection from Hs as well as of any incurred penalties. If issue is not resolved (3258), then AC Escalate issue (3286). If issue is resolved (3258), then process goes to step 3264 (FIG. 27C: 2766).

FIGS. 33A & 33B are logic flowcharts for the Delivery Process: Recipient arrives to collects the parcel from a Hubspot which is closed (3300). On FIG. 33A, after Rc advises AC of closed Hs (3306), AC: (3308) AC Instructs Rc to wait for N minutes; and (3310) AC re-instructs Hs to show up. If Hs shows up (3312), process goes to Step 3320. If Hs does not show-up (3312), AC retries Hs N-times in M-minutes (3314). If Hs then shows up (3316), process goes to Step 3320. If Hs still does Not show-up, then AC calls Hs mobile number (3330). If Hs then shows up (3320), process goes to Steps 3320 and 3322 (FIG. 32A:3218). If Hs does not show-up responsive to the call, process goes to step 3334 (FIG. 33B).

On FIG. 33B, after AC informs Sd, Rc, Cr, and Hs of “package missing” (3356); AC compensates Cr (3364), and process goes to Step 3380. Also, (3357) AC retries calling Hs up to N2 times during a M-hour period. If Hs does respond by the N2nd retry (3358), then AC: transmits bad feedback/bans Hs (3360); updates database (3363); and process goes to step 3304 (FIG. 35A). If Hs does Not respond by the N2nd retry (3358), then AC: (3366) AC initiates legal procedures against Hs; (3362) AC initiates Insurance/compensation to Sd. Process goes to Step 3380, where the AC registers parcel as, “failed delivery” & Stops process; and updates Database.

FIG. 34 is a logic flowchart for the Delivery Process: Troubleshooting—Cr & Rc DCCs don't match (3400). At step 3406, AC asks Rc to carefully check & repeat the DCC. If DCC is confirmed (3410), process goes (3408) to FIG. 27C (2765). If DCC is Not confirmed (3410), then: (3412) AC instructs the Cr to not give the parcel; and (3414) AC requests the Cr and the Rc to retry (N-times. If a retrial is successful (3430), process again goes (3408) to FIG. 27C (2765).

If N retrials not successful (3432) then AC contacts Rc's mobile number to confirm Rc's identity (3434). If Rc responds (3436) process goes (3438) to FIG. 27C (2765). If Rc does not respond (3436), AC contacts Cr's mobile number to assess the situation (3440). If Rc responds (3442) to call, then (3444) AC sends Guidelines to Cr to instruct Rc to answer the call by AC. If Rc does Not respond (3442), then AC: transmits mobApp instructions to the Cr to NOT give the parcel and to contact AC as soon as possible (3450); registers parcel as “failed Delivery”; and Escalates issue (3460).

FIGS. 35A, 35B & 35C are overview flowcharts for CMT member meetups with another user, and replacement of a courier or hubspot, during either the parcel pickup or the parcel delivery processes (3500).

On FIG. 35A, at step 3506, the AC receives data from mobile device type sensors (e.g. WiFi, accelerometer, GPS) about the location of Cr, CMT and Hs members. Then, AC dynamically calculates the optimum route to Sd, Hs, Rc, or to a meeting point within Cr's route. These computations take into account the current Cr, CMT members' positions/routes, speed and expected time to reach meeting point, and CMT skills. AC algorithms use this data to generate/select the optimal choice of CMT member to takeover transport of the parcel (3510).

Based on the inputted, computed and previously stored data, AC determines C (Crisis Management Team) is possible (3512). If NOT, AC: (3520) so informs Sd; refunds Sd; and (if Cr is not the cause of the problem) AC pays the Cr (3522). AC also contacts Cr and instructs Cr to reschedule delivery to Rc, Hs or new CMT meetup (3524). Next, AC registers parcel as “failed pickup”, updates database, and STOPS process (3530).

If AC determines that CMT delivery is possible (3512), then AC transmits notification, with meeting point data, to the CMT; and to Sd, Hs, Rc, and/or Cr (3514). Process then goes (3518) to FIG. 35B.

On FIG. 35B, after AC transmits meetup data (3553), AC detects whether the selected CMT member has responded (3554). If not, the AC (3556) retries up to N-times to contact selected CMT member. If N retries are Not successful (3556, 3557), or if CMT does not accept the Route (3556); then AC records “Low acceptance rate” to CMT member and sends a warning message (3558) to him. Process then returns (3560) to FIG. 35A:3508 (Recalc).

If selected CMT responds (3554), and accepts the calculated Route (3559); then AC Database generates CMT-UTC (3562). Note that the UTCs are different from the DCCs. and RACs. UTCs are used only for parcel exchanges (e.g., at relay points (n1-n2-n3- . . . n′) between Platform members (i.e., Cr, Hs, CMT). UTCs are not for interactions with original clients (i.e., Sd or Rc). In other word, UTCs are not used for activation or delivery confirmation. Also, the AC generates a different UTC for each intra-route exchange, whether for emergency or non-emergency purposes.

For example, our Platform is configured to handle routes which include not just start and end points, but also may comprise one or more interim (relay-type) points. In other words, rather than just a point A to point B network, we also have means for handling an A-n1-n2-n3- . . . n′-B network. Thus, in cases where a plurality of member handoffs are needed, the AC generates a plurality of distinct UTCs.

Next (3564), the AC sends (to CMT) the meeting point directions and the CMT-UTC. AC then monitors (3566) the progress of both Cr and CMT's routes towards the meeting point (3568). If meetup is with a Hs, process goes to step 3570. If meetup is with a Rc, process goes to step 3574. If meetup is with a Cr (3576), process goes to step 3578 (FIG. 35C:3580).

On FIG. 35C, if progress towards meetup is Not satisfactory (3578), then AC ascertains if it is the CMT's fault (3591). If so, AC: (3592) cancels CMT, informs CMT of route cancelation, (3594) penalizes CMT member, and AC finds new CMT member (3596). Process then goes (3598) to FIG. 35A:3508. If AC ascertains that CMT is Not at fault (3591), then AC rewards CMT and informs CMT of route cancelation (3597). Then, AC: leaves automatic feedback and/or bans/penalizes Cr (3593); and AC contacts Cr to reschedule delivery to Rc or new CMT meetup (3595). Process then goes (3598) to FIG. 35A:3508.

If progress towards meetup seems satisfactory (3581), but Cr and CMT do Not meetup (3582), then AC contacts CMT & Cr; Escalates issue; offers guidance (at Step 3590); and rechecks progress (3581). If Cr and CMT (3583) do meetup (e.g., through data from GPS, etc.), then at this stage this process is straightforward since a CMT is involved, thus Platform has an expert onsite (3582). Next, it is determined whether CMT-UTC is confirmed (3584). If no confirmation, process goes again to Step 3590. If CMT-UCC is confirmed, then CMT collects the parcel (3586). Process then goes (3589) to FIG. 29A.

FIGS. 36A, 36B, 36C are overview flowcharts for CMT member parcel pickups from Sender (3600). On FIG. 36A, AC software collects information (3610) about CMT members (from GPS, prior ratings, availability/timing data, etc.); and AC Database receives & stores CMT data (3612). If and when AC determines that a CMT is needed (3606), AC software routines dynamically calculate which CMT members' location best matches the pickup point defined by Sd (3620). Then, AC transmits an emergency “Notification To Carry” signal, to best CMT member, with an N-minute deadline to respond (3622).

If selected CMT does not timely respond, then process goes (3632) to FIG. 36C. If CMT does timely respond, (3634), then: AC database generates RAC & RAC1 and directions to pick-up point; transmits directions & RAC to selected CMT; and AC transmits RAC1 to Sd. Then AC monitors the progress of CMT's route towards the meeting point with Sd (3624); and process goes (3640) to FIG. 36B.

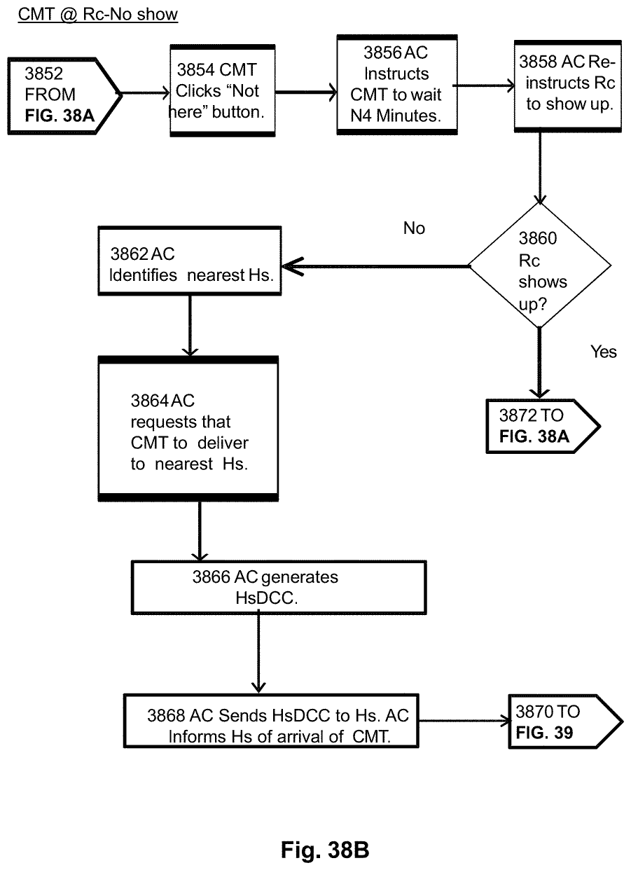

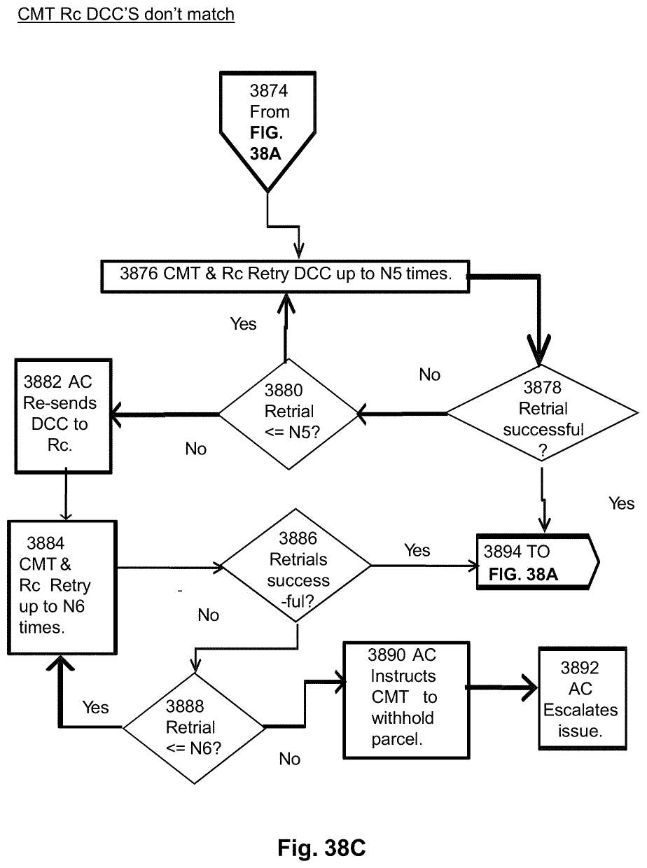

On FIG. 36B, after Sd and CMT meetup (3680), they confirm matchup of RAC and RAC1 (3681). [At this stage the process is straightforward since a CMT is involved, and Platform thereby now has an expert onsite (3682).] Thus, in effect, CMT now: “Steps into the shoes” of Cr; and Crisis Management Team member then follows Pickup process steps normally done by courier (3684). Therefore, (3686) CMT collects the parcel from Sd, and process goes (3688) to FIG. 29A (dropoff to Hs), or to FIG. 38A (delivery to Rc).

On FIG. 36C, if CMT does Not (3654) timely respond (to emergency route offer signal from AC), then (3656) AC retries to contact selected contact CMT member up to N-times (3658, 3660). If retries do not succeed; or if CMT responds, but does Not accept route; process goes to step 3662. There, AC records “Low acceptance rate” for CMT member; AC sends warning message (3662); and process goes (3664) back to FIG. 36A. If CMT accepts route (3666), process goes (3668) to FIG. 36B:3676.

FIG. 37 is an overview flowchart for a CMT member parcel pickup from a Hub spots (3700). As the CMT proceeds toward Hs (3708), the AC monitors progress (3712). When (3716) CMT arrives at Hs, (3724) CMT Informs AC of arrival via mob.app “I'm here” button. AC then informs Hs of CMT arrival for pickup (3728); and AC requests RAC input from Hs to mob.app. (3732). When Hs & CMT meetup (3734), they confirm matchup of RAC & RAC1 (3736). Then: (3738) Hs gives parcel to CMT, (3740) CMT receives parcel, and process goes to step 3750 (FIG. 3 8A:3 804).

FIGS. 38A, 38B & 38C are overview flowcharts for CMT member deliveries directly to Recipients. On FIG. 38A, as the CMT proceeds toward Rc (3806), the AC monitors progress (3808). When CMT arrives at Rc (3810), CMT informs AC of arrival via mob.app “I'm here” button/ECD equivalent (3812). AC transmits notice of Rc of CMT arrival to Rc (3814). If Rc and CMT do Not meetup (3816), process goes to step 3818 (FIG. 38B). If they do meetup, (3822) Rc gives DCC to CMT; and CMT inputs DCC from Rc to mob.App (3824).

If AC does Not confirm DCC (3826), process goes to step 3828 (FIG. 38C). If DCC is confirmed, then AC: informs CMT (3836) and Sd (3832) of confirmed delivery; AC asks Sd for feedback; and process goes to Step 3848. Also, after DCC confirmation, (3838) CMT gives parcel to Rc. Next, after N3 minute delay (3840), AC transfers funds to CMT account; and AC asks CMT for feedback (3846). Process then goes to step 3848, where AC updates Sd and CMT profiles. Here, in addition to monetary compensation, the AC may/may not also award Ecopoints to the Sd, the CMT or both.

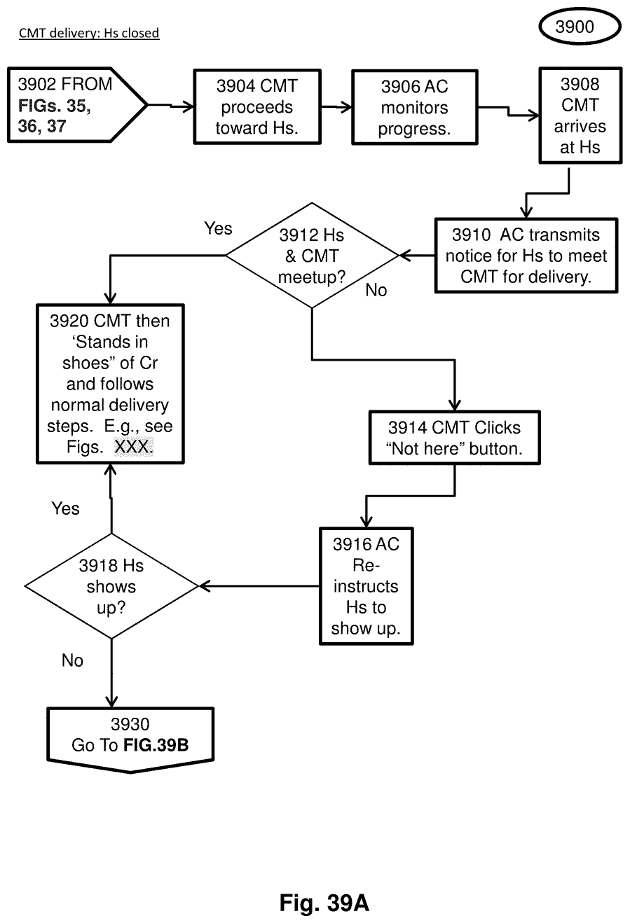

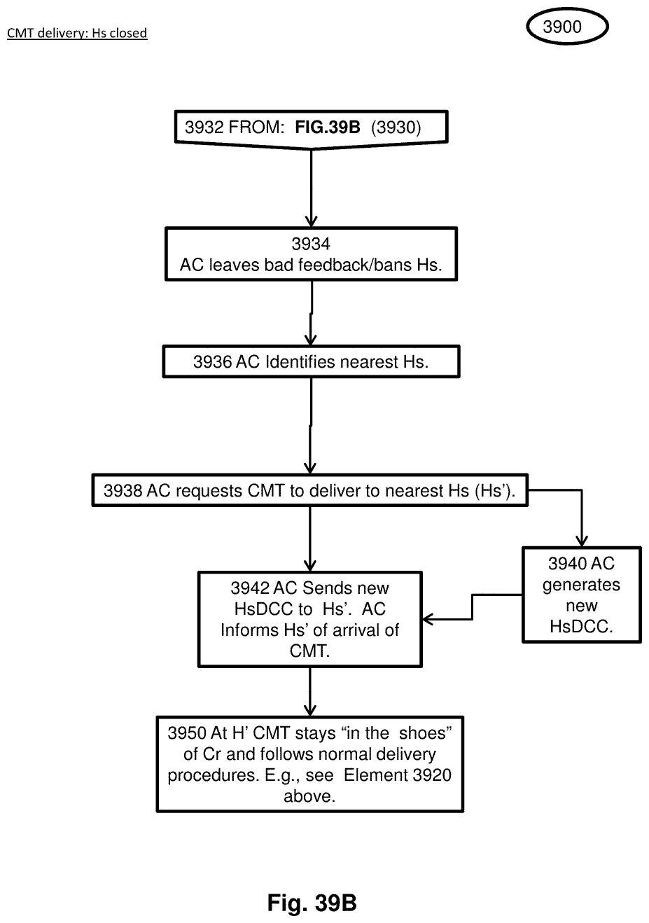

On FIG. 38B (when Rc does not meetup with CMT), after CMT clicks “Not here” button (3854); AC: instructs CMT to wait N4 Minutes (3856); and transmits instructions for Rc to show-up (3858). If Rc does show-up (3860), then process goes (3872) to FIG. 38A. If Rc does Not show-up (3862), AC identifies the nearest Hs (3862); requests CMT to deliver to nearest Hs (3864); and AC generates HsDCC (3866). Next, AC Sends HsDCC to Hs and AC informs Hs of pending arrival of CMT (3868). Process then goes (3870) to FIG. 39.

On FIG. 38C (when DCC is not initially confirmed), (3876) CMT & Rc retry DCC up to N5 times. If one of these (up to N5) retrials is successful (3878), then process goes back to FIG. 38A (3894). If the (up to N5) retrials are Not successful (3880): AC re-sends DCC to Rc (3882); and the CMT & Rc retry up to N6 times (3884). If one of these (up to N6) retrials is successful (3886), then process again goes back to FIG. 38A (3894). If Not (3888), AC transmits instructions for CMT to withhold parcel (3890), and AC Escalates issue (3892).

FIG. 39 is an overview flowchart or CMT member deliveries where a designated Hubspot (Hs) is closed. As (3904) CMT proceeds toward Hs, AC monitors (3906) her progress; and when (3908) CMT arrives at Hs, AC transmits notice for Hs to meet CMT for delivery (3910). If they do meetup (3912), CMT then process goes to Step 3920, where CMT: “Stands in shoes” of Cr (3920), and follows normal pickup/delivery steps. For example, see FIG. 29 (dropoff at Hs) and FIG. 37 (pickup from Hs).

If Hs and CMT do Not meetup (3912), after CMT (3930) Clicks “Not here” button, (3932) AC re-instructs Hs to show up. If Hs then shows-up (3934), process again goes to Step 3920. If Hs does Not show-up (3934), then AC: (3940) AC leaves bad feedback/bans Hs; (3942) AC identifies nearest Hs; (3944) requests CMT to deliver to nearest Hs (i.e., Hs′); (3946) generates new HsDCC (i.e., for substitute, H′); (3948) sends new HsDCC to Hs'; and AC informs Hs′ of pending arrival of CMT. When CMT reaches H′, the CMT: stays “in the shoes” of Cr (3950 At H′), and follows Normal delivery procedures, such as those illustrated at FIG. 29A and FIG. 37. (E.g., see Element 3920 above.).

FIGS. 40A & 40B are overview logic flowcharts for the Loading Capacity Optimization (“LCO”) Process with an optional Augmented Reality (“AR”) module (4000).

Note that our platform is compatible with different types of couriers and both Platform-owned and individually-owned hubspots. These Cr/Hs may be differently configured, such that some are more or less amenable to generation of required input for the algorithmic AR processing code of our AR processing module.

For example, physical structure of a given Cr/Hs (carrying/storing) space may impact what type, and how much, AR information is obtainable. So can available scanning equipment. The ECD apparatuses used with our Platform can have devices typically found on mobile (“smart”) phones, including: cameras, GPS, accelerometers, WiFi, and third-party internet connectivity (GSM card, etc). some of these will have facilities that allow use of our AR programs and some Cr/Hs may not be AR enhanced.

Note that (as previously indicated), our Platform's computer processing resources include both centralized and decentralized components. For example, some of the processing in Cloud servers (e.g., see element 140); and some of the processing utilizes the computing capacity of an ECD such as a mobile/handheld type device (150) or desktop/laptop type device (155).

On FIG. 40A, based on newly inputted data (e.g., size, shape, weight of parcel) registered data (e.g., capacity and configuration of Cr carrying spaces and Hs storage spaces), and stored data (potential delivery routes, traffic, weather, hazards, etc), AC if LCO (Loading Capacity Optimization) option is to be used (4012). Note that our platform is compatible with different types of couriers and hubspots; and some of these will have facilities that allow use of our AR programs and some Cr/Hs may not be AR enhanced. If the AR option is not to be used for a given package, then system returns (4018) to Order Placement Process. (E.g., see FIG. 12A.).

If LCO option is chosen by AC, then the LCO Process begins at step 4004). At step 4006, a scan (FIG. 6) is made, with mobApp/ECD, of the available parcel/luggage area—e.g., luggage area, unused area in cabin of car, rucksack, motorcycle top-box and/or side boxes, garage or generic storing areas in Hs, etc [see FIGS. 5A-5G (506, 508, 524, 534, 544, 554)].

At step 4032, the AC receives package parameters & other registration data from the order placement process (FIG. 12A). At step 4040, the AC aggregates and processes initial input and stored data from scans and other sources. LCO process then goes to FIG. 40B.

On FIG. 40B, at step 4064, the AC (based on collected initial inputted and processed data, and updated data) dynamically calculates loading capacity. At step 4066, AC uses loading optimization algorithms to dynamically compute optimal loading configuration. Our AR module uses constraint-driven distance-space geometric spatial query algorithms, (which include a number of optimization and Satisfiability Solver solutions).

Next, AC transmits, via their mobApp/ECD, display configuration information to Cr and/or Hs (4070), by utilizing the AC Augmented Reality (AR) module (4058).

AC confirms loaded configuration of Cr and/or Hs, via the mobApp, by utilizing the AR (4040). Then AC registers (in the database) the available/unavailable space, at Cr and/Hs (4060). AC then updates data on loading capacity accordingly (4046).

FIGS. 41 to 46 are screen shots illustrating procedures relating to calculations of radius. [E.g., see radius elements (442, 446) on FIG. 4D]

FIG. 41, for example, is a picture of an ECD screen (4100) for a user-courier display. Here, on the left side of screen, there is illustration of input means (4112) and a display controller (4114). The right side of this screen shows display (4102) mechanisms for an exemplary radius calculation. Here the user-carrier has input a route on a map with a distance-from-route radius displayed at 565 meters (4106). The resultant route (4108) and radius display (4104) are also illustrated here.

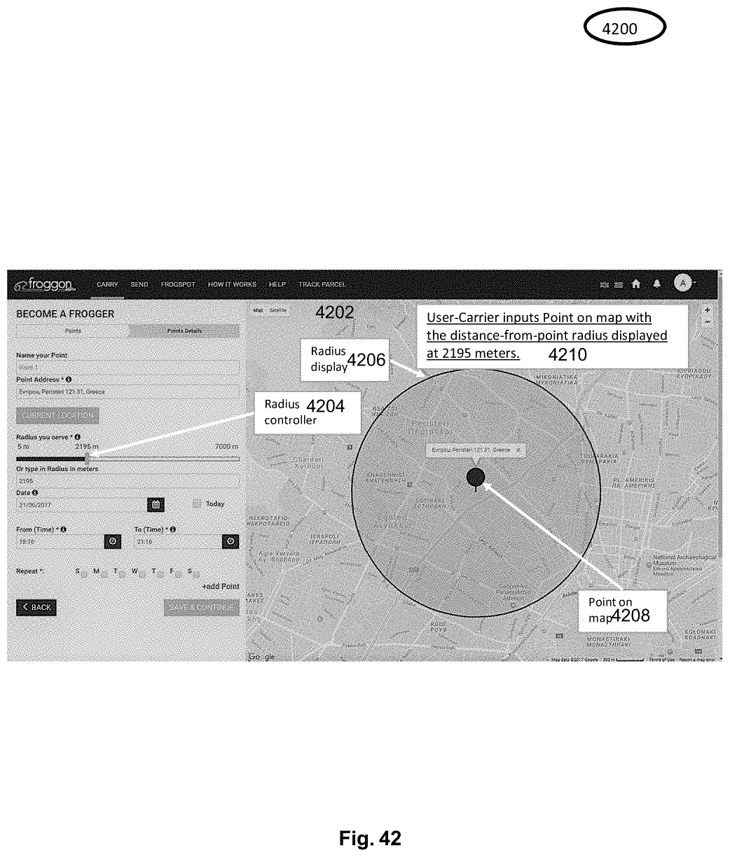

FIG. 42, for example, is a picture of another ECD screen (4200) for a user-courier display. Here, the right side of this screen (4202) shows display mechanisms for a different radius calculation. Here the user-carrier inputs points on a map (4208) with a distance-from-route radius displayed at 2195 meters (4210). The resultant circular radius display (4206) is also illustrated here.

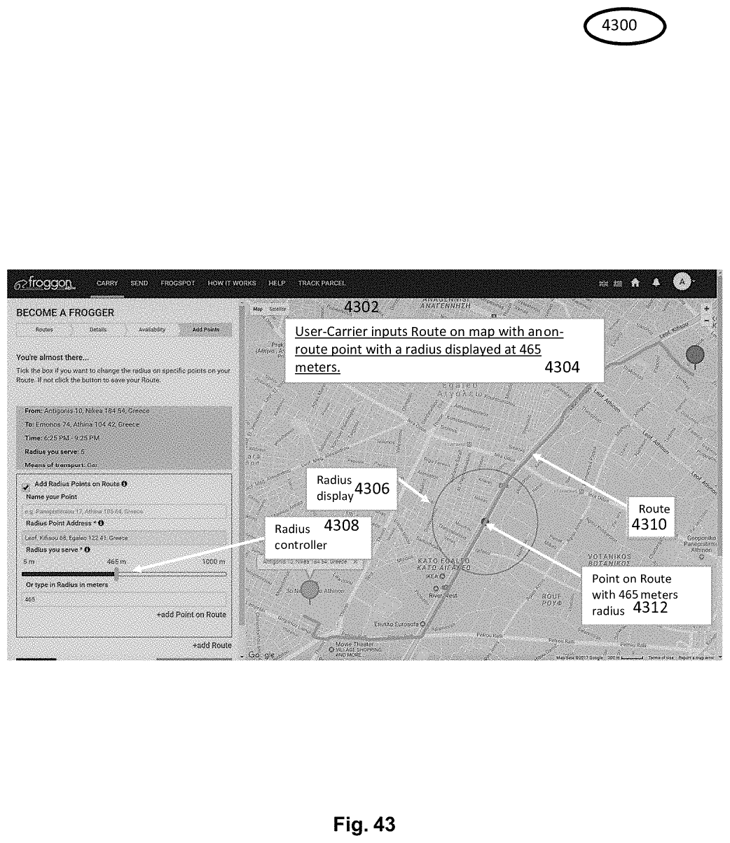

FIG. 43, for example, is a picture of another ECD screen (4300) for a user-courier display. Here, the right side of this screen (4302) shows display mechanisms for a different radius calculation. Here the user-carrier inputs (4304) a route (4310) on a map with an on-route point (4312) with a radius displayed at 465 meters (4308). Also shown is a circular radius display (4306).

FIG. 44, for example, is a picture of an ECD screen (4400) for a user-sender display. Here, the right side of this screen (4404) shows display mechanisms for a different radius calculation. Here the user-sender inputs her pickup address (4402) with an approximation of prefixed xx meters radius (as a remedy for cases where the exact address cannot be displayed correctly (4406). Also shown is the Best/Nearest known address (4408) and circular radius display radius display (4410).

FIG. 45, for example, is a picture of another ECD screen (4500) for a user-sender display. The right side of this screen (4504) shows another view of display mechanisms for a radius calculation. Here the user-sender inputs (4506) her pickup address on a map with an approximation of prefixed xx meters radius (as a remedy for cases where the exact address cannot be displayed correctly). Also shown is the Best/Nearest known address (4508).

FIG. 46, for example, is a picture of an ECD screen (4600) for a user-hubspot display. Here, the right side of this screen (4604) shows display mechanisms for a different radius calculation. Here the user-hubspot inputs her Hs address on a map with a prefixed xx meters service radius (4606). Also shown is the Hs location (4610) on the map, the Hs address (4612) and a circular radius display (4608) of map area within xx meters range of the Hs address.

FIGS. 47 to 51 are illustrations of views and equipment relating to use of augmented reality (AR) procedures/mechanisms for determining space availability; and further illustrate some of the mechanisms/procedures discussed in conjunction with FIG. 6.

FIG. 47 illustrates one type of head mounted AR input apparatus (4700). This HMD (4704), in effect, comprises an eyeglass-type structure (4702) with an attached computer-type apparatus (4708).

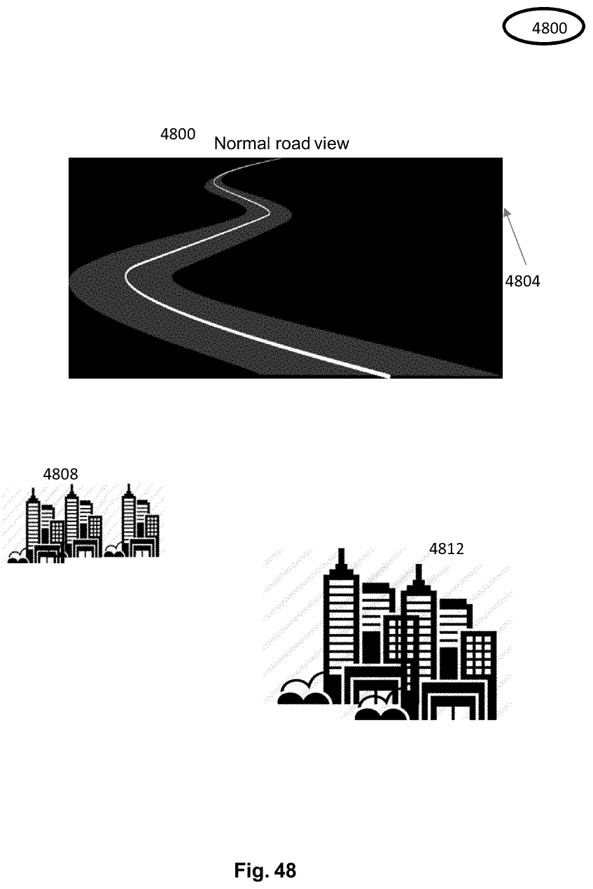

FIG. 48 shows a normal road view (4804), a normal building view (4808), and an enlarged building view (4812).

FIG. 49 shows a similar road view (4906) through AR apparatus (4916). Also shown are a view of a building identified for pickup or drop-off (4908), and a view of that same building (4912) isolated using AR.

FIG. 50 shows a scene (5000) illustrating a normal view of an area (5002) with parcels to be picked up (5004). Also shown (within 5002) is a subarea of excess capacity space (5008).

FIG. 51 shows a similar scene (5100) illustrating a view using an AR apparatus (5110). This view includes an area (5102) with piles of parcels awaiting pickup (5106), where a target parcel has been identified (5108). Also shown (within 5102) is a subarea of excess capacity space (5104).

### CONCLUSION

It is to be appreciated that the forthcoming Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

1. An electronic platform (ePlatform) system, comprising:
a platform administrative computer (PAC) system, including a digital database, digital program code, digital servers and input/output (I/O) interface;
user operated electronic control devices (ECD), configured for communications, computing/processing, storage and I/O operations;
telecommunications network structures for electronically coupling the PAC to users though their ECDs, to at least one from the group including the Internet, to the Cloud, and to third party (P3) providers of geospatial data, computing power, and other P3 sources of information and services; and
a security code module configured to generate security codes responsive to PAC server algorithms, the security codes being configured for transmission to the ECDs, and used by the PAC to control user handling of parcels;
wherein error correction routines are used by the PAC to resolve issues, and the ePlatform is configured to control the user handling.

2. The system of claim 1, wherein the ePlatform controls a crowdsourced transportation system for picking up parcels from a sender, carrying the parcels along a calculated geographic route and delivering the parcel to a recipient.

3. The system of claim 1, wherein the handling includes pickup, handoff and secure delivery of parcels; and wherein the error correction code is configured for activation when users do not perform as required.

4. An electronic platform (“ePlatform”) for logistic control of a crowdsourced transportation system for picking up parcels from a sender, carrying said parcels along a calculated geographic route and delivering the parcel to a recipient; said ePlatform comprising:
a platform administrative computer (“PAC”) system, which includes a digital database, digital program code, digital servers and input/output (“I/O”) interface means;
user operated electronic control devices (“ECD”), configured for communications, computing/processing, storage and I/O operations
telecommunications network structures for electronically coupling the PAC: to users though their ECDs, to the Internet, to the Cloud, and to third party (“P3”) providers of geospatial data, computing power, and other P3 sources of information and services;
security codes, which are generated by PAC server algorithms, transmitted to the user ECDs, and used by the PAC to direct and control user pickup, handoff and secure delivery of parcels;
e) troubleshooting/error correction routines, which are employed by the PAC to define and resolve issues, when users do not perform as required;
whereby the ePlatform controls and supervises the pickup, handoff, interim storage (if necessary) and safe delivery of shipped parcels.

5. The ePlatform of claim 4, wherein the platform users include: “clients” (e.g., “Sd” or parcel senders-shippers, and “Rc” or parcel receiver-recipients); and said users include “members” (e.g., “Cr” or parcel couriers-carriers, “Hs” or hubspot-operators (i.e., Hs owners/administrators), and “CMT” or Crisis Management Team members), and these users electronically interact with the PAC during pickup-handoff-delivery processes, as a parcel is transported along a geographic route.

6. The ePlatform of claim 4, wherein the PAC's digital program code includes software Apps (“mob.Apps”), for directing user performance of parcel handling logistics tasks, and portions of these mob.Apps are downloadable by the PAC to the ECDs, or may be preloaded into ECD memory; and wherein portions of the PAC's program code may be remotely stored/distributed among P3 resource providers.

7. The ePlatform of claim 4, wherein the ECD's processing power is usable by the PAC for certain tasks, and the ECD I/O means includes: screens/earphones or other input devices, for: displaying route information, directions, instructions and messages transmitted by the PAC; and includes buttons/dedicated function keys/touch screens or other output devices for transmitting messages to the PAC.

8. The ePlatform of claim 4, wherein the PAC generated security codes include: RACs (Route Activation Codes), which are used for: activating a calculated route or geographical path, validating user IDs and package IDs, process monitoring during each step/leg of a given route; DCCs (Delivery Confirmation Codes), which activate remuneration and database feedback routines; and UTCs (Unique Transition Codes), which are not used by platform clients, but are used only for handoffs between “members” of the platform.

9. The ePlatform of claim 4, wherein the PAC calculated route includes a network of one or more interim/relay points, between the starting and endpoints; and the robustness of the system is improved by intra-route generation and use of different/distinct UTCs for each of the in-between stages//legs.

10. The ePlatform of claim 4, wherein the Hs operators are individuals or businesses, and their hubspots may comprise both static & mobile locations and structures, such as: kiosks, cafes, garages, backyards, basements, porches, parked vehicles, leased lockers, self-storage units, unoccupied rental houses/apartments, excess warehouse footage, unused retail shop spaces, etc; and wherein a plurality of hubspots can electronically share data through the platform, thereby creating a network of digitally interconnected and communicating hubspots which can work in combination to facilitate parcel delivery.

11. The ePlatform of claim 4, wherein the PAC program code includes a Loading Capacity Optimization (“LCO”) module, which computes the optimal parcel arrangement or loading configuration; and which can be used for quickly identifying particular target packages, within a carrying area or other storage space.

12. The ePlatform of claim 4, wherein PAC database and servers (which may be centralized or distributed) generate polypoints, which the PAC uses for defining and computationally identifying a certain route on a geographical map, thus making these data points amenable to computational analysis and reconstruction.

13. The ePlatform of claim 4, wherein PAC servers generate Ecopoints, which the PAC calculates by using a mixture of factors such as: the means of transportation used (e.g. car, moped, bike, truck, etc.), the distance covered, time required for end-to-end delivery completion, weight/size of parcel sent, CO2 emissions etc.; and PAC database stores these Ecopoints for consideration when rewarding a Cr or Sd.

14. The ePlatform of claim 4, wherein the PAC program code includes machine learning algorithms which use database stored historical data—along with current geospatial, time, platform usage and personal preferences data—to improve the route calculation process.

15. The ePlatform of claim 8, wherein the Hs control physical structures which can be used as mobile and/or static hubs—for drop-offs and pickups, in case a hand-to-hand pickup/delivery cannot take place; the Hs use their ECDs to dynamically communicate information to the PAC such as: changes in hours of operation, and availability and usage levels of their hub storage spaces.

16. The ePlatform of claim 5, wherein the crowdsourced platform is for a peer-to-peer (P2P) shipping/delivery system, and the courier-type users are not professional couriers, but are everyday individuals who register their daily travel routes through mob.Apps, which were preloaded on their ECDs or downloaded from the PAC to the couriers' ECDs

17. The ePlatform of claim 5, wherein couriers use their ECDs to dynamically communicate information to the PAC regarding the availability and usage levels of their underutilized carrying space in a rucksack, car trunk/back seat, motorcycle side bag/carrying box, etc.

18. The ePlatform of claim 7, wherein troubleshooting routines include processes for dealing with situations where, when dynamic PAC monitoring (e.g., via GPS) of a Cr's progress along a route indicates that the Cr may be in trouble, the PAC activates an “Orange alert”.

19. The ePlatform of claim 7, wherein troubleshooting routines include processes for dealing with situations where, when dynamic PAC message exchanges (e.g., via ECD) indicates that the Cr will be late or can't pickup/deliver at all, and a “Red alert” is activated by the PAC.

20.-23 (canceled)

24. An electronic platform (“ePlatform”) for logistic control of a crowdsourced transportation system for picking up parcels from a sender, carrying said parcels along a calculated geographic route and delivering the parcel to a recipient; said ePlatform comprising:
a) a platform administrative computer (“PAC”) system, which includes a digital database, digital program code, digital servers and input/output (“I/O”) interface means;
b) user operated electronic control devices (“ECD”), configured with means for communications, computing/processing, storage and I/O operations;
c) telecommunications network structures for electronically coupling the PAC: to users though their ECDs, to the Internet, to the Cloud, and to third party (P3″) providers of geospatial data, computing power, and other P3 sources of information and services;
d) security codes, which are generated by PAC server algorithms, transmitted to the user ECDs, and used by the PAC to direct and control user pickup, handoff and secure delivery of parcels;
e) troubleshooting/error correction routines, which are employed by the PAC to define and resolve issues, when users do not perform as required;
whereby the ePlatform controls and supervises the pickup, handoff, interim storage (if necessary) and safe delivery of shipped parcels; and
f) wherein the ECD I/O means includes devices for input and display of Augmented Reality (“AR”) data, and transmittal to the PAC (via the ECD mob.App) of AR data, for processing and use with a Loading Capacity Optimization (“LCO”) module.

25.-30 (canceled)
